(19) United States
(12) Patent Application Publication
(10) Pub. No.: US 2011/0119708 A1
(43) Pub. Date: May 19, 2011

(54) METHOD AND APPARATUS FOR GENERATING MULTIMEDIA STREAM FOR 3-DIMENSIONAL REPRODUCTION OF ADDITIONAL VIDEO REPRODUCTION INFORMATION, AND METHOD AND APPARATUS FOR RECEIVING MULTIMEDIA STREAM FOR 3-DIMENSIONAL REPRODUCTION OF ADDITIONAL VIDEO REPRODUCTION INFORMATION

(75) Inventors: Dae-jong LEE, Suwon-si (KR); Kil-soo JUNG, Osan-si (KR); Jae-han KIM, Suwon-si (KR); Bong-je CHO, Busan (KR); Yong-tae KIM, Seoul (KR); Jae-seung KIM, Yongin-si (KR); Hong-seok PARK, Anyang-si (KR)

(73) Assignee: SAMSUNG ELECTRONICS CO., LTD., Suwon-si (KR)

(21) Appl. No.: 12/944,486

(22) Filed: Nov. 11, 2010

Related U.S. Application Data
(60) Provisional application No. 61/266,631, filed on Dec. 4, 2009.
(60) Provisional application No. 61/260,893, filed on Nov. 13, 2009.

(30) Foreign Application Priority Data
Jun. 15, 2010 (KR) 10-2010-0056756
Jun. 15, 2010 (KR) 10-2010-0056757

(51) Int. Cl. H04N 5/445; H04N 13/02; H04N 13/00

(52) U.S. Cl. 725/39; 348/46; 348/42; 348/E13.074

(57) ABSTRACT

A multimedia stream generating method for 3-dimensional (3D) reproduction of additional reproduction information is provided, the method includes generating a video elementary stream (ES), an audio ES, an additional data stream, and an ancillary information stream that respectively comprise video data, audio data related to the video data, data of additional reproduction information which is to be reproduced together with the video data on a display screen, and additional reproduction information depth information used for 3D reproduction of the additional reproduction information.

### CROSS-REFERENCE TO RELATED PATENT APPLICATION

This application claims the benefits of U.S. Provisional Patent Application No. 61/260,893, filed on Nov. 13, 2009, and U.S. Provisional Patent Application No. 61/266,631, filed on Dec. 4, 2009, in the US Patent and Trademark Office, and priority from Korean Patent Application No. 10-2010-0056756, filed on Jun. 15, 2010, and Korean Patent Application No. 10-2010-0056757, filed on Jun. 15, 2010, in the Korean Intellectual Property Office, the disclosures of which are incorporated herein in their entirety by reference.

### BACKGROUND

1. Field

Methods and apparatuses consistent with the exemplary embodiments relate to encoding and decoding of multimedia including stereoscopic video.

2. Description of the Related Art

Demand for 3-dimensional (3D) contents having a realistic and stereoscopic effect is increasing. In addition, there is an increasing amount of broadcasting contents or programs manufactured so as to be reproduced in 3D.

A program provides video information and audio information mutually related to each other, and visual materials that can be reproduced together with a video image on a screen provide an additional description about a program or a channel or additional information such as a date and a place.

For example, a closed caption of a digital TV (DTV), which is subtitle data existing in a certain region of a TV program stream, may be displayed on a TV screen according to a user's selection although, by default, it is generally not displayed on the TV screen. Closed captioning is provided for the hearing-impaired or is widely used for additional purposes such as for educational purposes.

A subtitle of the DTV may be displayed together with a video image on the screen, in the form of visual materials that provide an enhanced visual effect related to text, by using a character, an image such as a bitmap, a frame, an outline, a shadow, or the like.

Since electronic program guide (EPG) information of the DTV is displayed on the TV screen to provide channel or program information, the EPG information may be used by viewers changing channels or checking additional information about a current channel program.

A method of processing additional visual materials which are to be reproduced together with a 3D video image on a screen has been developed.

### SUMMARY

According to an aspect of the exemplary embodiments, there is provided a multimedia stream generating method for 3-dimensional (3D) reproduction of additional reproduction information, the method comprising: generating a video elementary stream (ES), an audio ES, an additional data stream, and an ancillary information stream that respectively comprise video data, audio data related to the video data, data of additional reproduction information which is to be reproduced together with the video data on a display screen, and information for 3D reproduction of the additional reproduction information, wherein the video data comprises at least one of a 2-dimensional (2D) video image and a 3D video image; generating a video packetized elementary stream (PES) packet, an audio PES packet, a data PES packet, and an ancillary information packet by respectively packetizing the video ES, the audio ES, the additional data stream and the ancillary information stream; and generating a transport stream (TS) by multiplexing the video PES packet, the audio PES packet, the additional data PES packet, and the ancillary information packet.

The information for 3D reproduction of the additional reproduction information may comprise information about an offset amount of 3D additional reproduction information for adjusting a depth of the 3D additional reproduction information during 3D reproduction of the video data. The offset of the additional reproduction information may represent at least one selected from the group consisting of a parallax indicating a displacement amount of the 3D additional reproduction information, a coordinate of the 3D additional reproduction information, and a depth of the 3D additional reproduction information, wherein the parallax is expressed in units of one selected from the group consisting of a depth difference, a disparity, and a binocular parallax between first-view additional reproduction information and second-view additional reproduction information of the 3D additional reproduction information.

The information for 3D reproduction of the additional reproduction information may further comprise information about an offset direction of the 3D additional reproduction information during 3D reproduction of the video data. The information for 3D reproduction of the additional reproduction information may further comprise offset type information indicating whether the offset of the 3D additional reproduction information is expressed as a first displacement amount with respect to a zero plane where a depth is at the origin or as a second displacement amount with respect to at least one selected from the group consisting of a depth, a disparity, and a binocular parallax of a video image which is to be reproduced together with the 3D additional reproduction information. The information for 3D reproduction of the additional reproduction information may further comprise at least one selected from the group consisting of 2D/3D distinguishing information of the 3D additional reproduction information, 2D video reproduction information representing whether a video image is to be reproduced in 2D during reproduction of the 3D additional reproduction information, information identifying a region where the 3D additional reproduction information is to be reproduced, information associated with when the 3D additional reproduction information is to be displayed, and 3D reproduction safety information of the 3D additional reproduction information.

The generating of the video ES, the audio ES, the additional data stream, and the ancillary information stream may include inserting closed caption data, which is to be displayed with the video data on the display screen, into the video ES. The generating of the video ES, the audio ES, the additional data stream, and the ancillary information stream may comprise inserting information for 3D reproduction of the closed caption into at least one selected from the group consisting of the video ES, a header of the video ES, and additional data of the additional data stream. The information for 3D reproduction of the closed caption may comprise 3D caption emphasizing information representing whether the closed caption data is to be replaced by 3D closed caption emphasizing data.

The generating of the video ES, the audio ES, the additional data stream, and the ancillary information stream may comprise generating a data stream for subtitle data which is to be reproduced on the display screen together with the video data, to serve as the additional data stream. The generating of the video ES, the audio ES, the additional data stream, and the ancillary information stream may further include inserting information for 3D reproduction of the subtitle data into at least one selected from the group consisting of the additional data PES packet and a header of the additional data PES packet.

When the multimedia stream is generated by an American National Strandard Institute/Society of Cable Telecommunications Engineers (ANSI/SCTE) based cable communication system, the information for 3D reproduction of the subtitle data may include parallax information representing a displacement amount of at least one of a bitmap and a frame of a 3D subtitle, and parallax information representing at least one selected from the group consisting of depth information of the 3D subtitle and coordinate information of the 3D subtitle.

The generating of the video ES, the audio ES, the additional data stream, and the ancillary information stream may include inserting offset information for each region of a current page of the subtitle data into a reserved field included in a page composition segment of the data stream, when the multimedia stream is generated by a DVB communication system.

The generating of the video ES, the audio ES, the additional data stream, and the ancillary information stream may comprise inserting electronic program guide (EPG) information, which is to be reproduced together with the video data on the display screen, and information for 3D reproduction of the EPG information, into the ancillary information stream. In the generating of the video ES, the audio ES, the additional data stream, and the ancillary information stream, when the multimedia stream is generated by an ATSC communication system, the information for 3D reproduction of the EPG information may be inserted into a descriptor field of an ATSC-based Program Specific Information Protocol (PSIP) table. In the generating of the video ES, the audio ES, the additional data stream, and the ancillary information stream, when the multimedia stream is generated by a DVB communication system, the information for 3D reproduction of the EPG information may be inserted into a descriptor field of a DVB-based Specific Information (SI) table.

According to another aspect of the exemplary embodiments, there is provided a multimedia stream receiving method for 3D reproduction of additional reproduction information, the method comprising: extracting a video PES packet, an audio PES packet, an additional data PES packet, and an ancillary information packet by receiving and demultiplexing a transport stream (TS) for a multimedia stream; extracting a video ES, an audio ES, an additional data stream, and an ancillary information stream from the video PES packet, the audio PES packet, the additional data PES packet, and the ancillary information packet, respectively, wherein the video ES, the audio ES, the additional data stream, and the ancillary information stream comprise additional reproduction information, which is to be reproduced together with video data comprising at least one of a 2D video image and a 3D video image, and information for 3D reproduction of the additional reproduction information; restoring the video data, audio data, additional data, and the additional reproduction information and extracting the information for 3D reproduction of the additional reproduction information, from the video ES, the audio ES, the additional data stream, and the ancillary information stream; and reproducing the additional reproduction information in 3D together with the video data, based on the information for 3D reproduction of the additional reproduction information.

The reproducing of the additional reproduction information in 3D may include moving the 3D additional reproduction information in a positive direction or in a negative direction by the offset of the additional reproduction information, based on the offset amount of the 3D additional reproduction information and an offset direction of the 3D additional reproduction information from among the information for 3D reproduction of the additional reproduction information. The offset may represent a displacement amount of the 3D additional reproduction information expressed in the unit of a depth, a disparity, or a binocular parallax of the video data.

The reproducing of the additional reproduction information in 3D may comprise reproducing a video corresponding to the 3D additional reproduction information in 2D when reproducing the additional reproduction information in 3D, based on the 2D video reproduction information. The reproducing of the additional reproduction information in 3D may comprise synchronizing the 3D additional reproduction information with the corresponding video, based on information associated with when to display the 3D additional reproduction information.

The reproducing of the additional reproduction information in 3D may comprise determining whether the 3D reproduction of the 3D additional reproduction information is safe, based on the 3D reproduction safety information of the 3D additional reproduction information. The reproducing of the additional reproduction information in 3D may further comprise, if it is determined that the 3D reproduction of the 3D additional reproduction information is safe, reproducing the 3D additional reproduction information in 3D.

The reproducing of the additional reproduction information in 3D may further comprise, if it is determined that the 3D reproduction of the 3D additional reproduction information is unsafe, comparing the offset of the 3D additional reproduction information with a disparity of a corresponding video image to be displayed with the 3D additional reproduction information. The reproducing of the additional reproduction information in 3D may further comprise determining 3D reproduction of the 3D additional reproduction information according to whether the offset of the 3D additional reproduction information belongs to a safe section of the disparity of the corresponding video image according to a result of the comparing. The reproducing of the additional reproduction information in 3D may further comprise, if the offset of the 3D additional reproduction information does not belong to a safe section of the disparity of the corresponding video image according to a result of the comparing, reproducing the 3D additional reproduction information after post-processing the 3D additional reproduction information.

The extracting of the video ES, the audio ES, the additional data stream, and the ancillary information stream may comprise extracting closed caption data which is to be displayed with the video data on the display screen, from the video ES. The extracting of the video ES, the audio ES, the additional data stream, and the ancillary information stream may comprise extracting information for 3D reproduction of the closed caption data from at least one selected from the group consisting of the video ES, a header of the video ES, and the ancillary information stream. The information for 3D reproduction of closed caption data may comprise 3D caption emphasizing information representing whether the closed caption data is to be replaced by 3D closed caption emphasizing data. The reproducing of the additional reproduction information in 3D may comprise reproducing the closed caption data in 3D, based on the information for 3D reproduction of closed caption data.

The extracting of the video ES, the audio ES, the additional data stream, and the ancillary information stream may comprise extracting a subtitle data stream for subtitle data which is to be reproduced on the display screen together with the video data, to serve as the additional data stream. The extracting of the video ES, the audio ES, the additional data stream, and the ancillary information stream may further comprise extracting information for 3D reproduction of the subtitle data from at least one selected from the group consisting of the additional data PES packet and a header of the additional data PES packet.

When the multimedia stream is received by an ANSI/SCTE based cable communication system, the information for 3D reproduction of the subtitle data may comprise parallax information representing a displacement amount of at least one of a bitmap and a frame of a 3D subtitle, and offset information representing at least one selected from the group consisting of depth information of the 3D subtitle and coordinate information of the 3D subtitle. The extracting of the video ES, the audio ES, the additional data stream, and the ancillary information stream may comprise extracting offset information for each region of a current page of the subtitle data from a reserved field included in a page composition segment of the data stream, when the multimedia stream is generated by a DVB communication system. The reproducing of the additional reproduction information in 3D may comprise reproducing the subtitle data in 3D, based on the information for 3D reproduction of the subtitle.

The extracting of the video ES, the audio ES, the additional data stream, and the ancillary information stream may comprise extracting EPG information which is to be reproduced together with the video data, and information for 3D reproduction of the EPG information, from the ancillary information stream. In the extracting of the video ES, the audio ES, the additional data stream, and the ancillary information stream, the information for 3D reproduction of the EPG information may be extracted from a descriptor field of an ATSC-based PSIP table or from a descriptor field of a DVB-based SI table. The reproducing of the additional reproduction information in 3D may comprise reproducing the EPG information in 3D, based on the information for 3D reproduction of the EPG information.

According to another aspect of the exemplary embodiments, there is provided a multimedia stream generating apparatus for 3D reproduction of additional reproduction information, the multimedia stream generating apparatus comprising: a program encoder which generates a video ES, an audio ES, an additional data stream, and an ancillary information stream that respectively comprise video data, audio data related to the video data, data of additional reproduction information which is to be reproduced together with the video data on a display screen, and information for 3D reproduction of the additional reproduction information, and which generates a video PES packet, an audio PES packet, a data PES packet, and an ancillary information packet by respectively packetizing the video ES, the audio ES, the additional data stream and the ancillary information stream, wherein the video data comprises at least one of a 2D video image and a 3D video image; and a TS generator which generates a TS by multiplexing the video PES packet, the audio PES packet, the additional data PES packet, and the ancillary information packet.

According to another aspect of the exemplary embodiments, there is provided a multimedia stream receiving apparatus for 3D reproduction of additional reproduction information, the multimedia stream receiving apparatus comprising: a receiver which receives a TS for a multimedia stream that comprises video data comprising at least one of a 2D video image and a 3D video image; a demultiplexer which demultiplexes the received TS to extract a video PES packet, an audio PES packet, an additional data PES packet, and an ancillary information packet and extracts a video ES, an audio ES, an additional data stream, and an ancillary information stream from the video PES packet, the audio PES packet, the additional data PES packet, and the ancillary information packet, wherein the video ES, the audio ES, the additional data stream, and the ancillary information stream comprise additional reproduction information, which is to be reproduced together with the video data on a display screen, and information for 3D reproduction of the additional reproduction information; a decoder which extracts and restores the video data, audio data, additional data, and the additional reproduction information and extracts the information for 3D reproduction of the additional reproduction information, from the video ES, the audio ES, the additional data stream, and the ancillary information stream; and a reproducer which reproduces the additional reproduction information in 3D together with the video data, based on the information for 3D reproduction of the additional reproduction information.

According to another aspect of the exemplary embodiments, there is provided a computer readable recording medium having recorded thereon a program for executing the multimedia stream generating method. According to another aspect of the exemplary embodiments, there is provided a computer readable recording medium having recorded thereon a program for executing the multimedia stream receiving method.

### BRIEF DESCRIPTION OF THE DRAWINGS

The above and other aspects will become more apparent by describing in detail exemplary embodiments thereof with reference to the attached drawings in which:

FIG. 1 is a block diagram of a multimedia stream generating apparatus for 3-dimensional (3D) reproduction of additional reproduction information, according to an exemplary embodiment;

FIG. 2 is a block diagram of a multimedia stream receiving apparatus for 3D reproduction of additional reproduction information, according to an exemplary embodiment;

FIG. 3 illustrates a scene in which a 3D video and 3D additional reproduction information are simultaneously reproduced;

FIG. 4 illustrates a phenomenon in which a 3D video and 3D additional reproduction information are reversed and reproduced;

FIG. 5 illustrates a structure of a Moving Picture Expert Group (MPEG) transport stream (TS) including various types of additional reproduction information;

FIG. 6 is a detailed block diagram of a closed caption reproducer included in the multimedia stream receiving apparatus illustrated in FIG. 2, according to a first exemplary embodiment;

FIG. 7 is a perspective view of a screen that adjusts a depth of a closed caption, according to the first exemplary embodiment;

FIG. 8 is a plan view of a screen that adjusts the depth of the closed caption, according to the first exemplary embodiment;

FIG. 9 is a flowchart of a method in which the multimedia stream receiving apparatus according to the first exemplary embodiment uses 3D caption emphasizing information and offset information of a closed caption;

FIG. 10 is a flowchart of a method in which the multimedia stream receiving apparatus according to the first exemplary embodiment uses 3D reproduction safety information of the closed caption;

FIG. 11 illustrates an example of an image post-processing method which is performed when safety is not ensured based on the 3D reproduction safety information of the closed caption, according to the first exemplary embodiment;

FIGS. 12 and 13 illustrate another example of the image post-processing method which is performed when safety is not ensured based on the 3D reproduction safety information of the closed caption, according to the first exemplary embodiment;

FIGS. 14 and 15 illustrate another example of the image post-processing method which is performed when safety is not ensured based on the 3D reproduction safety information of the closed caption, according to the first exemplary embodiment;

FIG. 16 is a block diagram of a multimedia stream generating apparatus for 3D reproduction of a subtitle, according to second and third exemplary embodiments;

FIG. 17 is a diagram of a hierarchical structure of subtitle data complying with a digital video broadcasting (DVB) communication method;

FIGS. 18 and 19 illustrate two methods of expressing a subtitle descriptor within a program map table (PMT) that indicates a subtitle packetized elementary stream (PES) packet, according to a DVB communication method;

FIG. 20 is a diagram of a structure of a datastream including subtitle data complying with a DVB communication method, according to an exemplary embodiment;

FIG. 21 is a diagram of a structure of a composition page complying with a DVB communication method, according to an exemplary embodiment;

FIG. 22 is a flowchart illustrating a subtitle processing model complying with a DVB communication method;

FIGS. 23, 24, and 25 are diagrams illustrating data stored respectively in a coded data buffer, a composition buffer, and a pixel buffer;

FIG. 26 is a diagram for describing adjustment of a depth of a subtitle according to regions, according to the second exemplary embodiment;

FIG. 27 is a diagram for describing adjustment of a depth of a subtitle according to pages, according to the second exemplary embodiment;

FIG. 28 is a diagram illustrating components of a bitmap format of a subtitle complying with a cable broadcasting method;

FIG. 29 is a flowchart of a subtitle processing model for 3D reproduction of a subtitle complying with a cable broadcasting method;

FIG. 30 is a diagram for describing a process of a subtitle being output from a display queue to a graphic plane through the subtitle processing model complying with a cable broadcasting method illustrated in FIG. 29;

FIG. 31 is a flowchart of a subtitle processing model for 3D reproduction of a subtitle complying with a cable broadcasting method, according to the third exemplary embodiment;

FIG. 32 is a diagram for describing adjustment of a depth of a subtitle complying with a cable broadcasting method according to the third exemplary embodiment;

FIG. 33 is a diagram for describing adjustment of a depth of a subtitle complying with a cable broadcasting method according to the third exemplary embodiment;

FIG. 34 is a diagram for describing adjustment of a depth of a subtitle complying with a cable broadcasting method according to the third exemplary embodiment;

FIG. 35 is a block diagram of a digital communication system that transmits EPG information, according to an exemplary embodiment;

FIG. 36 illustrates program specific information protocol (PSIP) tables including electronic program guide (EPG) information according to an advanced television standards committee (ATSC) communication method;

FIG. 37 illustrates service information (SI) tables including EPG information according to a DVB communication method;

FIG. 38 illustrates a screen on which EPG information is displayed, and a source of each information;

FIG. 39 is a block diagram of a TS decoding system according to a fourth exemplary embodiment;

FIG. 40 is a block diagram of a display processing unit of the TS decoding system according to the fourth exemplary embodiment;

FIG. 41 is a flowchart of a multimedia stream generating method for 3D reproduction of additional reproduction information, according to an exemplary embodiment; and

FIG. 42 is a flowchart of a multimedia stream receiving method for 3D reproduction of additional reproduction information, according to an exemplary embodiment.

### DETAILED DESCRIPTION OF THE EXEMPLARY EMBODIMENTS

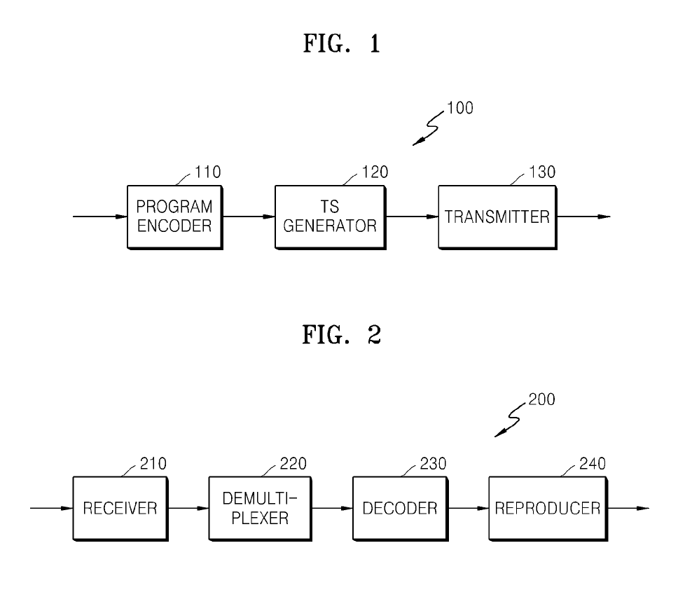

Hereinafter, a method and apparatus for generating a multimedia stream for 3-dimensional (3D) reproduction of additional video reproduction information and a method and apparatus for receiving the multimedia stream for 3-dimensional reproduction of additional video reproduction information, according to an exemplary embodiment will be described more fully with reference to FIGS. 1 through 42. Expressions such as “at least one of,” when preceding a list of elements, modify the entire list of elements and do not modify the individual elements of the list.

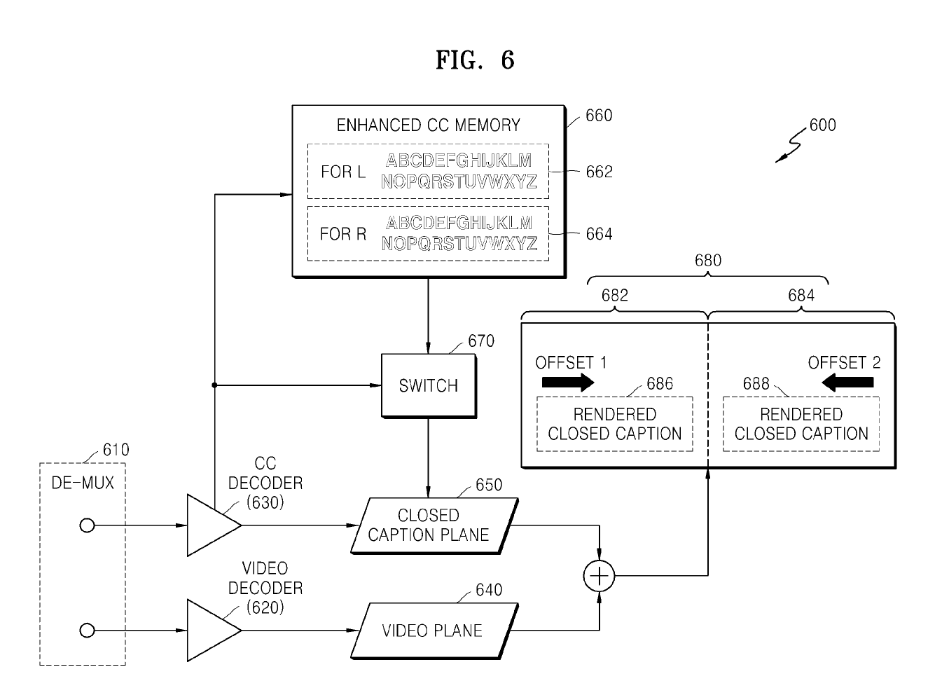

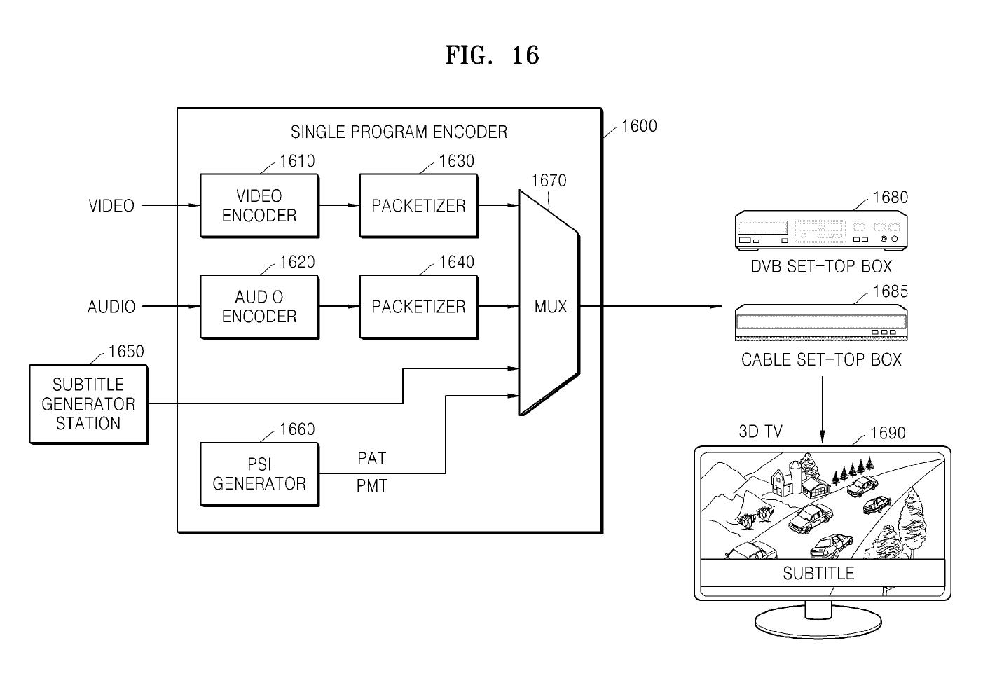

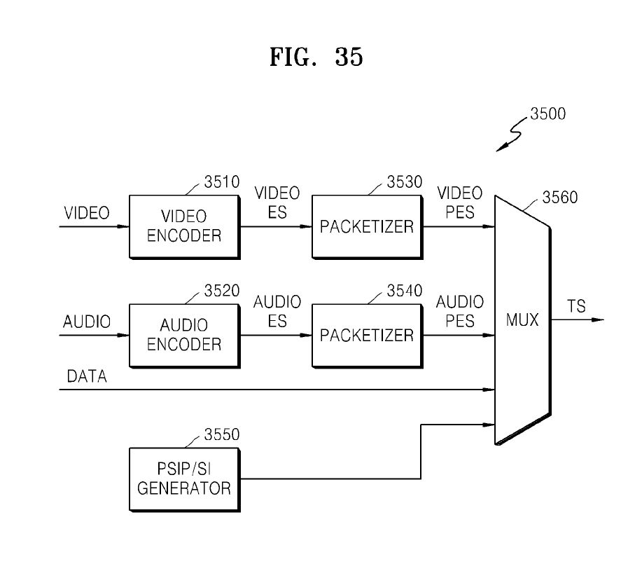

Additional reproduction information, which will be described later, is displayed together with a video image on a screen in association with a program, and may include a closed caption, a subtitle, and electronic program guide (EPG) information. The aspects disclose various exemplary embodiments in which a closed caption, a subtitle, and EPG information are reproduced in 3D. In detail, exemplary embodiments related to a closed caption based on a Consumer Electronics Association (CEA) method will be described with reference to FIGS. 6 through 15, exemplary embodiments related to a subtitle will be described with reference to FIGS. 16 through 34, and exemplary embodiments related to EPG information will be described with reference to FIGS. 35 through 40.

FIG. 1 is a block diagram of a multimedia stream generating apparatus 100 for 3D reproduction of additional reproduction information, according to an exemplary embodiment.

The multimedia stream generating apparatus 100 according to the exemplary embodiment for 3D reproduction of additional reproduction information (hereinafter, referred to as a multimedia stream generating apparatus 100 according to the exemplary embodiment) includes a program encoder 110, a transport stream (TS) generator 120, and a transmitter 130.

The program encoder 110 receives data of additional reproduction information together with encoded video data and encoded audio data. For convenience of description, data, which is inserted into a stream as the data of additional reproduction information, such as a closed caption, a subtitle, or EPG information, and which is to be displayed with a video image on a screen, will be hereinafter referred to as “additional reproduction data”.

Video data of a program generated by the program encoder 110 includes at least one of 2D video data and 3D video data. Additional reproduction data related to the program according to an exemplary embodiment may include closed caption data, subtitle data, and EPG data that are related to the program.

Additional reproduction data according to an exemplary embodiment may be reproduced in 3D together with 3D video data by controlling a depth of the additional reproduction information. To achieve this, the program encoder 110 may generate a video elementary stream (ES), an audio ES, an additional data stream, and an ancillary information stream that includes the encoded video data, the encoded audio data, the additional reproduction data, and information for 3D reproduction of the additional reproduction information.

The additional data to be inserted in the ancillary information stream may include various types of data, such as control data, other than video data and audio data. The ancillary information stream may include program specific information (PSI), such as a program map table (PMT) or a program association table (PAT), or section information, such as advanced television standards committee program specific information protocol (ATSC PSIP) information or digital video broadcasting service information (DVB SI).

The program encoder 110 generates a video packetized elementary stream (PES) packet, an audio PES packet, and an additional data PES packet by packetizing the video ES, the audio ES, and the additional data stream, and also generates an ancillary information packet.

The TS generator 120 generates a TS by multiplexing the video PES packet, the audio PES packet, the additional data PES packet, and the ancillary information packet, which are output from the program encoder 110. The transmitter 130 transmits the TS output from the TS generator 120 via a predetermined channel.

The information for 3D reproduction of additional reproduction information, which is inserted into a multimedia stream together with a program and transmitted by the program encoder 110, includes information used to adjust the depth of the additional reproduction information which is reproduced in 3D during reproduction of a 3D video image.

Examples of the information used to adjust the depth of the additional reproduction information include offset information of the additional reproduction information, which includes parallax information such as a depth difference, a disparity, and a binocular parallax between left-view additional reproduction information for left-view images and right-view additional reproduction information for right-view images, coordinate information or depth information of additional reproduction information for each view, and other information. In the following exemplary embodiments, even when any one element of the offset information, such as a disparity, a coordinate, or the like, from among different elements of the offset information is illustrated, the same exemplary embodiment may be realized for the other elements of offset information for each view.

The offset information of the additional reproduction information may indicate the amount of displacement of additional reproduction information of one view relative to the location of the additional reproduction information of another view from among first-view additional reproduction information and second-view additional reproduction information of a 3D video image. The offset information of the additional reproduction information may also indicate a displacement amount of additional reproduction information for each view relative to one of a depth, a disparity, and a binocular parallax of a current video image.

The offset information of the additional reproduction information may include an absolute location of additional reproduction information based on a zero plane (zero parallax), instead of a depth difference, a disparity, or a binocular parallax of the additional reproduction information, which are relative values.

The offset information of the additional reproduction information may further include information about an offset direction of the additional reproduction information. For example, the offset direction of the additional reproduction information may be set to be a positive direction for the first-view additional reproduction information of the 3D video image and may be set to be a negative direction for the second-view additional reproduction information of the 3D video image.

The information for 3D reproduction of additional reproduction information may further include offset type information indicating whether the offset information of the additional reproduction information is of a first offset type representing an absolute location of the additional reproduction information based on the zero plane or of a second offset type representing a relative displacement amount of additional reproduction information for each view.

The information for 3D reproduction of additional reproduction information may further include at least one selected from the group consisting of 2D/3D distinguishing information of the additional reproduction information, 2D video reproduction information representing whether video data is to be reproduced in 2D during reproduction in 2D of the additional reproduction information, information identifying a region where the additional reproduction information is to be reproduced, information associated with when the additional reproduction information should be displayed, and 3D reproduction safety information of the additional reproduction information.

When a multimedia stream is encoded by a Moving Picture Expert Group-2 (MPEG-2) data communication system, the program encoder 110 may insert at least one selected from the group consisting of binocular parallax information, disparity information, and depth information of a 3D video image, into at least one selected from the group consisting of a parallax information extension field, a depth map, and a reserved field of a closed caption data field.

When the multimedia stream is generated in an International Organization for Standardization (ISO) media file format, the program encoder 110 may insert at least one selected from the group consisting of binocular parallax information, disparity information, and depth information of a 3D video image, into a Stereoscopic Camera And Display Information (SCDI) region of the ISO-based media file format, which includes a stereoscopic camera and display-related information.

An operation of the program encoder 110 may vary according to whether the additional reproduction information is a closed caption, a subtitle, or EPG information.

According to a first exemplary embodiment, the program encoder 110 inserts closed caption data based on the CEA standards into a video ES. The program encoder 110 according to the first exemplary embodiment may insert information for 3D reproduction of a closed caption (hereinafter, referred to as closed caption 3D reproduction information) into the video ES, a header of the video ES, or a section. The closed caption 3D reproduction information according to the first exemplary embodiment may include not only the above-described information for 3D reproduction of additional reproduction information but also 3D caption emphasizing information representing whether the closed caption data is to be replaced by 3D closed caption emphasizing data.

According to a second exemplary embodiment, when the multimedia stream generating apparatus 100 complies with an American National Standard Institute/Society of Cable Telecommunications Engineers (ANSI/SCTE) method, the program encoder 110 may generate a subtitle PES packet by generating a data stream including subtitle data, along with the video ES and the audio ES. Here, the program encoder 110 according to the second exemplary embodiment may insert information for 3D reproduction of a subtitle (hereinafter, referred to as subtitle 3D reproduction information) into at least one of the subtitle PES packet and a header of the subtitle PES packet. Subtitle offset information included in the subtitle 3D reproduction information according to the second exemplary embodiment may be information about a displacement amount of at least one of a bitmap and a frame of the subtitle.

The program encoder 110 according to the second exemplary embodiment may insert offset information, which is applied to both character elements and frame elements of the subtitle, into a reserved field of a subtitle message field in the subtitle data. Alternatively, the program encoder 110 according to the second exemplary embodiment may insert offset information about the character elements of the subtitle, and offset information about the frame elements of the subtitle separately into the subtitle data.

The program encoder 110 according to the second exemplary embodiment may basically include subtitle type information about a base-view subtitle as subtitle type information. The program encoder 110 according to the second exemplary embodiment may add subtitle type information about an additional-view subtitle to the subtitle type information. Accordingly, the program encoder 110 according to the second exemplary embodiment may additionally insert coordinate information of an additional-view subtitle for an additional-view video of a 3D video image into the subtitle data.

The program encoder 110 according to the second exemplary embodiment may add a subtitle disparity type to the subtitle type information, and additionally insert disparity information of the additional-view subtitle of the additional-view video relative to a base-view subtitle of a base-view video of the 3D video image into the subtitle data.

According to a third exemplary embodiment, when the multimedia stream generating apparatus 100 according to the third exemplary embodiment complies with a digital video broadcasting (DVB) method, the program encoder 110 may generate a subtitle PES packet by generating an additional data stream including subtitle data, along with the video ES and the audio ES. In this case, the program encoder 110 according to the third exemplary embodiment may insert the subtitle data into the additional data stream so that the subtitle data forms a subtitle segment in the additional data stream.

The program encoder 110 according to the third exemplary embodiment may insert the subtitle 3D reproduction information into a reserved field included in a page composition segment. The program encoder 110 according to the third exemplary embodiment may additionally insert at least one of offset information for each page of the subtitle and offset information for each region of a current page of the subtitle into the page composition segment.

According to a fourth exemplary embodiment, the program encoder 110 may insert EPG information which can be reproduced together with video data, and information for 3D reproduction of EPG information (hereinafter, referred to as EPG 3D reproduction information) into a section.

When the multimedia stream generating apparatus 100 according to the fourth exemplary embodiment complies with the ATSC method, the program encoder 110 may insert the EPG 3D reproduction information into a descriptor field of a PSIP table of the ATSC. In detail, the EPG 3D reproduction information may be inserted into a descriptor field of at least one selected from the group consisting of a Terrestrial Virtual Channel Table (TVCT) section, an Event Information Table (EIT) section, an Extended Text Table (ETT) section, an Rating Region Table (RRT) section, and a System Time Table (STT) section of the PSIP table of the ATSC.

When the multimedia stream generating apparatus 100 according to the fourth exemplary embodiment complies with the DVB method, the program encoder 110 may insert the EPG 3D reproduction information into a descriptor field of a SI table of the DVB. In detail, the EPG 3D reproduction information may be inserted into a descriptor field of at least one selected from the group consisting of a Network Information Table (NIT) section, a Service Description Table (SDT) section, and an EIT section of the SI table.

Accordingly, in order to reproduce various types of additional reproduction information in three-dimension based on various communication methods such as a closed caption based on the CEA method, a subtitle based on the DVB method or the cable broadcasting method, and EPG information based on the ATSC or DVB method, the multimedia stream generating apparatus 100 according to the exemplary embodiment may insert additional reproduction data and information for 3D reproduction of the additional reproduction information into video ES data, a data stream, or an ancillary stream and thus transmit the additional reproduction data and the information for 3D reproduction of the additional reproduction information together with multimedia data. A receiver (not shown) may use the information for 3D reproduction of additional reproduction information to stably reproduce the additional reproduction information during 3D reproduction of video data.

The multimedia stream generating apparatus 100 maintains compatibility with various communication methods, such as the DVB method based on an existing MPEG TS method, the ATSC method, and the cable broadcasting method, and may provide viewers with a multimedia stream that allows 3D video to be reproduced and 3D reproduction information to be stably reproduced.

FIG. 2 is a block diagram of a multimedia stream receiving apparatus 200 for 3D reproduction of additional reproduction information, according to an exemplary embodiment.

The multimedia stream receiving apparatus 200 according to the exemplary embodiment includes a receiver 210, a demultiplexer 220, a decoder 230, and a reproducer 240.

The receiver 210 receives a TS for a multimedia stream including video data that includes at least one of a 2D video image and a 3D video image. The multimedia stream includes additional reproduction data for additional reproduction information such as a closed caption, a subtitle, EPG information, etc., which can be reproduced with a 2D or 3D video image on a screen, and information for 3D reproduction of additional reproduction information.

The demultiplexer 220 extracts a video PES packet, an audio PES packet, an additional data PES packet, and an ancillary information packet by receiving and demultiplexing the TS from the receiver 210. The demultiplexer 220 extracts a video ES, an audio ES, an additional data stream, and program related information from the video PES packet, the audio PES packet, the additional data PES packet, and the ancillary information packet. The video ES, the audio ES, the additional data stream, and the program related information include additional reproduction data and information for 3D reproduction of the additional reproduction information.

The decoder 230 receives the video ES, the audio ES, the additional data stream, and the program related information from the demultiplexer 220, restores video, audio, additional data, and additional reproduction information respectively from the received video ES, the audio ES, and the additional data stream, and extracts the information for 3D reproduction of the additional reproduction information from the received streams or the program related information.

The reproducer 240 reproduces the video, the audio, the additional data, and the additional reproduction information restored by the decoder 230. Also, the reproducer 240 may construct 3D additional reproduction information, based on the information for 3D reproduction of the additional reproduction information.

The additional reproduction data and the information for 3D reproduction of additional reproduction information extracted and used by the multimedia stream receiving apparatus 200 according to the exemplary embodiment correspond to the additional reproduction data and the information for 3D reproduction of additional reproduction information described above with reference to the multimedia stream generating apparatus 100 according to the exemplary embodiment of FIG. 1.

In order to achieve 3D reproduction of the additional reproduction information, the reproducer 240 may reproduce the additional reproduction information at a location offset from a reference location of the additional reproduction information in a positive or negative direction, based on offset information of the additional reproduction information from among the information for 3D reproduction of the additional reproduction information. Hereinafter, although any one of parallax information, depth information, and coordinate information is illustrated for convenience of explanation, the offset information of the additional reproduction information from among the information for 3D reproduction of additional reproduction information is not limited thereto, which is similar to the exemplary embodiment of FIG. 1.

The reproducer 240 may reproduce the additional reproduction information in such a way that the additional reproduction information is displayed at a location positively or negatively displaced by an offset amount relative to a zero plane, based on the offset information of the additional reproduction information and information about an offset direction. Alternatively, the reproducer 240 may reproduce the additional reproduction information in such a way that the additional reproduction information is displayed at a location positively or negatively displaced by an offset, based on one selected from the group consisting of a depth, a disparity, and a binocular parallax of a video which is to be reproduced with the additional reproduction information.

The reproducer 240 may construct 3D additional reproduction information and reproduce the 3D additional reproduction information in 3D in such a way that one of first-view additional reproduction information and second-view additional reproduction information of the 3D additional reproduction information is displayed at a location positively displaced by an offset from a zero plane, and the other is displayed at a location negatively displaced by the offset relative to the zero plane, based on the offset information of the additional reproduction information and the information about an offset direction.

The reproducer 240 may construct 3D additional reproduction information and reproduce the 3D additional reproduction information in 3D in such a way that the one view additional reproduction information is displayed at a location moved by an offset relative to the location of the other view additional reproduction information, based on the offset information of the additional reproduction information and the information about an offset direction.

The reproducer 240 may construct 3D additional reproduction information and reproduce the 3D additional reproduction information in 3D in such a way that additional reproduction information for a current video is displayed at a location moved by an offset based on one of a depth, a disparity, and a binocular parallax of the current video, based on the offset information of the additional reproduction information and the information about an offset direction.

The reproducer 240 may construct 3D additional reproduction information and reproduce the 3D additional reproduction information in 3D in such a way that the first-view additional reproduction information is displayed based on location information of the first-view additional reproduction information from among the offset information of the additional reproduction information and the second-view additional reproduction information is displayed based on location information of the second-view additional reproduction information from among the offset information of the additional reproduction information, based on location information of additional reproduction information independently set for each view.

3D video from among video data restored by the decoder 230 may have a 3D composite format of a side by side format. In this case, the reproducer 240 may construct 3D additional reproduction information and reproduce the 3D additional reproduction information in 3D in such a way that each of left-view additional reproduction information and right-view additional reproduction information for a left-view video and a right-view video, which form a 3D composite format, are displayed at a location displaced by half an offset, when the offset is obtained from the offset information of the additional reproduction information.

When reproducing additional reproduction information in 3D, the reproducer 240 may reproduce video data corresponding to the additional reproduction information in 2D, based on 2D video reproduction information included in the information for 3D reproduction of the additional reproduction information.

The reproducer 240 may reproduce a video and additional reproduction information in 3D by synchronizing the video with the additional reproduction information, based on information associated with when the additional reproduction information from among the information for 3D reproduction of the additional reproduction information is displayed.

The reproducer 240 may determine whether 3D reproduction of additional reproduction information is safe, based on 3D reproduction safety information of the additional reproduction information from among the information for 3D reproduction of the additional reproduction information, and may then determine a method of reproducing the additional reproduction information. If it is determined, based on the 3D reproduction safety information of the additional reproduction information, that 3D reproduction of additional reproduction information is safe, the reproducer 240 may reproduce the additional reproduction information in 3D. On the other hand, if it is determined, based on the 3D reproduction safety information of the additional reproduction information, that 3D reproduction of additional reproduction information is not safe, the reproducer 240 may not reproduce the additional reproduction information or may reproduce the additional reproduction information after performing a predetermined image post-processing technique.

For example, if it is determined, based on the 3D reproduction safety information of the additional reproduction information, that 3D reproduction of additional reproduction information is not safe, the reproducer 240 may compare a disparity of a corresponding video with an offset of the additional reproduction information. If the offset of the additional reproduction information belongs to a safe section of the disparity of the corresponding video, which is determined according to a result of the comparison, the reproducer 240 may reproduce the additional reproduction information in 3D. On the other hand, if the offset of the additional reproduction information does not belong to the safe section of the disparity of the corresponding video, which is determined according to a result of the comparison, the reproducer 240 may not reproduce the additional reproduction information.

Alternatively, if the offset of the additional reproduction information does not belong to the safe section of the disparity of the corresponding video, which is determined according to a result of the comparison, the reproducer 240 may reproduce the additional reproduction information after performing a predetermined image post-processing technique. In an example of the predetermined image post-processing technique, the reproducer 240 may reproduce the additional reproduction information on a predetermined area of the corresponding video in 2D. In another example of the predetermined image post-processing technique, the reproducer 240 may reproduce the additional reproduction information by moving the additional reproduction information so that the additional reproduction information protrudes toward a viewer relative to an object of the corresponding video. In another example of the predetermined image post-processing technique, the reproducer 240 may reproduce the corresponding video in 2D and reproduce the additional reproduction information in 3D.

The reproducer 240 may extract or newly measure the disparity of the corresponding video in order to compare the disparity of the corresponding video with the offset of the additional reproduction information. When a multimedia stream is based on an MPEG-2 TS, the reproducer 240 may extract at least one selected from the group consisting of binocular parallax information, disparity information, and depth information of a 3D video image, from at least one selected from the group consisting of a parallax information extension field, a depth map, and a reserved field of a closed caption data field of the video ES, and compare the extracted information with the offset information of the additional reproduction information. For example, when the multimedia stream has an ISO-based media file format, the reproducer 240 may extract at least one selected from the group consisting of binocular parallax information, disparity information, and depth information of a 3D video image, from an SCDI region of the ISO-based media file format, which includes a stereoscopic camera and display-related information, and compare the extracted information with the offset information of the additional reproduction information.

An operation of the multimedia stream receiving apparatus 200 according to the exemplary embodiment may vary according to whether the additional reproduction information is a closed caption, a subtitle, or EPG information.

According to a first exemplary embodiment, the demultiplexer 220 may extract a video ES including closed caption data based on the CEA standards from a TS. The decoder 230 according to the first exemplary embodiment may restore video data from the video ES and extract closed caption data from the video data. The decoder 230 according to the first exemplary embodiment may extract closed caption 3D reproduction information from the video ES, a header of the video ES, or a section.

The reproducer 240 according to the first exemplary embodiment may construct 3D closed caption data including a left-view closed caption and a right-view closed caption and reproduce the 3D closed caption data in 3D, based on the closed caption 3D reproduction information. Characteristics of the closed caption data and the closed caption 3D reproduction information according to the first exemplary embodiment correspond to those described above with reference to the multimedia stream generating apparatus 100 according to the first exemplary embodiment.

According to the second exemplary embodiment, when the multimedia stream receiving apparatus 200 according to the second exemplary embodiment complies with the ANSI/SCTE method, the demultiplexer 220 may extract an additional data stream including subtitle data along with the video ES and the audio ES from the TS. Accordingly, the decoder 230 according to the second exemplary embodiment may extract the subtitle data from the additional data stream. The demultiplexer 220 or the decoder 230 according to the second exemplary embodiment may extract subtitle 3D reproduction information from at least one of a subtitle PES packet and a header of the subtitle PES packet.

Characteristics of the subtitle data and the subtitle 3D reproduction information according to the second exemplary embodiment correspond to those described above with reference to the multimedia stream generating apparatus 100 according to the second exemplary embodiment. The decoder 230 according to the second exemplary embodiment may extract offset information, which is applied to both character elements and frame elements of a subtitle, from a reserved field of a subtitle message field in the subtitle data according to the exemplary embodiment. Alternatively, the decoder 230 according to the second exemplary embodiment may additionally extract offset information about the character elements of the subtitle, and offset information about the frame elements of the subtitle separately from the subtitle data.

The decoder 230 according to the second exemplary embodiment may check a subtitle type for second-view video data from among 3D video data, which is included as subtitle type information in the 3D video data. Accordingly, the decoder 230 according to the second exemplary embodiment may additionally extract offset information, such as coordinate information, depth information, and parallax information, of a subtitle related to the second-view video data from the subtitle data.

When it is checked from the subtitle type information that a current subtitle type is a subtitle disparity type, the decoder 230 according to the second exemplary embodiment may additionally extract disparity information of the second-view subtitle related to a first-view subtitle from the subtitle data.

The reproducer 240 according to the second exemplary embodiment may construct a 3D subtitle including a left-view subtitle and a right-view subtitle and reproduce the 3D subtitle in 3D, based on the subtitle 3D reproduction information.

According to a third exemplary embodiment, when the multimedia stream receiving apparatus 200 according to the exemplary embodiment complies with a DVB method, the decoder 220 may extract an additional data stream including subtitle data along with the video ES and the audio ES from a TS. Accordingly, the decoder 230 according to the third exemplary embodiment may extract the subtitle data of a subtitle segment format from the additional data stream.

The decoder 230 according to the third exemplary embodiment may extract the subtitle 3D reproduction information from a reserved field included in a page composition segment. The decoder 230 according to the third exemplary embodiment may additionally extract at least one of offset information for each page of the subtitle and offset information for each region of a current page of the subtitle from the page composition segment.

The reproducer 240 according to the third exemplary embodiment may construct a 3D subtitle including a left-view subtitle and a right-view subtitle and reproduce the 3D subtitle in 3D, based on the subtitle 3D reproduction information.

According to a fourth exemplary embodiment, when the multimedia stream receiving apparatus 200 according to the exemplary embodiment complies with the ATSC method, the decoder 230 may extract EPG 3D reproduction information from a descriptor field of a PSIP table of the ATSC. In detail, the EPG 3D reproduction information may be extracted from a descriptor field of at least one selected from the group consisting of a TVCT section, an EIT section, an ETT section, an RRT section, and an STT section of the PSIP table of the ATSC.

When the multimedia stream receiving apparatus 200 according to the fourth exemplary embodiment complies with the DVB method, the decoder 230 may extract the EPG 3D reproduction information from a descriptor field of a SI table of the DVB. In detail, the EPG 3D reproduction information may be extracted from a descriptor field of at least one selected from the group consisting of an NIT section, an SDT section, and an EIT section of the SI table.

The reproducer 240 according to the fourth exemplary embodiment may construct 3D EPG information including left-view EPG information and right-view EPG information and reproduce the 3D EPG information in 3D, based on the EPG 3D reproduction information.

Accordingly, in order to three-dimensionally reproduce various types of additional reproduction information based on various communication methods such as a closed caption based on the CEA method, a subtitle based on the DVB method or the cable broadcasting method, and EPG information based on the ATSC or DVB method, the multimedia stream receiving apparatus 200 according to the exemplary embodiment may extract additional reproduction data and information for 3D reproduction of the additional reproduction information from a received multimedia stream. The multimedia stream receiving apparatus 200 according to the exemplary embodiment may stably reproduce the additional reproduction information during 3D reproduction of video data by using the information for 3D reproduction of additional reproduction information.

The multimedia stream receiving apparatus 200 according to the exemplary embodiment maintains compatibility with various communication methods, such as the DVB method based on an existing MPEG TS method, the ATSC method, and the cable broadcasting method, and may provide viewers with a multimedia stream that allows 3D video to be reproduced and 3D reproduction information to be stably reproduced.

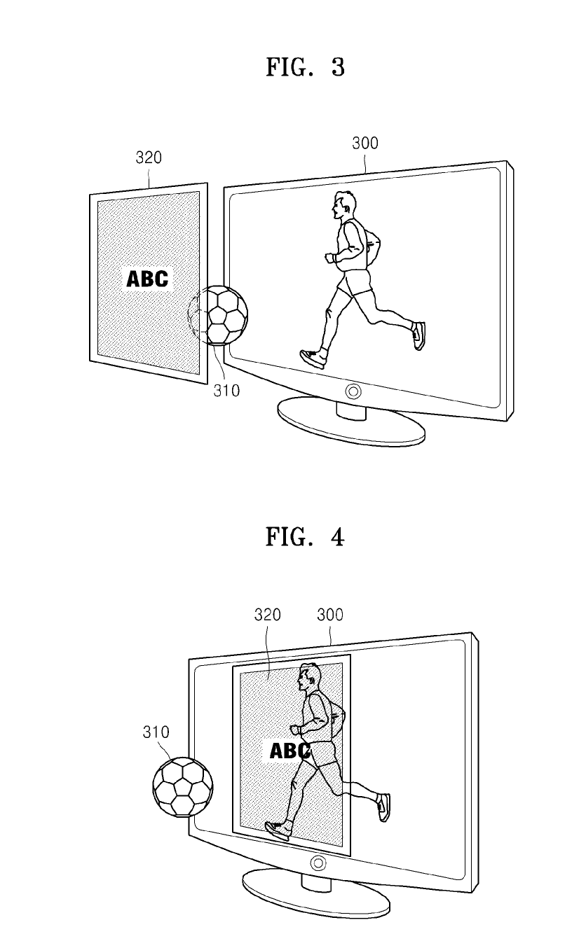

FIG. 3 illustrates a scene in which a 3D video and 3D additional reproduction information are simultaneously reproduced.

According to 3D video reproduction by a 3D display device, an object image 310 may be reproduced so as to protrude from a zero plane 300 toward a viewer. Additional reproduction information, such as a closed caption, a subtitle, and EPG information, needs to be reproduced on a text screen 320, so as to protrude toward the viewer relative to all objects of a video image, so that the viewer stably enjoys a 3D video image without fatigue or disharmony.

FIG. 4 illustrates a phenomenon in which a 3D video and 3D additional reproduction information are reversed and reproduced. As shown in FIG. 4, when an error exists in depth information, disparity information, or binocular parallax information of the additional reproduction information, a reversal phenomenon may occur in which the text screen 320 is reproduced further than the object image 310 from the viewer. Due to the reversal phenomenon, the object image 310 covers the text screen 320. In this case, the viewer may be fatigued or feel disharmony while viewing a 3D video.

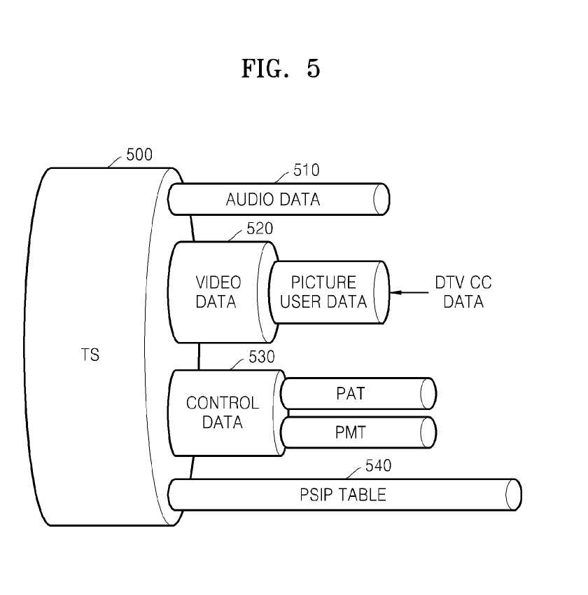

FIG. 5 illustrates a structure of an MPEG TS 500 including various types of additional reproduction information.

The MPEG TS 500 includes streams of contents that constitute a program. In detail, the MPEG TS 500 includes an audio ES 510, a video ES 520, control data 530, and a PSIP table 540 which is program related information.

The closed caption data according to the first exemplary embodiment which is processed by the multimedia stream generating apparatus 100 according to the exemplary embodiment and the multimedia stream receiving apparatus 200 according to the exemplary embodiment may be inserted in a ‘cc_data’ format into a picture user data region of the video ES 520. In an exemplary embodiment, the closed caption data may be inserted into a ‘cc_data’ field of a video PES packet constructed by multiplexing the video ES 520.

The subtitle data according to the second and third exemplary embodiments may be inserted into an additional data stream separate from the audio ES 510 or the video ES 520 and may be included in the MPEG TS 500. In particular, the subtitle data may include not only text data but also graphic data.

The EPG information according to the fourth exemplary embodiment may be inserted into predetermined tables of the PSIP table 540.

Generation and reception of a multimedia stream for 3D reproduction of the closed caption according to the first exemplary embodiment will now be described in detail with reference to Tables 1 through 12 and FIGS. 6 through 15.

The multimedia stream generating apparatus 100 according to the first exemplary embodiment may insert the closed caption together with video data into a video stream. The program encoder 110 according to the first exemplary embodiment may insert the closed caption data into the ‘cc_data’ field of a ‘user_data’ field of the video PES packet. Table 1 shows a syntax of the ‘cc_data’ field based on the DVB method, and Table 2 shows a syntax of the ‘cc_data’ field based on the DVB method. The closed caption data may be inserted into ‘cc_data1’ and ‘cc_data_{—}2’ fields of a ‘for’ loop.

TABLE 1
Syntax

```
cc_data( ){
    reserved
    process_cc_data_flag
    additional_data_flag
    cc_count
    reserved
    for (i=0; i<cc_count; i++){
      marker_bits
      cc_valid
      cc_type
      cc_data_1
      cc_data_2
  }
  marker_bits
    if (addtional_data_flag){
      while (nextbits( ) != ‘0000 0000 0000 0000 0000 0001’ ){
      additional_cc_data
      }
  }
}
```

TABLE 2
Syntax

```
    cc_data( ){
      reserved
  process_cc_data_flag
      zero_bit
      cc_count
      reserved
for (i=0; i<cc_count; i++){
      one_bit
      reserved
        cc_valid
        cc_type
      cc_data_1
      cc_data_2
      }
marker_bits = “11111111”
      }
```

The program encoder 110 according to the first exemplary embodiment may insert the closed caption 3D reproduction information into a ‘reserved’ field of the ‘cc_data’ field of Tables 1 and 2.

The program encoder 110 according to the first exemplary embodiment may insert 2D/3D distinguishing information of the closed caption, offset information of the closed caption, and 3D caption emphasizing information into the ‘reserved’ field of the ‘cc_data’ field.

In detail, for example, the program encoder 110 according to the first exemplary embodiment may insert 2D/3D distinguishing information ‘2d_CC’ of the closed caption as shown in Table 3 into first ‘reserved’ fields of Tables 1 and 2.

TABLE 3
Syntax

2d_CC

The 2D/3D distinguishing information ‘2d_CC’ according to the first exemplary embodiment may represent whether closed caption data inserted into a field next to a ‘2d_CC’ field is to be reproduced in 2D or 3D.

The program encoder 110 according to the first exemplary embodiment may insert 3D caption emphasizing information ‘enhanced_CC’ and offset information of the closed caption, ‘cc_offset’, as shown in Table 4 into second ‘reserved’ fields of Tables 1 and 2.

TABLE 4
Syntax

enhanced_CC
cc_offset
reserved

The 3D caption emphasizing information ‘enhanced_CC’ according to the first exemplary embodiment may represent whether closed caption data of DTV CC data is to be replaced by data used for 3D closed caption emphasis. The offset information of the closed caption, ‘cc_offset’, according to the first exemplary embodiment may represent a disparity offset which is horizontal displacement amount of the closed caption data of DTV CC data to provide a depth to the closed caption.

The multimedia stream generating apparatus 100 according to the first exemplary embodiment may encode a command character and a text of the closed caption according to a code set prescribed in the CEA-708 standard for a closed caption of an ATSC digital TV stream. Table 5 shows a code set mapping table prescribed in the CEA-708 standard.

TABLE 5

| Code sub- | | |
|---|---|---|
| groups | Bits | Description |
| C0 | 0x00-0x1F | Subset of ASCII Control Codes |
| C1 | 0x80-0x9F | Caption Control Codes |
| C2 | 0x1000-0x101F | Extended Miscellaneous Control |
| | | Codes |
| C3 | 0x1080-0x109F | Extended Control Code Set 2 |
| G0 | 0x20-0x7F | Modified version of ANSI X3.4 |
| | | Printable Character Set (ASCII) |
| G1 | 0xA0-0xFF | ISO 8859-1 Latin 1 Characters |
| G2 | 0x1020-0x107F | Extended Control Code Set 1 |
| G3 | 0x10A0-0x10FF | Future characters and icons |

An ASCII control code may be represented using a code set of a C0 group of the code set mapping table, and closed caption data may be represented using the code set of the C0 group. The code set of the C0 group of the code set mapping table prescribed in the CEA-708 standards can be arbitrarily defined as an extended control code by a user. The multimedia stream generating apparatus 100 according to the first exemplary embodiment may represent a command descriptor for setting the closed caption 3D reproduction information according to the first exemplary embodiment, by using a code set of a C2 group. Table 6 shows a code set table of the C2 group.

TABLE 6
C2 table

| | |
|---|---|
| 0x00-0x07 | +0 bytes - 1 byte code section |
| 0x08-0x0f | +1 byte - 2 byte code section |
| 0x10-0x17 | +2 bytes - 3 byte code section |
| 0x18-0x1f | +3 byte - 4 byte code section |

In an exemplary embodiment, the multimedia stream generating apparatus 100 according to the first exemplary embodiment may represent the closed caption 3D reproduction information as the command character by using a 2 byte code section of a bitstring ‘0x08˜0x0f’ in the code set of the C2 group.

For example, the multimedia stream generating apparatus 100 according to the first exemplary embodiment may define a command descriptor ‘Define3DInfo’ for setting the closed caption 3D reproduction information. Table 7 shows an example of the command character of the command descriptor ‘Define3DInfo( )’.

TABLE 7

| b7 | b6 | b5 | b4 | b3 | b2 | b1 | b0 | |
|---|---|---|---|---|---|---|---|---|
| 0 | 0 | 0 | 0 | 1 | 1 | 0 | 0 | Command |
| id2 | id1 | id0 | sc | x | x | X | x | Parameter1 |

When the command descriptor ‘Define3DInfo( )’ according to the first exemplary embodiment has a format of ‘Define3DInfo(window_ID, is_safety_check)’, ‘00001100’ (or ‘0x0C’) in the command character of Table 7 may be assigned to represent a command ‘Define3DInfo’, and ‘id2 id1 id0 sc’ in the command character represents input parameters ‘id’ and ‘sc’. Since the input parameter ‘id’ is expressed in 3 bits as a caption region identifier ‘window_ID’ for identifying a closed caption, the input parameter ‘id’ may be set as one unique identifier from among 0 through 7. The input parameter ‘sc’ represents 3D reproduction safety information ‘is_safety_check’ of the closed caption. As shown in Table 8, the parameter ‘is_safety_check’ may represent whether the offset information of the closed caption inserted into contents is safe.

TABLE 8

| is_safety_check | Contents |
|---|---|
| 0 | Safety of disparity information inserted into contents is |
| | not ensured. |
| 1 | Safety of disparity information inserted into contents is |
| | ensured. |

In another exemplary embodiment, the multimedia stream generating apparatus 100 according to the first exemplary embodiment may define a command descriptor ‘SetDisparityType’ for setting offset information for 3D reproduction of the closed caption. Table 9 shows an example of the command character of the command descriptor ‘SetDisparityType’.

TABLE 9

| b7 | b6 | b5 | b4 | b3 | b2 | b1 | b0 | |
|---|---|---|---|---|---|---|---|---|
| 0 | 0 | 0 | 0 | 1 | 1 | 0 | 0 | Command |
| id2 | id1 | id0 | Dt | x | x | x | x | Parameter1 |

When the command descriptor ‘SetDisparityType’ according to the first exemplary embodiment has a format of ‘SetDisparityType(window_ID, disparity_type)’, ‘00001100’ (or ‘0x0C’) in the command character of Table 9 may be assigned to represent a command ‘SetDisparityType’, and ‘id2 id1 id0 dt’ in the command character represents input parameters ‘id’ and ‘dt’.

The input parameter ‘id’ represents a caption region identifier ‘window_ID’. The input parameter ‘dt’ represents offset type information ‘disparity_type’ of the closed caption. As shown in Table 10, the parameter ‘disparity_type’ may represent whether an offset value of the closed caption is a first offset type set based on a screen plane or a zero plane, or a second offset type set based on a disparity of a video.

TABLE 10

| disparity_type | Contents |
|---|---|
| 0 | Value of parameter “offset” is given based on a screen |
| | plane. |
| 1 | Value of parameter “offset” is given based on a disparity |
| | value defined within a video ES. |

According to the related art CEA-708 standard, a command descriptor ‘SetWindowDepth’ for controlling generation, deletion, correction, display or non-display, and the like of a caption region is used in a Digital-TV Closed Caption (DTVCC) Coding Layer.

The multimedia stream generating apparatus 100 according to the first exemplary embodiment may modify the command descriptor ‘SetWindowDepth’ and use the modified command descriptor ‘SetWindowDepth’. The multimedia stream generating apparatus 100 according to the first exemplary embodiment may use and modify the command descriptor ‘SetWindowDepth’ by using an extended control code set region of the code set mapping table prescribed in the CEA 708 standard, in order to maintain backward compatibility with a receiving apparatus including a closed caption decoding unit.

For example, the 3D reproduction safety information ‘is_safety_check’ and the offset type information ‘disparity type’ of the closed caption according to the first exemplary embodiment may be represented using a 2-byte code section of a bitstring ‘0x08˜0x0f’ of the C2 group code set, and information about an offset value may be additionally represented using a 3 byte code section of a bitstring ‘0x10˜0x17’ of the C2 group code set. Table 11 shows an example of the command character of the modified command descriptor ‘SetWindowDepth’ obtained by the multimedia stream generating apparatus 100 according to the first exemplary embodiment.

TABLE 11

| b7 | b6 | b5 | b4 | b3 | b2 | b1 | b0 | |
|---|---|---|---|---|---|---|---|---|
| 0 | 0 | 0 | 1 | 0 | 0 | 0 | 0 | Command |
| dt | vf | id2 | id1 | id0 | 0 | Sc | os | Parameter1 |
| off7 | off6 | off5 | off4 | off3 | off2 | off1 | off0 | Parameter2 |

When the command descriptor ‘SetWindowDepth’ according to the first exemplary embodiment has a format of ‘SetWindowDepth(disparity_type, video_flat, window_ID, is_safety_check, offset_sign, offset)’, ‘00010000’ in the command character of Table 11 may indicate a command ‘SetWindowDepth’, ‘dt vf id2 id1 id0 0 sc os’ in the command character indicates input parameters ‘dt’, ‘vf’, ‘id’, ‘sc’, and ‘os’, and ‘off7 off6 off5 off4 off3 off2 off1 off0’ in the command character indicates an input parameter ‘off’.

The input parameter ‘dt’ indicates offset type information ‘disparity_type’ of the closed caption. The input parameter ‘vf’ indicates 2D video reproduction information ‘video_flat’. ‘id’ of a parameter ‘id2 id1 id0’ indicates a caption region identifier ‘window_ID’ for identifying a region of a corresponding video image in which the closed caption is displayed. The input parameter ‘sc’ indicates 3D reproduction safety information ‘is_safety_check’ of the closed caption. The input parameter ‘os’ indicates offset direction information ‘offset_sign’ of the closed caption.

When the multimedia stream receiving apparatus 200 according to the first exemplary embodiment executes the command descriptor ‘SetWindowDepth’ of Table 11, if it is ascertained from the parameter ‘disparity_type’ that the value of the parameter ‘offset’ is set based on a disparity of a video image defined in a video ES, the parameters ‘video_flat’ and ‘is_safety_check’ may not be used.

As shown in Table 12, the 2D video reproduction information ‘video_flat’ may represent whether a 3D reproduction mode of 3D video reproduction is maintained or changed to a 2D reproduction mode during 3D reproduction of the closed caption.

TABLE 12

| video_flat | Contents |
|---|---|
| 0 | 3D reproduction mode of 3D video reproduction is maintained |
| | (L/R time-sequential) |
| 1 | 3D reproduction mode of 3D video reproduction is changed to |
| | 2D reproduction mode (L/L or R/R time-sequential) |

For example, if it is determined from the parameter ‘video_flat’ that a 3D reproduction mode of 3D video reproduction is maintained, the multimedia stream receiving apparatus 200 according to the first exemplary embodiment may control a 3D display device to reproduce a left-view image and a right-view image time-sequentially. On the other hand, if it is determined from the parameter ‘video_flat’ that the 3D reproduction mode of 3D video reproduction is changed to a 2D reproduction mode, the multimedia stream receiving apparatus 200 according to the first exemplary embodiment may control the 3D display device to reproduce left-view images time-sequentially or to reproduce right-view images time-sequentially.

Even when 3D video reproduction is maintained in the 3D reproduction mode or is switched from the 3D reproduction mode to the 2D reproduction mode according to the parameter ‘video_flat’, an offset of the closed caption is applied to a caption region by using the parameters ‘offset_sign’ and ‘offset’, so that the closed caption can be reproduced in 3D. However, if 3D video reproduction is switched from the 3D reproduction mode to the 2D reproduction mode, the parameter ‘is_safety_check’ may not be used. In this case, the parameter ‘offset_sign’ may be set to represent a negative offset so that the closed caption protrudes toward a viewer.

The parameter ‘sc’ indicates the 3D reproduction safety information ‘is_safety_check’ of the closed caption. As shown in Table 13, the parameter ‘is_safety_check’ may represent an offset sign of the closed caption and the safety or non-safety of the offset of the closed caption.

TABLE 13

| is_safety_check | Contents |
|---|---|
| 0 | Safety of an offset given by parameters “offset sign” |
| | and “offset” is not ensured. |
| 1 | Safety of an offset given by parameters “offset sign” |
| | and “offset” is ensured. |

For example, if the safety of the offset of the closed caption is not checked by a contents provider and the closed caption is provided together with contents as in real-time communications, a reverse phenomenon between depths of the 3D video image and the closed caption may occur, or viewers are highly likely to be experience fatigue due to an unsafe depth. Accordingly, the parameter ‘is_safety_check’ may be used to check whether the contents provider has secured 3D reproduction safety of the closed caption.

Accordingly, in the multimedia stream receiving apparatus 200 according to the first exemplary embodiment, if it is determined from the parameter ‘is_safety_check’ that the safety of an offset (or a disparity) of the closed caption to be controlled by the parameters ‘offset_sign’ and ‘offset’ is not ensured by the contents provider, an offset for the closed caption may be applied to the caption region according to a closed caption displaying method unique to the receiver.

On the other hand, if it is determined from the parameter ‘is_safety_check’ that the safety of the offset of the closed caption is ensured by the contents provider, the receiver may adjust the offset of the closed caption by using the parameters ‘offset_sign’ and ‘offset’ and reproduce the closed caption.

The input parameter ‘os’ represents sign information ‘offset_sign’ for determining whether the offset value of the closed caption given by the parameter ‘offset’ is a negative or positive binocular parallax. The input parameter ‘off’ may represent a horizontal displacement amount of a pixel for horizontally moving the location of an anchor point of a closed caption region generated in 2D in order to apply the offset to the caption region selected by the input parameter ‘id’. The horizontal displacement amount is the offset information of the closed caption.

The closed caption 3D reproduction information described above with reference to Tables 1 through 13 may be inserted into a video stream and transmitted by the multimedia stream generating apparatus 100 according to the first exemplary embodiment. The multimedia stream receiving apparatus 200 according to the first exemplary embodiment may extract the closed caption 3D reproduction information described above with reference to Tables 1 through 13 from the video stream and may use the closed caption 3D reproduction information in 3D reproduction of the closed caption.

Exemplary embodiments in which the multimedia stream receiving apparatus 200 according to the first exemplary embodiment uses the closed caption 3D reproduction information will now be described in detail with reference to FIGS. 6 through 15.

FIG. 6 is a detailed block diagram of a closed caption reproducer 600 of a multimedia stream receiving apparatus for 3D reproduction of a closed caption, according to an exemplary embodiment.

The closed caption reproducer 600 may be another exemplary embodiment of the reproducer 240 of the multimedia stream receiving apparatus 200 according to the first exemplary embodiment. The closed caption reproducer 600 includes a video decoder 620, a closed caption (CC) decoder 630, a video plane memory 640, a closed caption plane memory 650, a 3D CC emphasizing data memory 660 (hereinafter, referred to as an enhanced CC memory 660), and a switch 670.

Closed caption data and video data obtained by a demultiplexer (DE-MUX) 610 are input to the closed caption reproducer 600. The CC decoder 630 decodes the closed caption data received from the DE-MUX 610 and restores a closed caption plane. The video decoder 620 decodes the video data received from the DE-MUX 610 and restores a video plane. The video plane and the closed caption plane output from the video decoder 620 and the CC decoder 630 may be stored in the video plane memory 640 and the closed caption plane memory 650, respectively. When the video data and the closed caption data of the video plane memory 640 and the closed caption plane memory 650 are output and synthesized, a video screen on which the closed caption data is displayed may be output.

The CC decoder 630 may determine whether to reproduce the closed caption data ‘cc_data_{—}1’ and ‘cc_data_{—}2’ in 2D or 3D, based on the parameter ‘2d_CC’ of the closed caption field ‘cc_data’ according to the first exemplary embodiment described above with reference to Tables 1, 2, and 3.

When a set value of the parameter ‘2d_CC’ is 0, the CC decoder 630 may reproduce the closed caption data ‘cc_data_{—}1’ and ‘cc_data_{—}2’ in 3D. In this case, the CC decoder 630 may determine whether the input closed caption data ‘cc_data_{—}1’ and ‘cc_data_{—}2’ are reproduced, or the 3D CC emphasizing data stored in the enhanced CC memory 660 is reproduced, based on the parameter ‘enhance_CC’ of the closed caption field ‘cc_data’ according to the first exemplary embodiment.

For example, the 3D CC emphasizing data may be graphic data such as an image. 3D CC emphasizing data 662 and 664 for a left-view image and a right-view image may be separately stored in the enhanced CC memory 660. According to whether the 3D CC emphasizing data is used or not, the switch 670 may control an operation of outputting the 3D CC emphasizing data 662 and 664 to the closed caption plane memory 650.

The CC decoder 630 may reproduce the closed caption data at a location displaced by an offset value in a horizontal axis direction from an original location when displaying the closed caption data as a left-view image and a right-view image on a screen, based on the parameter ‘cc_offset’ of the closed caption field ‘cc_data’ according to the first exemplary embodiment. In other words, a left-view closed caption 686 and a right-view closed caption 688 may be displaced by offset1 and offset2, respectively, in a left-view image region 682 and a right-view image region 684 of a 3D video image 680 having a 3D composite format.

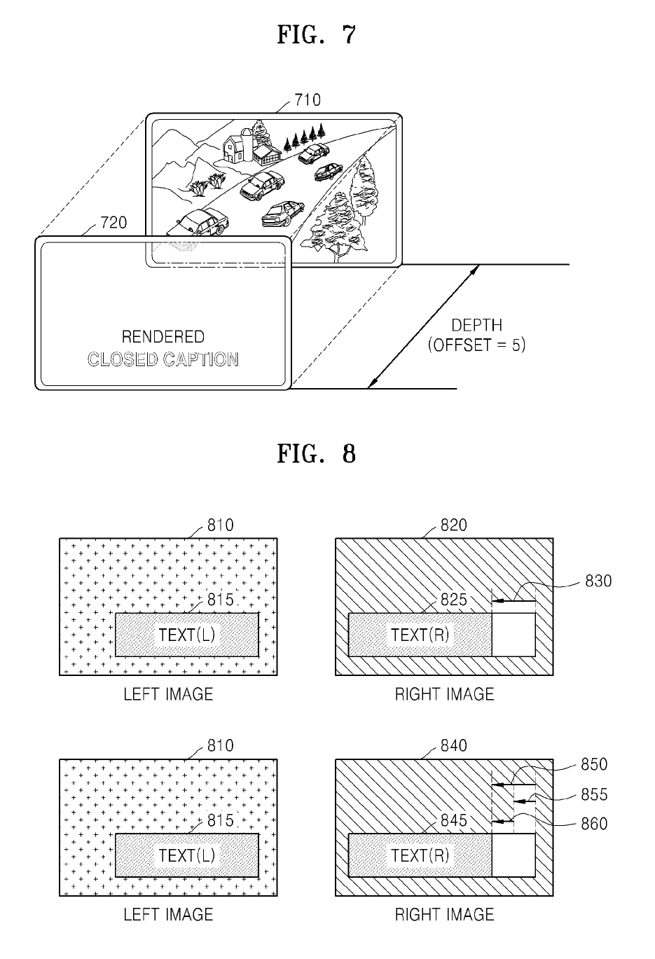

FIG. 7 is a perspective view of a screen that adjusts a depth of a closed caption, according to the first exemplary embodiment.

According to the first exemplary embodiment, when the offset value of the closed caption is a depth of 5, a 3D CC emphasizing caption plane 720 is displayed to protrude from a video plane 710 by the depth of 5, based on the 3D caption emphasizing information of the closed caption.

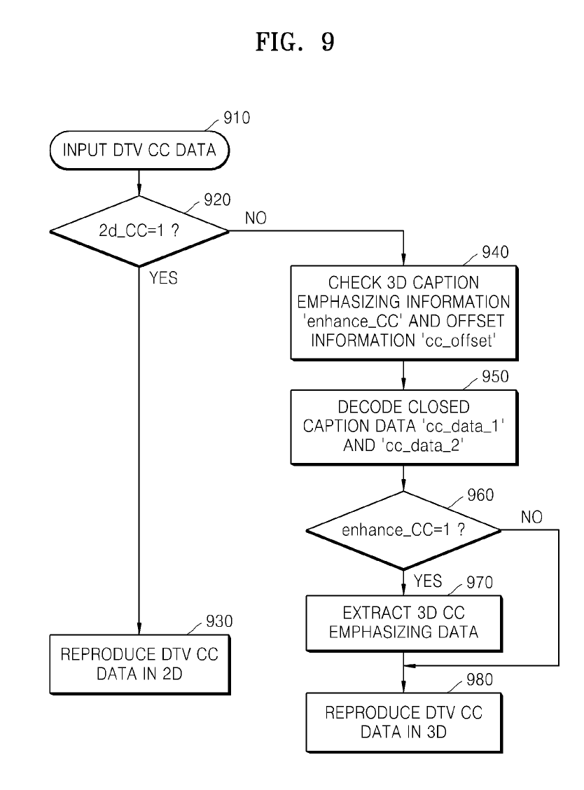

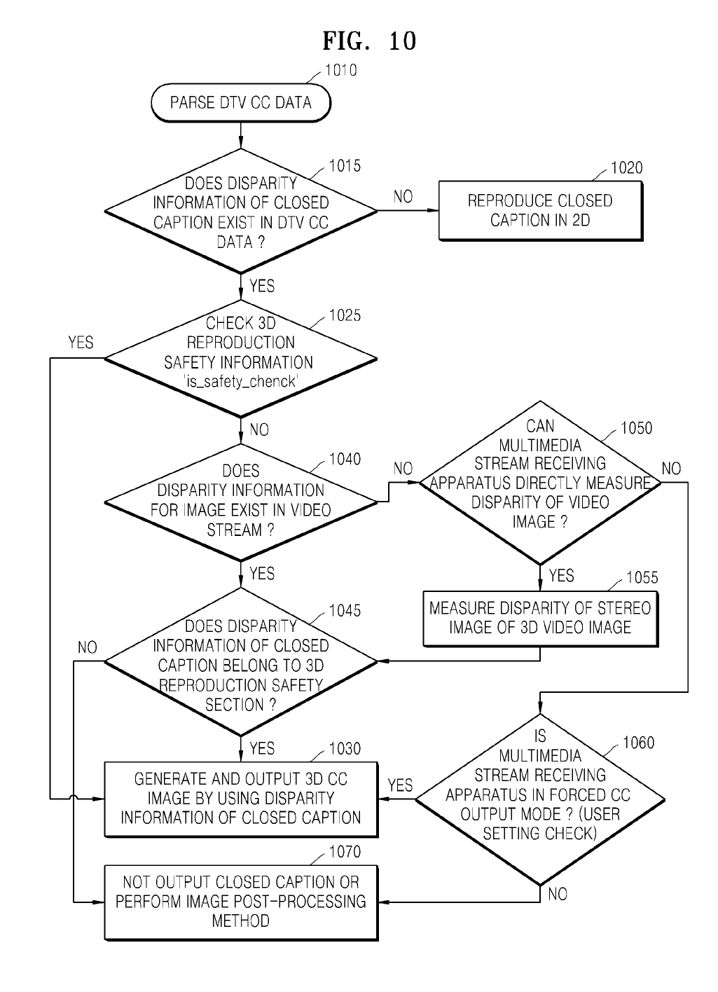

FIG. 8 is a plan view of a screen that adjusts a depth of a closed caption, according to the first exemplary embodiment.

The reproducer 240 of the multimedia stream receiving apparatus 200 according to the first exemplary embodiment may move the location of a right-view caption region 825 from a left-view caption region 815 by an offset 830 in order to reproduce a caption region 815 of a left-view image 810 and a caption region 825 of a right-view image 820. In this case, the offset 830 may represent a disparity of an actual closed caption and may correspond to a first displacement amount of the first offset type.

The reproducer 240 of the multimedia stream receiving apparatus 200 according to the first exemplary embodiment may move the location of a right-view caption region 845 from a disparity value 855 of a video image by an offset 860 of the closed caption. In this case, a sum of the offset 860 of the closed caption and the disparity value 855 of the video image may become a disparity value 850 of an actual closed caption and may correspond to a second displacement amount of the second offset type.

FIG. 9 is a flowchart of a method in which the multimedia stream receiving apparatus 200 according to the first exemplary embodiment uses 3D caption emphasizing information and offset information of a closed caption.

In operation 910, DTV CC data is input to the reproducer 240 of the multimedia stream receiving apparatus 200 according to the first exemplary embodiment. In operation 920, the reproducer 240 according to the first exemplary embodiment checks the value of the 2D/3D distinguishing information ‘2d_CC’ of the closed caption. If it is determined based on the 2D/3D distinguishing information ‘2d_CC’ of the closed caption that the closed caption is to be reproduced in 2D, the DTV CC data may be reproduced in 2D, in operation 930.

On the other hand, if it is determined based on the 2D/3D distinguishing information ‘2d_CC’ of the closed caption that the closed caption is to be reproduced in 3D, the reproducer 240 according to the first exemplary embodiment may check the 3D caption emphasizing information ‘enhance_CC’ and the offset information ‘cc_offset’ of the closed caption, in operation 940. In operation 950, the reproducer 240 according to the first exemplary embodiment decodes the closed caption data ‘cc_data_{—}1’ and ‘cc_data_{—}2’ of the DTV CC data. If it is determined based on the 3D caption emphasizing information ‘enhance_CC’ in operation 960 that the 3D CC emphasizing data is not used, the reproducer 240 according to the first exemplary embodiment may reproduce the DTV CC data in 3D, in operation 980.

On the other hand, if it is determined based on the 3D caption emphasizing information ‘enhance_CC’ in operation 960 that the 3D CC emphasizing data is used, the reproducer 240 according to the first exemplary embodiment may extract the 3D CC emphasizing data in operation 970, and may reproduce the 3D CC emphasizing data in operation 980.

FIG. 10 is a flowchart of a method in which the multimedia stream receiving apparatus 200 according to the first exemplary embodiment uses 3D reproduction safety information of the closed caption.

DTV CC data is input to the reproducer 240 of the multimedia stream receiving apparatus 200 according to the first exemplary embodiment and parsed, in operation 1010. In operation 1015, the reproducer 240 according to the first exemplary embodiment searches for the disparity information of the closed caption, ‘cc_offset’, from the DTV CC data. If no disparity information of the closed caption exists in the DTV CC data, the reproducer 240 according to the first exemplary embodiment reproduces the closed caption in 2D, in operation 1020.

On the other hand, if disparity information of the closed caption exists in the DTV CC data, the reproducer 240 according to the first exemplary embodiment checks the 3D reproduction safety information ‘is_safety_check’ in the DTV CC data, in operation 1025. If it is determined based on the 3D reproduction safety information ‘is_safety_check’ that the safety of the disparity information of the closed caption is secured, the reproducer 240 according to the first exemplary embodiment reproduces the closed caption in 3D by using the disparity information of the closed caption, in operation 1030.

On the other hand, if it is determined based on the 3D reproduction safety information ‘is_safety_check’ that the safety of the disparity information of the closed caption is not secured, the reproducer 240 according to the first exemplary embodiment searches for disparity information for an image from a video stream, in operation 1040. For example, if a multimedia stream is encoded according to the MPEG-2 TS method, the disparity information for the image may be detected from at least one selected from the group consisting of a parallax information extension field, a depth map, a reserved field of a closed caption data field from among a plurality of fields included in a video ES. If the multimedia stream is encoded according to the ISO media file format, the disparity information for the image may be detected from an SCDI region of the ISO media file format.

If the disparity information for the image exists in the video stream, the reproducer 240 according to the first exemplary embodiment determines whether the disparity information of the closed caption belongs to a 3D reproduction safety section, by comparing the disparity information of the closed caption with disparity information of the image, in operation 1045.

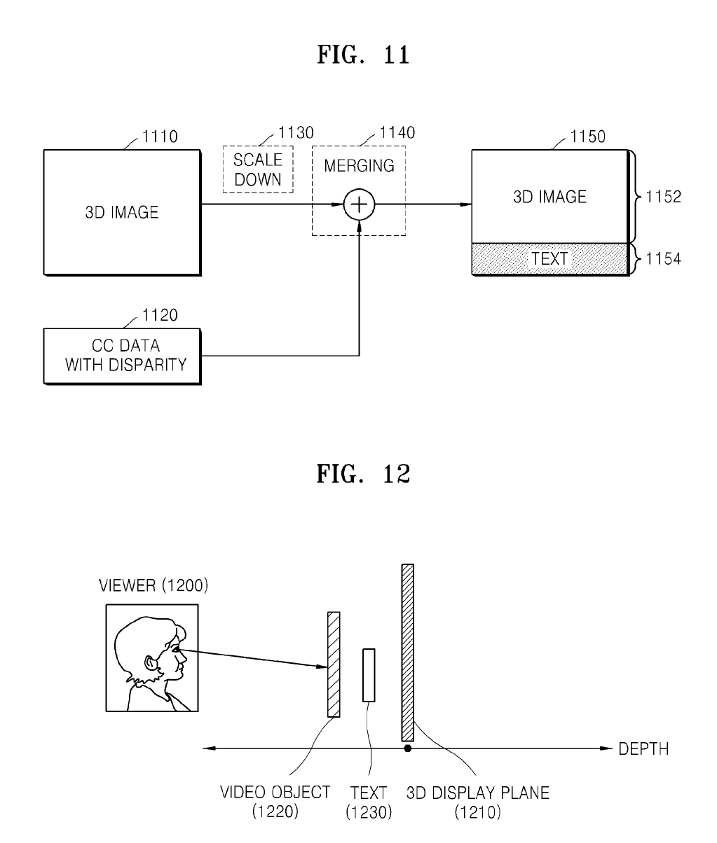

If the disparity information of the closed caption belongs to the 3D reproduction safety section, the reproducer 240 according to the first exemplary embodiment reproduces the closed caption in 3D by using the disparity information of the closed caption, in operation 1030. On the other hand, if the disparity information of the closed caption does not belong to the 3D reproduction safety section, the reproducer 240 according to the first exemplary embodiment may not reproduce the closed caption or may secure the safety of the disparity information of the closed caption through an image post-processing method and then reproduce the closed caption in 3D, in operation 1070. Various exemplary embodiments of the image post-processing technique will be described later with reference to FIGS. 11, 12, 13, 14, and 15.

If it is determined in operation 1040 that the disparity information for the image does not exist in the video stream, it is determined whether the multimedia stream receiving apparatus 200 according to the first exemplary embodiment can directly measure the disparity of a video image, in operation 1050. If the multimedia stream receiving apparatus 200 according to the first exemplary embodiment includes an image disparity measuring unit, a disparity of a stereo image of a 3D video image is measured, in operation 1055. In operation 1045, the reproducer 240 according to the first exemplary embodiment determines whether the disparity information of the closed caption belongs to the 3D reproduction safety section, by comparing the disparity information of the closed caption with information about the disparity measured in operation 1055. According to a result of the determination in operation 1045, an operation 1030 or 1070 may be performed.

On the other hand, if the multimedia stream receiving apparatus 200 according to the first exemplary embodiment does not include an image disparity measuring unit, it may be determined whether the multimedia stream receiving apparatus 200 is set to be in a forced CC output mode according to a user's setting, in operation 1060. If the CC output mode of the multimedia stream receiving apparatus 200 is the forced CC output mode, the reproducer 240 according to the first exemplary embodiment reproduces the closed caption in 3D by using the disparity information of the closed caption, in operation 1030. On the other hand, if the CC output mode of the multimedia stream receiving apparatus 200 is not set to be the forced CC output mode, the reproducer 240 according to the first exemplary embodiment may not reproduce the closed caption or may secure the safety of the disparity information of the closed caption through the image post-processing method and then reproduce the closed caption in 3D, in operation 1070.

FIG. 11 illustrates an example of the image post-processing method which is performed when the safety is not ensured based on the 3D reproduction safety information of the closed caption according to the first exemplary embodiment.

When it is determined based on the 3D reproduction safety information ‘is_safety_check’ of the closed caption that the safety is not ensured, the reproducer 240 according to the first exemplary embodiment may output closed caption data 1120 having disparity information so as to be forcedly arranged in a predetermined region of a 3D image 1110.

For example, the reproducer 240 according to the first exemplary embodiment scales down the 3D image 1110 vertically in operation 1130, and merges a result of the scaling-down with the closed caption data 1120 in operation 1140. A resultant image 1150 corresponding to a result of the merging may be divided into a vertically reduced 3D image region 1152 and a closed caption region 1154. The vertically reduced 3D image region 1152 and the closed caption region 1154 may be independently reproduced in 3D so that they do not overlap each other.

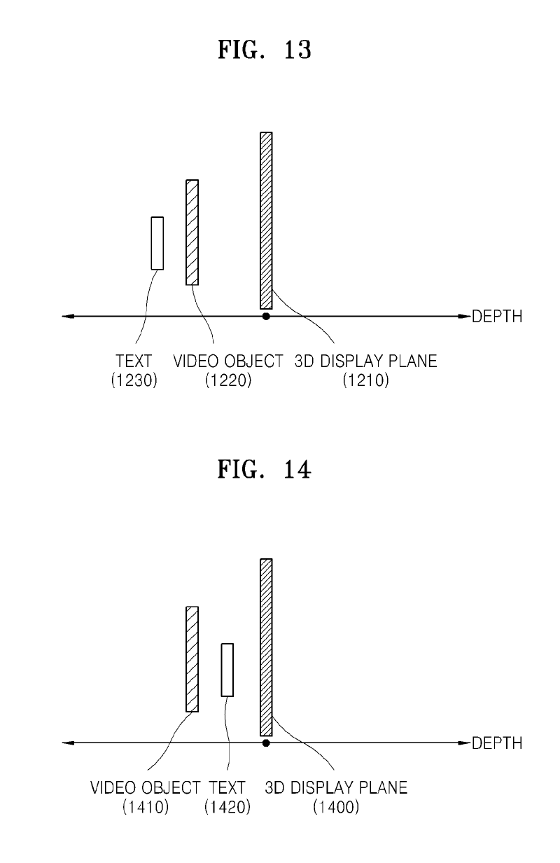

FIGS. 12 and 13 illustrate another example of the image post-processing method which is performed when the safety is not ensured based on the 3D reproduction safety information of the closed caption according to the first exemplary embodiment.

In FIG. 12, as 3D video is reproduced on a 3D display plane 1210, a video object region 1220 protrudes by a unique depth and is displayed. In this case, if a text region 1230 of a closed caption is displayed between the 3D display plane 1210 and the video object region 1220, a viewer 1200 may feel dizzy and fatigued when confused with a depth of a video object and a depth of a text.

In FIG. 13, if disparity information of the video object region 1230 can be acquired, the reproducer 240 according to the first exemplary embodiment may adjust the disparity information of the video object region 1230 so that the text region 1230 protrudes toward the viewer 1200 relative to the video object region 1220. If disparity information of all image pixels can be ascertained, the reproducer 240 according to the first exemplary embodiment may move a pixel location of a caption region of the text region 1230 to a location that is not overlapped by the video object region 1220 in terms of a depth sequence.

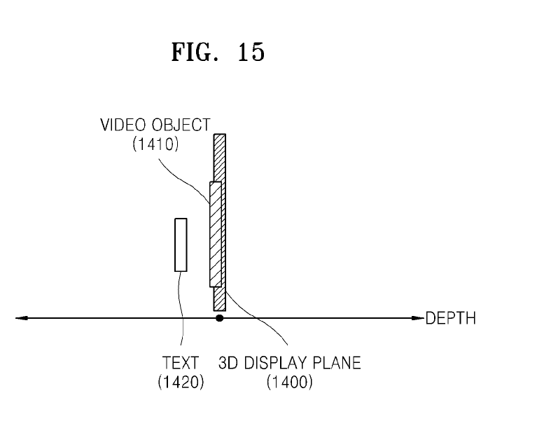

FIGS. 14 and 15 illustrate another example of the image post-processing method which is performed when the safety is not ensured based on the 3D reproduction safety information of the closed caption according to the first exemplary embodiment.

In FIG. 14, although a video object region 1410 is displayed protruding by a unique depth as a 3D video is reproduced on a 3D display plane 1400, a depth reversal phenomenon where a text region 1420 of a closed caption exists between the 3D display plane 1400 and the video object region 1410 occurs.

In FIG. 15, the reproducer 240 according to the first exemplary embodiment switches from a 3D reproduction mode to a 2D reproduction mode and reproduces a 3D video image in the 2D reproduction mode. In other words, the reproducer 240 according to the first exemplary embodiment may reproduce the video object region 1410 in 2D so as to be displayed on the 3D display plane 1400 and may reproduce the text region 1420 in 3D based on unique disparity information. Accordingly, a depth of the video object region 1410 becomes 0, and thus the depth reversal phenomenon between the text region 1420 and the video object region 1410 may be solved.

The multimedia stream generating apparatus 100 according to the first exemplary embodiment may insert closed caption 3D reproduction information for providing a 3D depth to a closed caption into a data stream and transmit the closed caption 3D reproduction information included in the data stream, together with a video image and an audio image. The multimedia stream receiving apparatus 200 according to the first exemplary embodiment may extract closed caption data and closed caption 3D reproduction information from a received multimedia stream. Based on the closed caption 3D reproduction information, the multimedia stream receiving apparatus 200 according to the first exemplary embodiment may select a closed caption reproducing method by checking the safety of a closed caption, adjust a depth of the closed caption, and use a closed caption for emphasizing a 3D reproduction effect of the closed caption. Accordingly, the 3D video image and the closed caption may be naturally reproduced.

Generation and reception of a multimedia stream for 3D reproduction of a subtitle according to an exemplary embodiment now be described in detail with reference to Tables 14 through 48 and FIGS. 16 through 34.

FIG. 16 illustrates generation and reception of a multimedia stream of subtitle data, according to an exemplary embodiment.

Referring to FIG. 16, a single program encoder 1600 receives video data and audio data and encodes the video data and audio data by using a video encoder 1610 and an audio encoder 1620, respectively. The encoded video data and the encoded audio data are packetized into video PES packets and audio PES packets, respectively, by using packetizers 1630 and 1640. In the current exemplary embodiment, the single program encoder 1600 receives subtitle data from a subtitle generator station 1650. A PSI generator 1660 generates information about various programs, such as a PAT and a PMT.

A MUX 1670 of the single program encoder 1600 not only receives the video PES packets and the audio PES packets from the packetizers 1630 and 1640, but also receives a subtitle data packet in a PES packet form, and the information about various programs in a section form from the PSI generator 1660, and generates and outputs a TS about one program by multiplexing the video PES packets, the audio PES packets, the subtitle data packet, and the information about various programs.

When the single program encoder 1600 has generated and transmitted the TS according to a DVB communication method, a DVB set-top box 1680 receives the TS and parses the TS to restore a video image, an audio image, and a subtitle. On the other hand, when the single program encoder 1600 has generated and transmitted the TS according to a cable broadcasting method, a cable set-top box 1685 may receive the TS and parse the TS to restore a video image, an audio image, and a subtitle. A television (TV) 1690 reproduces the video image and the audio image, and reproduces the subtitle by overlaying the subtitle on the video image displayed on a screen.

The multimedia stream generating apparatus 100 according to the second or third exemplary embodiment may additionally insert and transmit information for 3D information of a 3D video image and a subtitle, in addition to the operation of the single program encoder 1600. The multimedia stream receiving apparatus 200 according to the second or third exemplary embodiment may reproduce a 3D video image and a subtitle in 3D in addition to the operations of either the DVB set-top box 1680 or the cable set-top box 1685 and the TV 1690.

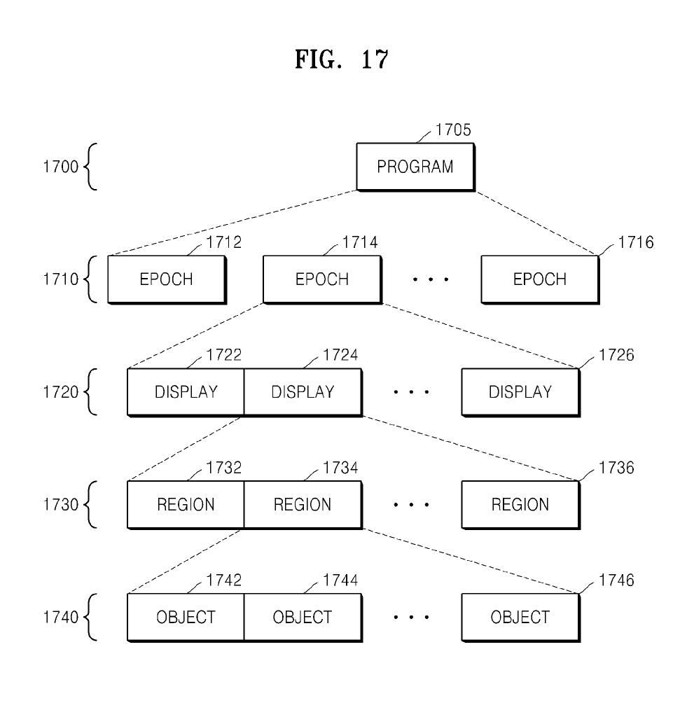

Generation and reception of a multimedia stream for 3D reproduction of a subtitle according to a DVB communication method according to the second exemplary embodiment will now be described in detail with reference to Tables 14 through 34 and FIGS. 17 through 27.

FIG. 17 is a diagram of a hierarchical structure of subtitle data complying with a DVB communication method.

Display data complying with a DVB communication method has the hierarchical structure of a program level 1700, an epoch level 1710, a display sequence level 1720, a region level 1730, and an object level 1740.

In detail, a program 1705 includes a plurality of epoch units 1712, 1714, and 1716.

An epoch unit denotes a time unit in which a memory layout in a decoder is maintained without changes. In other words, data included in the epoch unit 1712 is stored in a buffer of a subtitle decoder until data in a next epoch is transmitted to the buffer. The memory layout may be changed by resetting a decoder state according to reception of a page composition segment having a page state indicating a mode switch. Accordingly, in a period of time between the consecutive epoch units 1712 and 1714, a page composition segment having a page state indicating a mode switch is received by the decoder. The epoch unit 1714 includes a plurality of display sequence units 1722, 1724, and 1726.

Each of the display sequence units 1722, 1724, and 1726 indicates a complete graphic scene and may be maintained on a screen for several seconds. For example, the display sequence unit 1724 may include a plurality of region units 1732, 1734, and 1736 each having a designated display location.

Each of the region units 1732, 1734, and 1736 makes a pair with a color look-up table (CLUT) that defines colors and transparencies which are to be applied to all pixel codes. A pixel depth indicates the entry of colors to be applied to each of the region units 1732, 1734, and 1736, and 2-bit, 4-bit, and 8-bit pixel depths support pixel codes of 4, 16, and 256 colors, respectively. For example, the region unit 1734 may define a background color and include graphic object units 1742, 1744, and 1746, which are to be displayed in the region unit 1734.

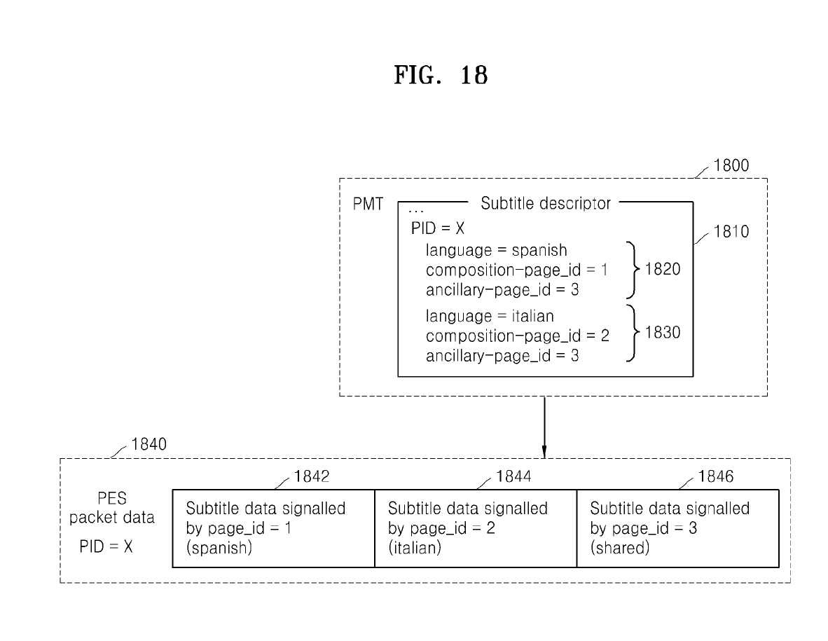

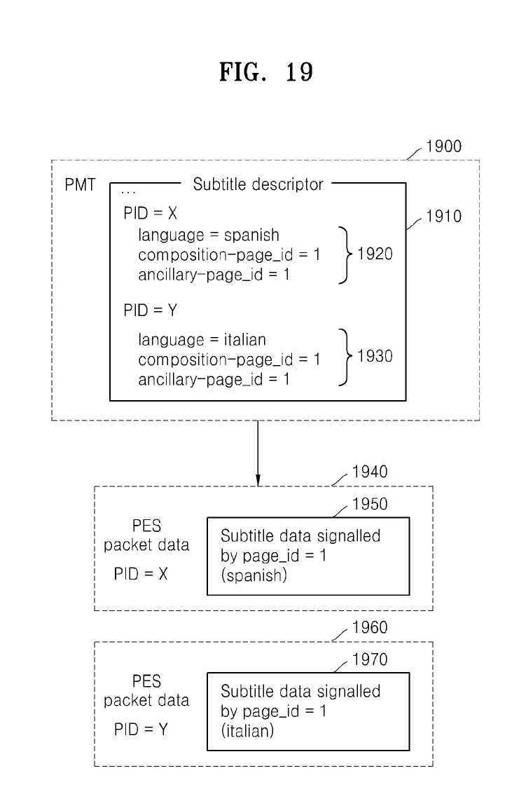

FIGS. 18 and 19 illustrate two expression types of a subtitle descriptor in a PMT indicating a PES packet of a subtitle, according to a DVB communication method.

One subtitle stream may transmit at least one subtitle service. The at least one subtitle service is multiplexed to one packet, and the packet may be transmitted with one piece of packet identifier (PID) information. Alternatively, each subtitle service may be configured to an individual packet, and each packet may be transmitted with individual PID information. A corresponding PMT may include the PID information about the subtitle services of a program, language, and a page identifier.

FIG. 18 is a diagram illustrating a subtitle descriptor and a subtitle PES packet, when at least one subtitle service is multiplexed into one packet. In FIG. 18, at least one subtitle service is multiplexed to a PES packet 1840 and is assigned with the same PID information X, and accordingly, a plurality of pages 1842, 1844, and 1846 for the subtitle service are subordinated to the same PID information X.

Subtitle data of the page 1846, which is an ancillary page, is shared with other subtitle data of the pages 1842 and 1844.

A PMT 1800 may include a subtitle descriptor 1810 about the subtitle data. The subtitle descriptor 1810 defines information about the subtitle data according to packets. In the same packet, information about subtitle services may be classified according to pages. In other words, the subtitle descriptor 1810 includes information about the subtitle data in the pages 1842, 1844, and 1846 in the PES packet 1840 having the PID information X. Each of subtitle data information 1820 and 1830, which are respectively defined according to the pages 1842 and 1844 in the PES packet 1840, may include language information ‘language’, a composition page identifier ‘composition-page_id’, and an ancillary page identifier ‘ancillary-page_id’.

FIG. 19 is a diagram illustrating a subtitle descriptor and a subtitle PES packet, when a subtitle service is formed in an individual packet. A first page 1950 for a first subtitle service is formed of a first PES packet 1940, and a second page 1970 for a second subtitle service is formed of a second PES packet 1960. The first and second PES packets 1940 and 1960 are respectively assigned with PID information X and PID information Y.

A subtitle descriptor 1910 of a PMT 1900 may include PID information values of a plurality of subtitle PES packets, and may define information about the subtitle data of the subtitle PES packets according to PES packets. In other words, the subtitle descriptor 1910 may include subtitle service information 1920 about the first page 1950 of the subtitle data in the first PES packet 1940 having PID information X, and subtitle service information 1930 about the second page 1970 of the subtitle data in the second PES packet 1960 having PID information Y.

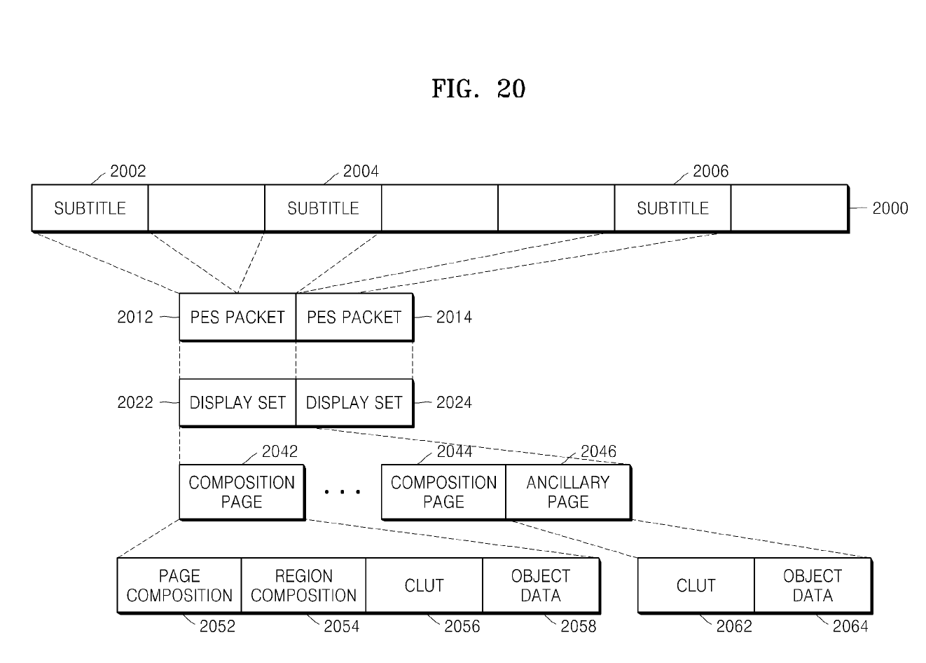

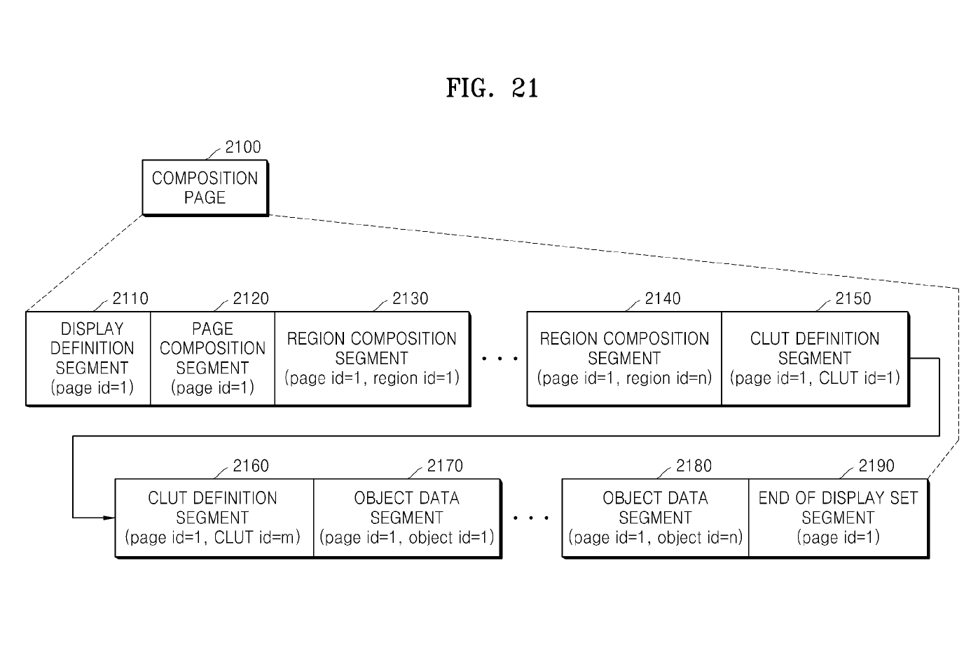

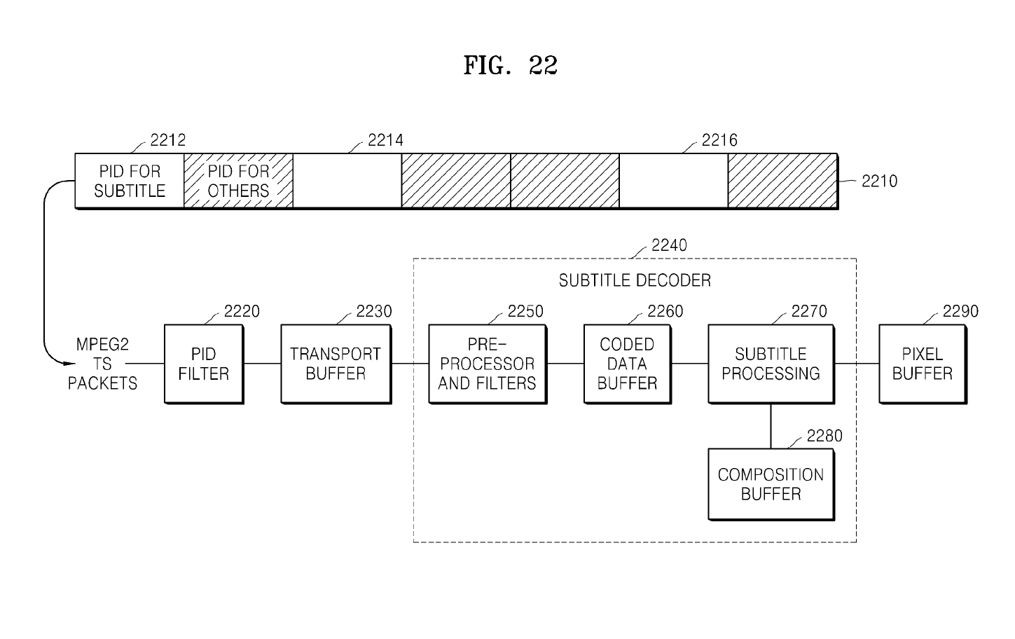

FIG. 20 is a diagram of a structure of a datastream including subtitle data complying with a DVB communication method, according to an exemplary embodiment.

Subtitle PES packets 2012 and 2014 are constructed by gathering subtitle TS packets 2002, 2004, and 2206 assigned with the same PID information from a DVB TS 2000 including a subtitle complying with the DVB communication method. The subtitle TS packets 2002 and 2006 respectively forming starting parts of the subtitle PES packets 2012 and 2014 are respectively headers of the subtitle PES packets 2012 and 2014.

The subtitle PES packets 2012 and 2014 include display sets 2022 and 2024, respectively. The display set 2022 includes a plurality of composition pages 2042 and 2044 and an ancillary page 2046. The composition page 2042 includes a page composition segment 2052, a region composition segment 2054, a CLUT definition segment 2056, and an object data segment 2058. The ancillary page 2046 includes a CLUT definition segment 2062 and an object data segment 2064.

FIG. 21 is a diagram of a structure of a composition page 2100 complying with a DVB communication method, according to an exemplary embodiment.

The composition page 2100 includes a display definition segment 2110, a page composition segment 2120, region composition segments 2130 and 2140, CLUT definition segments 2150 and 2160, object data segments 2170 and 2180, and an end of display set segment 2190. The composition page 2100 may include a plurality of region composition segments, a plurality of CLUT definition segments, or a plurality of object data segments.

All of the display definition segment 2110, the page composition segment 2120, the region composition segments 2130 and 2140, the CLUT definition segments 2150 and 2160, the object data segments 2170 and 2180, and the end of display set segment 2190 forming the composition page 2100 having a page identifier of 1 have a page identifier ‘page id’ of 1. Region identifiers ‘region id’ of the region composition segments 2130 and 2140 may each be set to an index according to regions, and CLUT identifiers ‘CLUT id’ of the CLUT definition segments 2150 and 2160 may each be set to an index according to CLUTs. Also, object identifiers ‘object id’ of the object data segments 2170 and 2180 may each be set to an index according to object data.

Syntaxes of the display definition segment 2110, the page composition segment 2120, the region composition segments 2130 and 2140, the CLUT definition segments 2150 and 2160, the object data segments 2170 and 2180, and the end of display set segment 2190 may be encoded in subtitle segments and may be inserted into a payload region of a subtitle PES packet.

Table 14 shows a syntax of a ‘PES_data_field’ field stored in a PES_packet_data_bytes' field in a DVB subtitle PES packet. Subtitle data stored in the DVB subtitle PES packet may be encoded in a form of the ‘PES_data_field’ field.

TABLE 14
Syntax

```
PES_data_field( ){
    data_identifier
    subtitle_stream_id
    while nextbits( ) == ‘0000 1111’ {
        subtitling_segment( )
}
    end_of_PES_data_field_marker
}
```

A value of a ‘data_identifier’ field is fixed to 0x20 to indicate that current PES packet data is DVB subtitle data. A ‘subtitle_stream_id’ field includes an identifier of a current subtitle stream, and is fixed to 0x00. An ‘end_of_PES_data_field_marker’ field includes information indicating whether a current data field is a PES data field end field, and is fixed to ‘1111 1111’. A syntax of a ‘subtitling_segment’ field is shown in Table 15 below.

TABLE 15
Syntax

```
subtitling_segment( ) {
    sync_byte
    segment_type
    page_id
    segment_length
    segment_data_field( )
}
```

A ‘sync_byte’ field is encoded to ‘0000 1111’. When a segment is decoded based on a value of a ‘segment_length’ field, a ‘sync_byte’ field is used to determine a loss or a non-loss of a transport packet by checking synchronization.

A ‘segment_type’ field includes information about a type of data included in a segment data field.

Table 16 shows a segment type defined by a ‘segment_type’ field.

TABLE 16

| Value | Segment Type |
|---|---|
| 0x10 | Page Composition Segment |
| 0x11 | Region Composition Segment |
| 0x12 | CLUT Definition Segment |
| 0x13 | Object Data Segment |
| 0x14 | Display Definition Segment |
| 0x40-0x7F | Reserved for Future Use |
| 0x80 | End of Display Set Segment |
| 0x81-0xEF | Private Data |
| 0xFF | Stuffing |
| All Other Values | Reserved for Future Use |

A ‘page_id’ field includes an identifier of a subtitle service included in the ‘subtitling_segment’ field. Subtitle data about one subtitle service is included in a subtitle segment assigned with a value of a ‘page_id’ field that is set as a composition page identifier in a subtitle descriptor. Also, data that can be shared by a plurality of subtitle services is included in a subtitle segment assigned with a value of the ‘page_id’ field that is set as an ancillary page identifier in the subtitle descriptor.

A ‘segment_length’ field includes information about the number of bytes included in a ‘segment_data_field’ field subsequent to the ‘segment_length’ field. The ‘segment_data_field’ field is a payload region of a segment, and a syntax of the payload region may vary according to the type of segment. A syntax of the payload region according to the types of segments is shown in Tables 17, 18, 20, 25, 26, and 28.

Table 17 shows a syntax of a ‘display_definition_segment’ field.

TABLE 17
Syntax

```
display_definition_segment( ){
    sync_byte
    segment_type
    page_id
    segment_length
    dds_version_number
    display_window_flag
    reserved
    display_width
    display_height
    if (display_window_flag == 1) {
        display_window_horizontal_position_minimum
        display_window_horizontal_position_maximum
        display_window_vertical_position_minimum
        display_window_vertical_position_maximum
  }
}
```

The display definition segment may define the resolution of a subtitle service.

A ‘dds_version_number’ field includes version information of the display definition segment. A version number constituting a value of the ‘dds_version_number’ field increases in units of modulo 16 whenever the content of the display definition segment changes.

When a value of a ‘display_window_flag’ field is set to 1, a DVB subtitle display set related to the display definition segment defines a window region in which the subtitle is to be displayed, within a display size defined by a ‘display_width’ field and a ‘display_height’ field. Here, in the display definition segment, a size and a location of the window region is defined according to values of a ‘display_window_horizontal_position_minimum’ field, a ‘display_window_horizontal_position_maximum’ field, a ‘display_window_vertical_position_minimum’ field, and a ‘display_window_vertical_position_maximum’ field.

When the value of the ‘display_window_flag’ field is set to 0, the DVB subtitle display set is expressed directly within a display defined by the ‘display_width’ field and the ‘display_height’ field, not in the window region of the display.

The ‘display_width’ field and the ‘display_height’ field respectively include a maximum horizontal width and a maximum vertical height of a display, and values thereof may each be set in a range from 0 to 4095.

A ‘display_window_horizontal_position_minimum’ field includes a horizontal minimum location of a window region of a display. The horizontal minimum location of the window region is defined with a left end pixel value of a DVB subtitle display window based on a left end pixel of the display.

A ‘display_window_horizontal_position_maximum’ field includes a horizontal maximum location of the window region in the display. The horizontal maximum location of the window region is defined with a right end pixel value of the DVB subtitle display window based on the left end pixel of the display.

A ‘display_window_vertical_position_minimum’ field includes a vertical minimum pixel location of the window region in the display. The vertical minimum pixel location is defined with an uppermost line value of the DVB subtitle display window based on an upper line of the display.

A ‘display_window_vertical_position_maximum’ field includes a vertical maximum pixel location of the window region in the display. The vertical maximum pixel location is defined with a lowermost line value of the DVB subtitle display window based on the upper line of the display.

Table 18 shows a syntax of a ‘page_composition_segment’ field.

TABLE 18
Syntax

```
Page_composition_segment( ){
    sync_byte
    segment_type
    page_id
    segment_length
    page_time_out
    page_version_number
    page_state
    reserved
    while (processed_length < segment_length){
      region_id
      reserved
      region_horizontal_address
      region_vertical_address
  }
)
```

A ‘page_time_out’ field includes information about a period of time for a page to disappear from a screen since the page is not valid, and is set in a unit of seconds. A value of a ‘page_version_number’ field denotes a version number of a page composition segment, and increases in a unit of modulo 16 whenever content of the page composition segment changes.

A ‘page_state’ field includes information about a page state of a subtitle page instance described in the page composition segment. A value of the ‘page_state’ field may denote an operational status of a decoder for displaying a subtitle page according to the page composition segment. Table 19 shows content of the value of the ‘page_state’ field.

TABLE 19

| Value | Page State | Effect on Page | Comments |
|---|---|---|---|
| 00 | Normal | Page Update | Display set contains only subtitle |
| | Case | | elements that are changed from |
| | | | previous page instance |
| 01 | Acquisition | Page Refresh | Display set contains all subtitle |
| | Point | | elements needed to display next |
| | | | page instance |
| 10 | Mode | New Page | Display set contains all subtitle |
| | Change | | elements needed to display the new |
| | | | page |
| 11 | Reserved | | Reserved for future use |

A ‘processed_length’ field includes information about the number of bytes included in a ‘while’ loop to be processed by the decoder. A ‘region_id’ field indicates an intrinsic identifier about a region in a page. Each identified region may be displayed on a page instance defined in the page composition segment. Each region is recorded in the page composition segment according to an ascending order of the value of a ‘region_vertical_address’ field.

A ‘region_horizontal_address’ field includes a location of a horizontal pixel at which an upper left pixel of a corresponding region in a page is to be displayed, and the ‘region_vertical_address’ field defines a location of a vertical line at which the upper left pixel of the corresponding region in the page is to be displayed.

Table 20 shows a syntax of a ‘region composition segment’ field.

TABLE 20
Syntax

```
Region_composition_segment( ){
  sync_byte
  segment_type
  page_id
  segment_length
  region_id
  region_version_number
  region_fill_flag
  reserved
  region_width
  region_height
  region_level_of_compatibility
  region_depth
  reserved
  CLUT_id
  region_8-bit_pixel_code
  region_4-bit_pixel-code
  region_2-bit_pixel-code
  reserved
  while (processed_length < segment_length) {
    object_id
    object_type
    object_provider_flag
      object_horizontal_position
    reserved
    object_vertical_position
    if (object_type ==0x01 or object_type == 0x02){
      foreground_pixel_code
      background_pixel_code
    }
  }
}
```

A ‘region_id’ field includes an intrinsic identifier of a current region.

A ‘region_version_number’ field includes version information of a current region. A version of the current region increases when a condition where a value of a ‘region_fill_flag’ field is set to 1, a condition where a CLUT of the current region is changed, or a condition where a length of the current region is not 0 but includes an object list is true.

When a value of a ‘region_fill_flag’ field is set to 1, the background of the current region is filled with a color defined in a ‘region_n-bit_pixel_code’ field.

A ‘region_width’ field and a ‘region_height’ field respectively include horizontal width information and vertical height information of the current region, and are set in a pixel unit.

A ‘region_level_of_compatibility’ field includes minimum CLUT type information required by a decoder to decode the current region, and is defined according to Table 21.

TABLE 21

| Value | region_level_of_compatibility |
|---|---|
| 0x00 | Reserved |
| 0x01 | 2-bit/Entry CLUT Required |
| 0x02 | 4-bit/Entry CLUT Required |
| 0x03 | 8-bit/Entry CLUT Required |
| 0x04 . . . 0x07 | Reserved |

When the decoder is unable to support an assigned minimum CLUT type, the current region cannot be displayed even though other regions that require a lower level CLUT type are displayed.

A ‘region_depth’ field includes pixel depth information, and is defined according to Table 22.

TABLE 22

| Value | region_depth |
|---|---|
| 0x00 | Reserved |
| 0x01 | 2 bits |
| 0x02 | 4 bits |
| 0x03 | 8 bits |
| 0x04 . . . 0x07 | Reserved |

A ‘CLUT_id’ field includes an identifier of a CLUT to be applied to the current region. A value of a ‘region_{—}8-bit_pixel-code’ field defines a color entry of an 8 bit CLUT to be applied as a background color of the current region, when a ‘region_fill_flag’ field is set. Similarly, values of a ‘region_{—}4-bit_pixel-code’ field and a ‘region_{—}2-bit_pixel-code’ field respectively define color entries of a 4 bit CLUT and a 2 bit CLUT, which are to be applied as the background color of the current region, when the ‘region_fill_flag’ field is set.

An ‘object_id’ field includes an identifier of an object to be displayed on the current region, and an ‘object_type’ field includes object type information defined in Table 23. An object type may be classified into a basic object or a composition object, a bitmap, a character, or a string of characters.

TABLE 23

| Value | object_type |
|---|---|
| 0x00 | basic_object, bitmap |
| 0x01 | basic_object, character |
| 0x02 | composite_object, string of characters |
| 0x03 | Reserved |

An ‘object_provider_flag’ field shows a method of providing an object according to Table 24.

TABLE 24

| Value | object_provider_flag |
|---|---|
| 0x00 | Provided in subtitling stream |
| 0x01 | Provided by POM in IRD |
| 0x02 | Reserved |
| 0x03 | Reserved |

An ‘object_horizontal_position’ field includes information about a location of a horizontal pixel on which an upper left pixel of a current object is to be displayed, as a relative location on which object data is to be displayed in a current region. In other words, the number of pixels from a left end of the current region to the upper left pixel of the current object is defined.

An ‘object_vertical_position’ field includes information about a location of a vertical line on which the upper left pixel of the current object is to be displayed, as the relative location on which the object data is to be displayed in the current region. In other words, the number of lines from the upper end of the current region to an upper line of the current object is defined.

A ‘foreground_pixel_code’ field includes color entry information of an 8-bit CLUT selected as a foreground color of a character. A ‘background_pixel_code’ field includes color entry information of the 8-bit CLUT selected as a background color of the character.

Table 25 shows a syntax of a ‘CLUT_definition_segment’ field.

TABLE 25
Syntax

```
CLUT_definition_segment( ){
  sync_byte
  segment_type
  page_id
  segment length
  CLUT-id
  CLUT_version_number
  reserved
  while (processed_length < segment length) {
    CLUT_entry_id
    2-bit/entry_CLUT_flag
    4-bit/entry_CLUT_flag
    8-bit/entry_CLUT_flag
    reserved
    full_range_flag
    if full_range_flag == ‘1’{
      Y-value
      Cr-value
      Cb-value
      T-value
    } else {
      Y-value
      Cr-value
      Cb-value
      T-value
    }
  }
}
```

A ‘CLUT-id’ field includes an identifier of a CLUT included in a CLUT definition segment in a page. A ‘CLUT_version_number’ field denotes a version number of the CLUT definition segment, and the version number increases in a unit of modulo 16 when content of the CLUT definition segment changes.

A ‘CLUT_entry_id’ field includes an intrinsic identifier of a CLUT entry, and has an initial identifier value of 0. When a value of a ‘2-bit/entry_CLUT_flag’ field is set to 1, a current CLUT is configured of a 2 bit entry, and similarly, when a value of a ‘4-bit/entry_CLUT_flag’ field or ‘8-bit/entry_CLUT_flag’ field is set to 1, the current CLUT is configured of a 4 bit entry or an 8 bit entry.

When a value of a ‘full_range_flag’ field is set to 1, full 8-bit resolution is applied to a ‘Y_value’ field, a ‘Cr_value’ field, a ‘Cb_value’ field, and a ‘T_value’ field.

The ‘Y_value’ field, the ‘Cr_value’ field, and the ‘Cb_value’ field respectively include Y output information, Cr output information, and Cb output information of the CLUT for each input.

The ‘T_value’ field includes transparency information of the CLUT for an input. When a value of the ‘T_value’ field is 0, there is no transparency.

Table 26 shows a syntax of a ‘object_data_segment’ field.

TABLE 26
Syntax

```
object_data_segment( ) {
  sync_byte
  segment_type
  page_id
  segment_length
  object_id
  object_version_number
  object_coding_method
  non_modifying_colour_flag
  reserved
  if (object coding method == ‘00’) {
    top_field_data_block_length
    bottom_field_data_block_length
    while(processed_Iength < top_field_data_block_length)
      pixel-data_sub-block( )
    while (processed_length< bottom_field_data_block_Iength)
      pixel-data_sub-block( )
    if (!wordaligned( ))
      8_stuff_bits
  }
  if (object_coding_method == ‘01’) {
    number_of_codes
    for (i== 1; i<= number_of_codes; i++)
      character_code
  }
}
```

An ‘object_id’ field includes an identifier about a current object in a page. An ‘object_version_number’ field includes version information of a current object data segment, and the version number increases in a unit of modulo 16 whenever content of the object data segment changes.

An ‘object_coding_method’ field includes information about a method of encoding an object. The object may be encoded in a pixel or a string of characters as shown in Table 27.

TABLE 27

| Value | object_coding_method |
|---|---|
| 0x00 | Encoding of pixels |
| 0x01 | Encoded as a string of characters |
| 0x02 | Reserved |
| 0x03 | Reserved |

When a value of a ‘non_modifying_colour_flag’ field is set to 1, an input value 1 of the CLUT may be an ‘unchanged color’. When the unchanged color is assigned to an object pixel, a background or the object pixel in a basic region is not changed.

A ‘top_field_data_block_length’ field includes information about the number of bytes included in a ‘pixel-data_sub-blocks’ field with respect to an uppermost field. A ‘bottom_field_data_block_length’ field includes information about a number of bytes included in a ‘data_sub-block’ with respect to a lowermost field. In each object, a pixel data sub block of the uppermost field and a pixel data sub block of the lowermost field are defined by the same object data segment.

An ‘8_stuff bits’ field is fixed to 0000 0000. A ‘number_of_codes’ field includes information about a number of character codes in a string of characters. A value of a ‘character_code’ field sets a character by using an index in a character code identified in the subtitle descriptor.

Table 28 shows a syntax of an ‘end_of_display_set_segment’ field.

TABLE 28
Syntax

```
end_of_display_set_segment( ) {
  sync_byte
  segment_type
  page_id
  segment_length
}
```

The ‘end_of_display_set_segment’ field is used to notify the decoder that transmission of a display set has completed. The ‘end_of_display_set_segment’ field may be inserted after the last ‘object_data_segment’ field for each display set. Also, the ‘end_of_display_set_segment’ field may be used to classify each subtitle service in one subtitle stream.

FIG. 22 is a flowchart illustrating a subtitle processing model 2200 complying with a DVB communication method.

According to the subtitle processing model 2200 complying with the DVB communication method, a TS 2210 including subtitle data is decomposed into MPEG-2 TS packets. A PID filter only extracts TS packets 2212, 2214, and 2216 for a subtitle assigned with PID information from among the MPEG-2 TS packets, in operation 2220, and transmits the extracted the TS packets 2212, 2214, and 2216 to a transport buffer. In operation 2230, the transport buffer forms subtitle PES packets by using the TS packets 2212, 2214, and 2216 for the subtitle. Each of the subtitle PES packets may include a PES payload including subtitle data, and a PES header. In operation 2240, a subtitle decoder receives the subtitle PES packets output from the transport buffer, and forms a subtitle to be displayed on a screen.

A subtitle decoding operation 2240 may include a pre-processing and filtering operation 2250, a coded data buffering operation 2260, a subtitle processing operation 2270, and a composition buffering operation 2280.

For example, it is assumed that a page having a ‘page_id’ field of 1 is selected from a PMT by a user. In the pre-processing and filtering operation 2250, composition pages having a ‘page_id’ field of 1 in the PES payload are decomposed into display definition segments, page composition segments, region composition segments, CLUT definition segments, and object data segments. In operation 2260, at least one piece of object data in at least one object data segment from among the decomposed segments is stored in an encoded data buffer. In operation 2280, the display definition segment, the page composition segment, the at least one region composition segment, and the at least one CLUT definition segment are stored in the composition buffer.

In the subtitle processing operation 2270, the at least one piece of object data is received from the coded data buffer, and the subtitle formed of a plurality of objects are generated based on the display definition segment, the page composition segment, the at least one region composition segment, and the at least one CLUT definition segment stored in the composition buffer.

In operation 2290, subtitle configured in the subtitle decoding operation 2240 is stored in a pixel buffer.

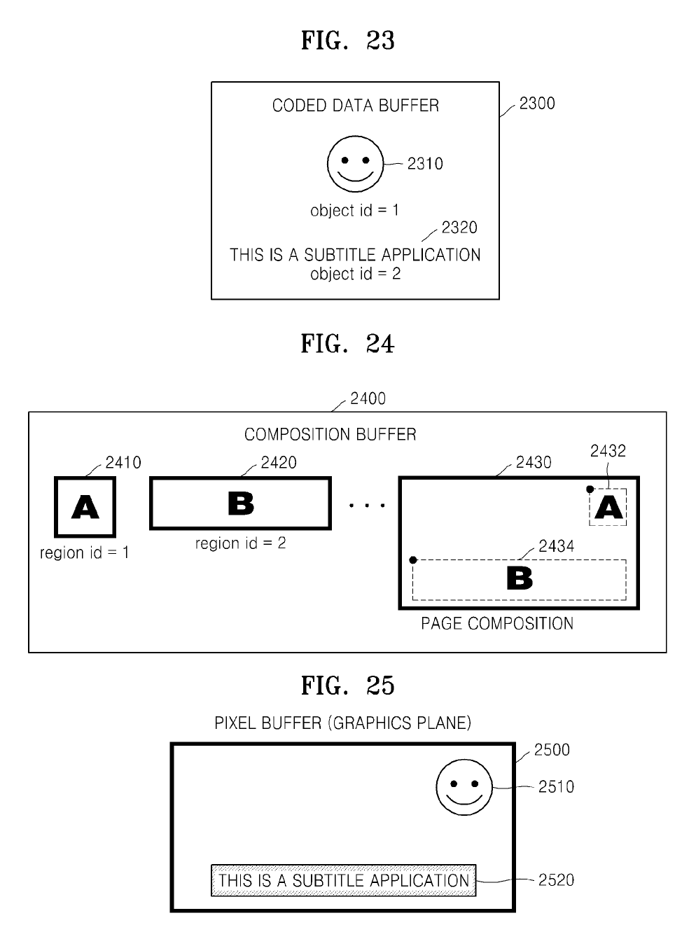

FIGS. 23, 24, and 25 are diagrams illustrating data stored respectively in a coded data buffer 2300, a composition buffer 2400, and a pixel buffer.

Referring to FIG. 23, object data 2310 having an object ID of 1, and object data 2320 having an object ID of 2 are stored in the coded data buffer 2300.

Referring to FIG. 24, information about a first region 2410 having a region ID of 1, information about a second region 2420 having a region ID of 2, and information about a page composition 2430 formed of regions 2432 and 2434, to which the first and second regions 2410 and 2420 are mapped, are stored in the composition buffer 2400.

In the subtitle processing operation 2270 of FIG. 22, a subtitle page 2500, in which subtitle objects 2510 and 2520 are disposed according to regions, is stored in the pixel buffer based on information about the object data 2310 and 2320 stored in the coded data buffer 2300, and information about the first region 2410, the second region 2420, and the page composition 2430 stored in the composition buffer 2400.

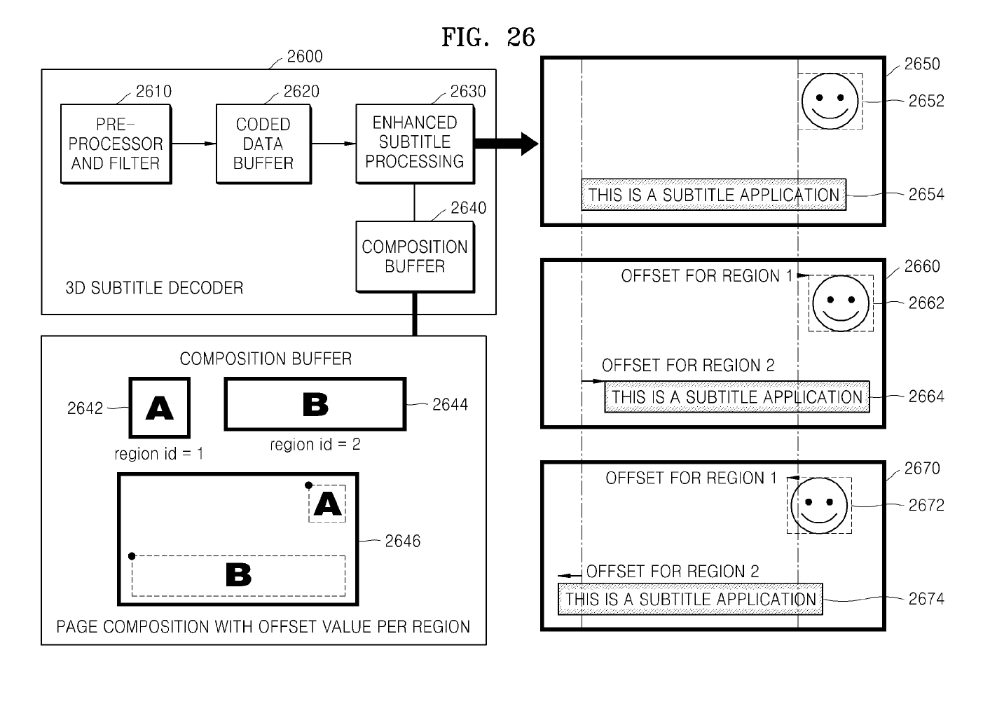

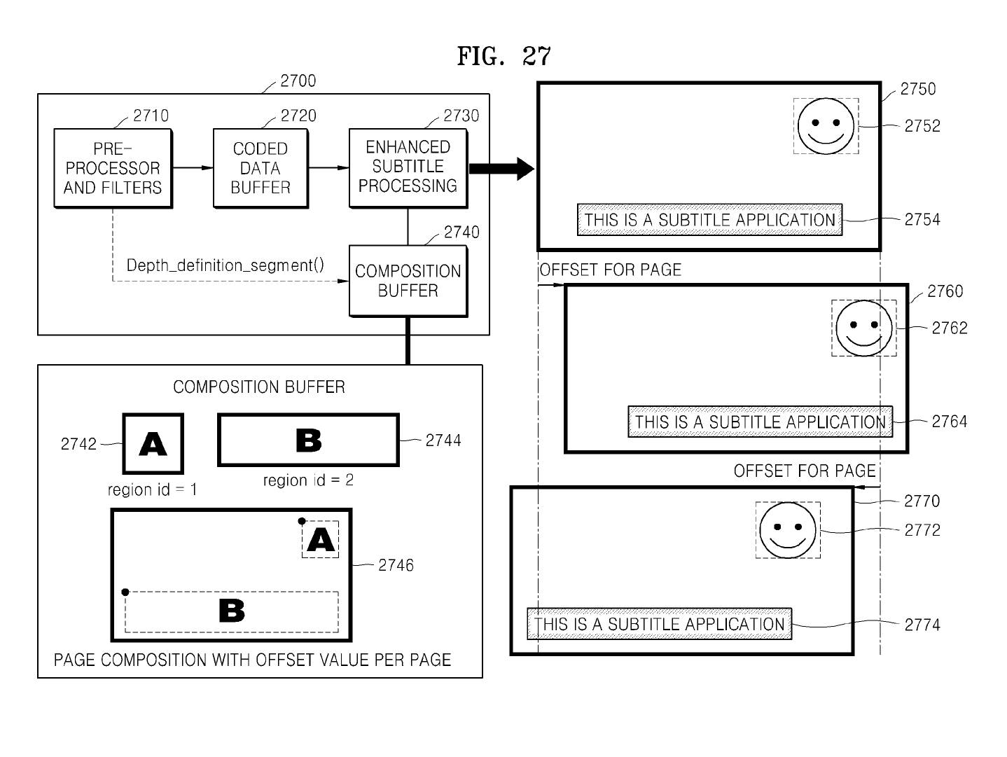

Operations of the multimedia stream generating apparatus 100 according to the second exemplary embodiment and the multimedia stream receiving apparatus 200 according to the second exemplary embodiment in order to achieve 3D reproduction of a subtitle will now be described with reference to Tables 29 through 34 and FIGS. 26 through 29, based on the subtitle complying with the DVB communication method described with reference to Tables 14 through 28 and FIGS. 16 through 25.

The multimedia stream generating apparatus 100 according to the second exemplary embodiment may insert information for reproducing a DVB subtitle in 3D into a subtitle PES packet. Here, the information may include offset information such as a depth, a parallax, a coordinate, etc., as information about a subtitle depth.

The program encoder 110 of the multimedia stream generating apparatus 100 according to the second exemplary embodiment may insert the information for reproducing the DVB subtitle in 3D into the page composition segment of the composition page in the subtitle PES packet. In addition, the program encoder 110 according to the second exemplary embodiment may newly define a segment for defining the subtitle depth and insert the segment into a PES packet.

Tables 29 and 30 show syntaxes of a page composition segment modified by the program encoder 110 according to the second exemplary embodiment to include depth information of a DVB subtitle.

TABLE 29
Syntax

```
page_composition_segment( ){
  sync_byte
  segment_type
  page_id
  segment_length
  page_time_out
  page_version_number
  page_state
  reserved
  while (processed_length < segment_length){
    region_id
    region_offset_direction
    region_offset
    region_horizontal_address
    region_vertical_address
  }
}
```

As shown in Table 29, the program encoder 110 according to the second exemplary embodiment may additionally insert a ‘region_offset_direction’ field and a “region_offset” field into the ‘reserved’ field in a while loop in the ‘page_composition_segment( )’ field of Table 18. For example, the program encoder 110 according to the second exemplary embodiment may assign 1 bit to the ‘region_offset_direction’ field and 7 bits to the ‘region_offset’ field in replacement of 8 bits of the ‘reserved’ field.

The ‘region_offset_direction’ field may include direction information of an offset of a current region. When the value of the ‘region_offset_direction’ field is ‘0’, the offset of the current region is set to be positive. When the value of the ‘region_offset_direction’ field is ‘1’, the offset of the current region is set to be negative.

The ‘region_offset’ field may include offset information of the current region. In order to generate a left-view subtitle or a right-view subtitle by using a 2D subtitle, a pixel displacement value of a x-coordinate value of the current region defined as a subtitle region by the value of a ‘region_horizontal_address’ field may be set as the value of the ‘region_offset’ field.

TABLE 30
Syntax

```
page_composition_segment( ){
  sync_byte
  segment_type
  page_id
  segment_length
  page_time_out
  page_version_number
  page_state
  reserved
  while (processed_length < segment_length){
    region_id
    region_offset_based_position
    region_offset_direction
    region_offset
    region_horizontal_address
    region_vertical_address
  }
}
```

The program encoder 110 according to the second exemplary embodiment may add a ‘region_offset_based_position’ field to the modified page composition segment of Table 29. 1 bit of a ‘region_offset_direction’ field, 6 bits of a ‘region_offset’ field, and 1 bit of a ‘region_offset_based_position’ field may be assigned instead of 8 bits of the ‘reserved’ field in the basic page composition segment of Table 18.

The ‘region_offset_based_position’ field may include flag information indicating whether an offset value of the ‘region_offset’ field is applied based on a zero plane or based on a depth of a video image.

Tables 31, 32, 33, and 34 show syntaxes of a ‘Depth_Definitioin_Segment’ field constituting a depth definition segment newly defined by the program encoder 110 according to the second exemplary embodiment to define the depth of the subtitle.

The program encoder 110 according to the second exemplary embodiment may insert pieces of information related to the offset of the subtitle such as the ‘Depth_Definition_Segment’ field into the ‘segment_data_field’ field in the ‘subtitling_segment’ field of Table 15, as an additional segment. Accordingly, the program encoder 110 according to the second exemplary embodiment may add the depth definition segment as a subtitle type. For example the multimedia stream generating apparatus 100 according to the second exemplary embodiment may guarantee low-level compatibility with a DVB subtitle system by additionally defining the depth definition segment by using one value from a reserved region of the ‘subtitle_type’ field of Table 16, wherein a value of the ‘subtitle_type’ field is from ‘0x40’ to ‘0x7F’.

The multimedia stream generating apparatus 100 according to the second exemplary embodiment may newly generate a depth definition segment that defines the offset information of the subtitle in a page unit. Syntaxes of the ‘Depth_Definition_Segment’ field are shown in Tables 31 and 32.

TABLE 31
Syntax

```
Depth_Definition_Segment( ) {
  sync_byte
  segment_type
  page_id
  segment_length
  page_offset_direction
  page_offset
  ......
```

TABLE 32
Syntax

```
Depth_Definition_Segment( ) {
  sync_byte
  segment_type
  page_id
  segment_length
  page_offset_based_position
  page_offset_direction
  page_offset
......
```

A ‘page_offset_direction’ field in Tables 31 and 32 may include information about the offset direction for a current page. A ‘page_offset’ field may include offset information for the current page. That is, the value of the ‘page_offset’ field may indicate a pixel displacement value of an x-coordinate value of the current page.

The program encoder 110 according to the second exemplary embodiment may include a ‘page_offset_based_position’ field in the depth definition segment. The ‘page_offset_based_position’ field may include flag information indicating whether an offset value of the ‘page_offset’ field is applied based on a zero plane or based on offset information of a video image.

According to the depth definition segment of Table 31 and 32, the same offset information may be applied in one page.

The multimedia stream generating apparatus 100 according to the second exemplary embodiment may newly generate a depth definition segment that defines the offset information of the subtitle in a region unit. Here, syntaxes of a ‘Depth_Definition_Segment’ field are as shown in Tables 33 and 34.

TABLE 33
Syntax

```
Depth_Definition_Segment( ) {
  sync_byte
  segment_type
  page_id
  segment_length
  for (i=0; i<N; i++){
    region_id
    region_offset_direction
    region_offset
  }
......
```

TABLE 34
Syntax

```
Depth_Definition_Segment( ) {
  sync_byte
  segment_type
  page_id
  segment_length
  for (i=0; i<N; i++){
    region_id
    region_offset_based_position
    region_offset_direction
    region_offset
  }
......
```

A ‘page_id’ field and a ‘region_id’ field in the depth definition segment of Tables 33 and 34 may refer to the same fields in the page composition segment. The multimedia stream generating apparatus 100 according to the second exemplary embodiment may set the offset information of the subtitle according to regions in the current page, through a ‘for’ loop in the newly defined depth definition segment. In other words, the ‘region_id’ field includes identification information of a current region, and a ‘region_offset_direction’ field, a ‘region_offset’ field, and a ‘region_offset_based_position’ field may be separately set according to a value of the ‘region_id’ field. Accordingly, the displacement amount of the pixel in an x-coordinate may be separately set according to regions of the subtitle.

The multimedia stream receiving apparatus 200 according to the second exemplary embodiment may extract composition pages by parsing a received TS, and decode syntaxes of a page composition segment, a region definition segment, a CLUT definition segment, an object data segment, etc. in the composition pages to form a subtitle based on a result of the decoding. Also, the multimedia stream receiving apparatus 200 according to the second exemplary embodiment may adjust depth of a page or a region on which the subtitle is displayed by using the subtitle 3D reproduction information described above with reference to Tables 26 through 34. A method of adjusting depth of a page and a region of a subtitle will now be described with reference to FIGS. 26 and 27.

FIG. 26 is a diagram for describing a method of adjusting the depth of a subtitle according to regions, according to the second exemplary embodiment.

A subtitle decoder 2600 according to an exemplary embodiment is realized by modifying the subtitle decoding operation 2240 described above with reference to FIG. 22, which is the subtitle processing model complying with a DVB communication method. The subtitle decoder 2600 may be understood as a component that performs the operations of the decoder 230 and the reproducer 240 of the multimedia stream receiving apparatus 200 according to the second exemplary embodiment, which are restoration of a subtitle and composition of a 3D subtitle.

The subtitle decoder 2600 includes a pre-processor and filter 2610, a coded data buffer 2620, an enhanced subtitle processor 2630, and a composition buffer 2640. The pre-processor and filter 2610 may output object data in a subtitle PES payload to the coded data buffer 2630, and output subtitle composition information, such as a region definition segment, a CLUT definition segment, a page composition segment, and an object data segment, to the composition buffer 2640. According to an exemplary embodiment the depth information according to regions shown in Tables 29 and 30 may be included in the page composition segment.

For example, the composition buffer 2640 may include information about a first region 2642 having a region ID of 1, information about a second region 2644 having a region ID of 2, and information about a page composition 2646 including an offset value per region.

The enhanced subtitle processor 2630 may form a subtitle page by using the object data stored in the coded data buffer 2620 and the composition information stored in the composition buffer 2640 and may adjust the depth of the subtitle by moving the subtitle according to the offset information for each region. For example, in a 2D subtitle page 2650, a first object and a second object are respectively displayed on a first region 2652 and a second region 2654. The first and second regions 2652 and 2654 may be displaced by a corresponding offset based on the offset information according to regions in the page composition 2646 stored in the composition buffer 2640.

In other words, in a 3D subtitle page 2660 for a left-view image, the first and second regions 2652 and 2654 are displaced in a positive direction respectively by a first region offset and a second region offset so that a first object and a second object are displayed respectively on a first left-view region 2662 and a second left-view region 2664. Similarly, in a 3D subtitle page 2670 for a right-view image, the first and second regions 2652 and 2654 are displaced in a negative direction respectively by the first region offset and the second region offset so that a first object and a second object are displayed respectively on a first right-view region 2672 and a second right-view region 2674.

The 3D subtitle pages 2660 and 2670 to which an offset has been applied for depth adjustment may be stored in a pixel buffer.

FIG. 27 is a diagram for describing a method of adjusting the depth of a subtitle according to pages, according to the second exemplary embodiment.

A subtitle processor 2700 according to an exemplary embodiment includes a pre-processor and filter 2710, a coded data buffer 2720, an enhanced subtitle processor 2730, and a composition buffer 2740. The pre-processor and filter 2710 may output object data in a subtitle PES payload to the coded data buffer 2720, and output subtitle composition information, such as a region definition segment, a CLUT definition segment, a page composition segment, and an object data segment, to the composition buffer 2740. According to an exemplary embodiment, the pre-processor and filter 2710 may transmit and store depth information according to pages or according to regions of the depth definition segment shown in Tables 31 through 34 to and in the composition buffer 2740.

For example, the composition buffer 2740 may store information about a first region 2742 having a region ID of 1, information about a second region 2744 having a region ID of 2, and information about a page composition 2746 including an offset value per page of the depth definition segment shown in Tables 31 and 32.

The enhanced subtitle processor 2730 may adjust the depth of the subtitle by forming the subtitle page and moving the subtitle page according to the offset value per page, by using the object data stored in the coded data buffer 2720 and the composition information stored in the composition buffer 2740. For example, a first object and a second object are respectively displayed on a first region 2752 and a second region 2754 of a 2D subtitle page 2750. The first region 2752 and the second region 2754 may be respectively displaced by a corresponding offset value, based on offset information per page included in the page composition 2746 stored in the composition buffer 2740.

In other words, a subtitle page 2760 for a left-view image is generated by displacing a location of the 2D subtitle page 2750 by a current page offset in a positive x-axis direction. Accordingly, the first and second regions 2752 and 2754 also move by the current page offset in the positive x-axis direction, and thus the first and second objects are respectively displayed in a first left-view region 2762 and a second left-view region 2764.

Similarly, a subtitle page 2770 for a right-view image is generated by moving the location of the 2D subtitle page 2750 by the current page offset in a negative x-axis direction. Accordingly, the first and second regions 2752 and 2754 are also displaced by the current page offset in the negative x-axis direction, and thus the first and second objects are respectively displayed in a first left-view region 2772 and a second left-view region 2774.

Also, when the offset information according to regions stored in the depth definition segment shown in Tables 33 and 34 is stored in the composition buffer 2740, the enhanced subtitle processor 2730 generates a subtitle page applied with the offset information according to regions, thereby generating results similar to the 3D subtitle pages 2660 and 2670 of FIG. 26.

The multimedia stream generating apparatus 100 according to the second exemplary embodiment may insert and transmit subtitle data and subtitle 3D reproduction information into a DVB subtitle PES packet. The subtitle 3D reproduction information may be set for safe reproduction of a 3D subtitle by a contents provider. Accordingly, the multimedia stream receiving apparatus 200 according to the second exemplary embodiment may receive a multimedia datastream received according to a DVB method and extract DVB subtitle data and DVB subtitle 3D reproduction information from the multimedia datastream, thereby forming a 3D DVB subtitle by using the DVB subtitle data and the DVB subtitle 3D reproduction information. Also, the multimedia stream receiving apparatus 200 according to the second exemplary embodiment adjusts a depth between a 3D video and a 3D subtitle based on the DVB subtitle 3D reproduction information so as to a prevent a viewer from being fatigued due to a depth reverse phenomenon between the 3D video and the 3D subtitle. Accordingly, the viewer may view the 3D video under stable conditions.

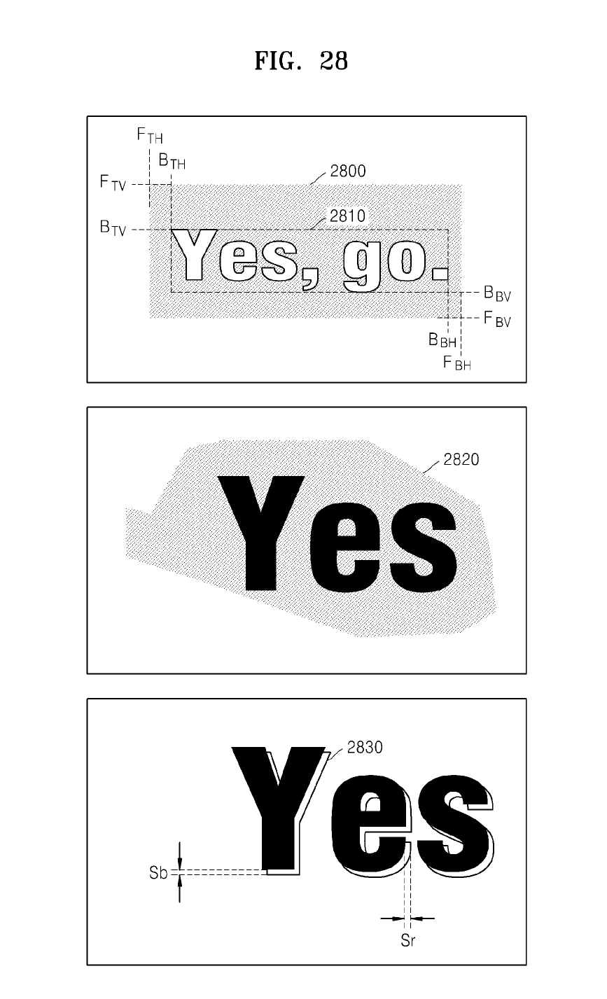

Generation and reception of a multimedia stream for three-dimensionally reproducing a subtitle complying with a cable broadcasting method, according to the third exemplary embodiment, will now be described with reference to Tables 35 through 48 and FIGS. 28 through 34.

Table 35 shows a syntax of a subtitle message table according to a cable broadcasting method.

TABLE 35
Syntax

```
subtitle_message( ){
  table_ID
  zero
  ISO reserved
  section_length
  zero
  segmentation_overlay_included
  protocol_version
  if (segmentation_overlay_included) {
    table_extension
    last_segment_number
    segment_number
  }
  ISO_639_language_code
  pre_clear_display
  immediate
  reserved
  display_standard
  display_in_PTS
  subtitle_type
  reserved
  display_duration
  block_length
  if (subtitle_type==simple_bitmap) {
    simple_bitmap( )
  } else {
    reserved( )
  }
  for (i=0; i<N; i++) {
    descriptor( )
  }
  CRC_32
}
```

A ‘table_ID’ field includes a table identifier of a current ‘subtitle_message’ table.

A ‘section_length’ field includes information about a number of bytes from a ‘section_length’ field to a ‘CRC_{—}32’ field. A maximum length of the ‘subtitle_message’ table from the ‘table_ID’ field to the ‘CRC_{—}32’ field is 1 kilobyte, i.e., 1024 bytes. When a size of the ‘subtitle_message’ table exceeds 1 kilobyte due to a size of a ‘simple_bitmap( )’ field, the ‘subtitle_message’ table is divided into a segment structure. A size of each divided ‘subtitle_message’ table is fixed to 1 kilobyte, and remaining bytes of a last ‘subtitle_message’ table that does not amount to 1 kilobyte may be filled by a stuffing descriptor. Table 36 shows a syntax of a ‘stuffing_descriptor( )’ field.

TABLE 36
Syntax

```
stuffing_descriptor( ) {
  descriptor_tag
  stuffing_string_length
  stuffing_string
}
```

A ‘stuffing_string_length’ field includes information about a length of a stuffing string. A ‘stuffing_string’ field includes the stuffing string and is not decoded by a decoder.

In the ‘subtitle message’ table of Table 35, a ‘simple_bitmap( )’ field from a ‘ISO_{—}639_language_code’ field may be formed of a ‘message_body( )’ segment. When a ‘descriptor( )’ field selectively exists in a ‘subtitle_message’ table, the ‘message_body( )’ segment includes from the ‘ISO_{—}639_language_code’ field to a ‘descriptor( )’ field. The total length of all segments including the ‘message_body( )’ segment is 4 megabytes.

A ‘segmentation_overlay_included’ field of the ‘subtitle message( )’ table of Table 35 includes information about whether the ‘subtitle_message( )’ table is formed of segments. A ‘table_extension’ field includes intrinsic information assigned for the decoder to identify ‘message_body( )’ segments. A ‘last_segment_number’ field includes identification information of a last segment for completing an entire message image of a subtitle. A ‘segment_number’ field includes an identification number of a current segment. The identification number may be assigned with a number from 0 to 4095.

A ‘protocol_version’ field of the ‘subtitle_message( )’ table of Table 35 includes information about an existing protocol version and information about a new protocol version when the structure of the existing protocol version significantly changes. An ‘ISO_{—}639_language_code’ field includes information about a language code complying with a predetermined standard. A ‘pre_clear_display’ field includes information about whether an entire screen is to be processed transparently before reproducing a current subtitle text. An ‘immediate’ field includes information about whether the subtitle on a screen should be reproduced at a reproduction point of time according to the value of a ‘display_in_PTS’ field or immediately after received.

A ‘display_standard’ field includes information about a display standard for reproducing the subtitle. Table 37 shows content of the ‘display_standard’ field.

TABLE 37

| display_standard | | Meaning |
|---|---|---|
| 0 | _720_480_30 | Indicates that display standard has 720 active display samples |
| | | horizontally per line, 480 active raster lines vertically, and runs |
| | | at 29.97 or 30 frames per second. |
| 1 | _720_576_25 | Indicates that display standard has 720 active display samples |
| | | horizontally per line, 576 active raster lines vertically, and runs |
| | | at 25 frames per second. |
| 2 | _1280_720_60 | Indicates that display standard has 1280 active display samples |
| | | horizontally per line, 720 active raster lines vertically, and runs |
| | | at 59.94 or 60 frames per second. |
| 3 | _1920_1080_60 | Indicates that display standard has 1920 active display samples |
| | | horizontally per line, 1080 active raster lines vertically, and |
| | | runs at 59.94 or 60 frames per second. |

| | |
|---|---|
| Other Values | Reserved |

In other words, it is determined which display standard from among ‘resolution 720×480 and 30 frames per second’, ‘resolution 720×576 and 25 frames per second’, ‘resolution 1280×720 and 60 frames per second’, and ‘resolution 1920×1080 and 60 frames per second’ is suitable for a subtitle, according to the ‘display_standard’ field.

A ‘display_in_PTS’ field of the ‘subtitle_message( )’ of Table 35 includes information about a program reference time when the subtitle is to be reproduced. Time information according to such an absolute expressing method is referred to as an in-cue time. When the subtitle is to be immediately reproduced on a screen based on the ‘immediate’ field, i.e., when a value of the ‘immediate’ field is set to 1, the decoder does not use a value of the ‘display_in_PTS’ field.

When the ‘subtitle_message( )’ table which has the in-cue time information and is to be reproduced after the ‘subtitle_message( )’ table is received by the decoder, the decoder may discard a subtitle message that is on standby to be reproduced. When the value of the ‘immediate’ field is set to 1, all subtitle messages that are on standby to be reproduced are discarded. If a discontinuity occurs in PCR information for a service due to the decoder, all of the subtitle messages that are on standby to be reproduced are discarded.

A ‘display_duration’ field includes information about a duration required to display the subtitle message, wherein the duration is indicated in a frame number of a TV. Accordingly, a value of the ‘display_duration’ field is related to a frame rate defined in the ‘display_standard’ field. An out-cue time obtained by adding the duration to the in-cue time may be determined according to the duration of the ‘display_duration’ field. When the out-cue time is reached, a subtitle bitmap displayed on a screen time during the in-cue time is erased.

A ‘subtitle_type’ field includes information about a format of subtitle data. According to Table 38, the subtitle data has a simple bitmap format when a value of the ‘subtitle_type’ field is 1.

TABLE 38

| subtitle_type | Meaning |
|---|---|
| 0 | Reserved |
| 1 | simple_bitmap - Indicates the subtitle data block |
| | contains data formatted in the simple bitmap style. |
| 2-15 | Reserved |

A ‘block_length’ field includes information about a length of a ‘simple_bitmap( )’ field or a ‘reserved( )’ field.

The ‘simple_bitmap( )’ field includes information about a bitmap format of the subtitle. A structure of the bitmap format will now be described with reference to FIG. 28.

FIG. 28 is a diagram illustrating components of the bitmap format of a subtitle complying with a cable broadcasting method.

The subtitle having the bitmap format includes at least one compressed bitmap image. Each compressed bitmap image may selectively have a rectangular background frame. For example, a first bitmap 2810 has a background frame 2800. When a reference point (0,0) of a coordinate system is set to an upper left of a screen, the following four relations may be set between coordinates of the first bitmap 2810 and coordinates of the background frame 2800.

1. An upper horizontal coordinate value (F_{TH}) of the background frame 2800 is smaller than or equal to an upper horizontal coordinate value (B_{TH}) of the first bitmap 2610 (F_{TH}≦B_{TH}).

2. An upper vertical coordinate value (F_{TV}) of the background frame 2800 is smaller than or equal to an upper vertical coordinate value (B_{TV}) of the first bitmap 2810 (F_{TV}≦B_{TV}).

3. A lower horizontal coordinate value (F_{BH}) of the background frame 2800 is higher than or equal to a lower horizontal coordinate value (B_{BH}) of the first bitmap 2810 (F_{BH}≧B_{BH}).

4. A lower vertical coordinate value (F_{BV}) of the background frame 2800 is higher than or equal to a lower vertical coordinate value (B_{BV}) of the first bitmap 2810 (F_{BV}≧B_{BV}).

The subtitle having the bitmap format may have an outline 2820 and a drop shadow 2830. A thickness of the outline 2820 may be in the range from 0 to 15. The drop shadow 2830 is defined by a right shadow Sr and a bottom shadow Sb, wherein thicknesses of the right shadow Sr and the bottom shadow Sb are each in the range from 0 to 15.

Table 39 shows a syntax of a ‘simple_bitmap( )’ field.

TABLE 39
Syntax

```
simple_bitmap( ) {
  reserved
  background_style
  outline_style
  character_color( )
  bitmap_top_H_coordinate
  bitmap_top_V_Coordinate
  bitmap_bottom_H_coordinate
  bitmap_bottom_V_coordinate
  if (background_style ==framed ){
    frame_top_H_coordinate
    frame_top_V_coordinate
    frame_bottom_H_coordinate
    frame_bottom_V_coordinate
    frame_color( )
  }
  if (outline_style==outlined){
    reserved
    outline_thickness
    outline_color( )
  } else if (outline_style==drop_shadow){
  shadow_right
  shadow_bottom
  shadow_color( )
  } else if (outline_style==reserved){
    reserved
  }
  bitmap_length
  compressed_bitmap( )
}
```

Coordinates (bitmap_top_H_coordinate, bitmap_top_V_coordinate, bitmap_bottom_H_coordinate, and bitmap_bottom_V_coordinate) of a bitmap are set in a ‘simple_bitmap( )’ field.

Also, if a background frame exists based on a ‘background_style’ field, coordinates (frame_top_H_coordinate, frame_top_V_coordinate, frame_bottom_H_coordinate, and frame_bottom_V_coordinate) of a background frame may be set in the ‘simple_bitmap( )’ field.

Also, if an outline exists based on an ‘outline_style’ field, a thickness (outline_thickness) of the outline may be set in the ‘simple_bitmap( )’ field. Also, when a drop shadow exists based on the ‘outline_style’ field, thicknesses (shadow_right, shadow_bottom) of a right shadow and a bottom shadow of the drop shadow may be set.

The ‘simple_bitmap( )’ field may include a ‘character_color( )’ field, which includes information about a color of a subtitle character, a ‘frame_color( )’ field, which includes information about a color of the background frame of the subtitle, an ‘outline_color( )’ field, which includes information about a color of the outline of the subtitle, and a ‘shadow_color( )’ field including information about a color of the drop shadow of the subtitle.

Table 40 shows a syntax of various ‘color( )’ fields.

TABLE 40
Syntax

```
color( ){
  Y_component
  opaque_enable
  Cr_component
  Cb_component
}
```

A maximum of 16 colors may be displayed on one screen to reproduce the subtitle. Color information is set according to color elements of Y, Cr, and Cb, and each color code is determined in the range from 0 to 31.

An ‘opaque_enable’ field includes information about transparency of color of the subtitle. The color of the subtitle may be opaque or blended 50:50 with a color of a video image, based on the ‘opaque_enable’ field.

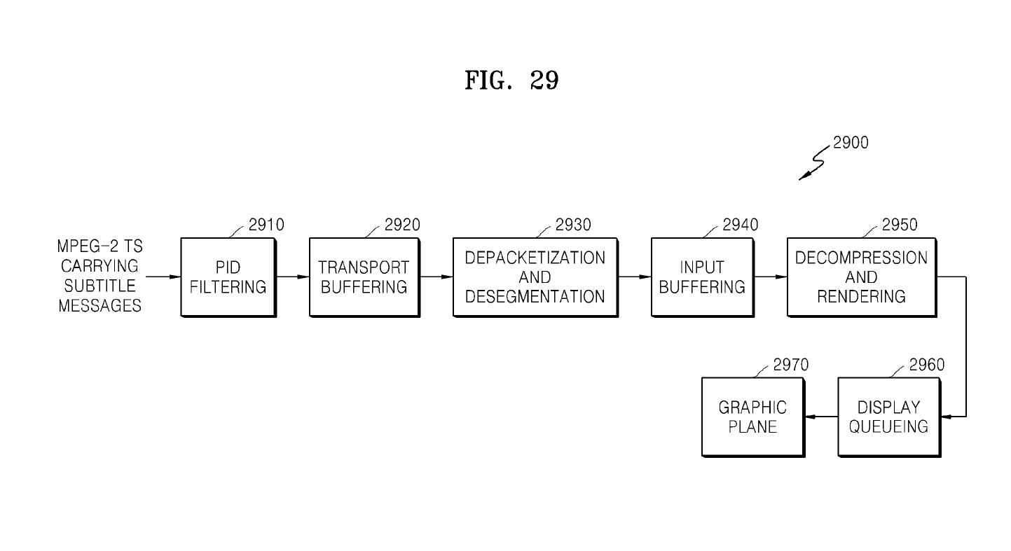

FIG. 29 is a flowchart of a subtitle processing model 2900 for 3D reproduction of a subtitle complying with a cable broadcasting method, according to an exemplary embodiment.

According to the subtitle processing model 2900, TS packets including subtitle messages are gathered from an MPEG-2 TS carrying the subtitle messages, and the TS packets are output to a transport buffer, in operation 2910. The TS packets including subtitle segments are stored, in operation 2920.

The subtitle segments are extracted from the TS packets in operation 2930, and the subtitle segments are stored and gathered in operation 2940. Subtitle data is restored and rendered from the subtitle segments in operation 2950, and the rendered subtitle data and information related to reproduction of a subtitle are stored in a display queue in operation 2960.

The subtitle data stored in the display queue forms a subtitle in a predetermined region of a screen based on the information related to reproduction of the subtitle, and the subtitle moves to a graphic plane 2970 of a display device, such as a TV, at a predetermined point of time. Accordingly, the display device may reproduce the subtitle together with a video image.

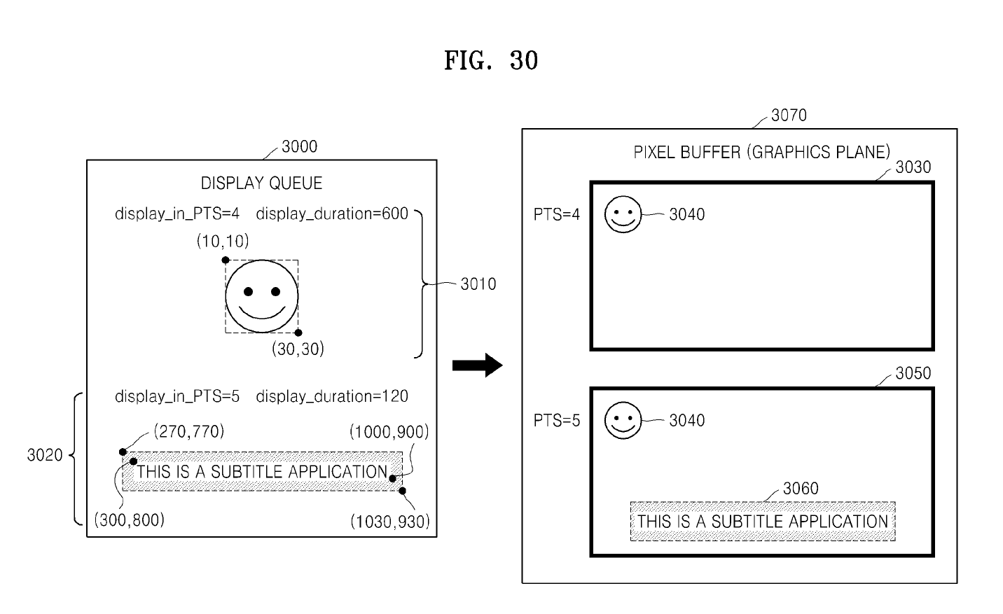

FIG. 30 is a diagram for describing a process in which a subtitle is output from a display queue 3000 to a pixel buffer (graphic plane) 3070 through a subtitle processing model complying with a cable broadcasting method.

First bitmap data and reproduction related information 3010 and second bitmap data and reproduction related information 3020 are stored in the display queue 3000 according to subtitle messages. Here, reproduction related information includes start time information (display_in_PTS) about a point of time when a bitmap is displayed on a screen, duration information (display_duration), and bitmap coordinate information. The bitmap coordinate information includes a coordinate of an upper left pixel of the bitmap and a coordinate of a bottom right pixel of the bitmap.

The subtitle formed based on the first bitmap data and reproduction related information 3010 and the second bitmap data and reproduction related information 3020 stored in the display queue 3000 is stored in the pixel buffer (graphic plane) 3070, according to time information based on the reproduction related information. For example, based on the first bitmap data and reproduction related information 3010 and the second bitmap data and reproduction related information 3020, a subtitle 3030 in which the first bitmap data is displayed on a location 3040 of corresponding coordinates is stored in the pixel buffer 3070 when a PTS unit time is 4. Alternatively, when the PTS unit time is 5, a subtitle 3050 in which the first bitmap data is displayed on the location 3040 and the second bitmap data is displayed on a location 3060 of corresponding coordinates is stored in the pixel buffer 3070.

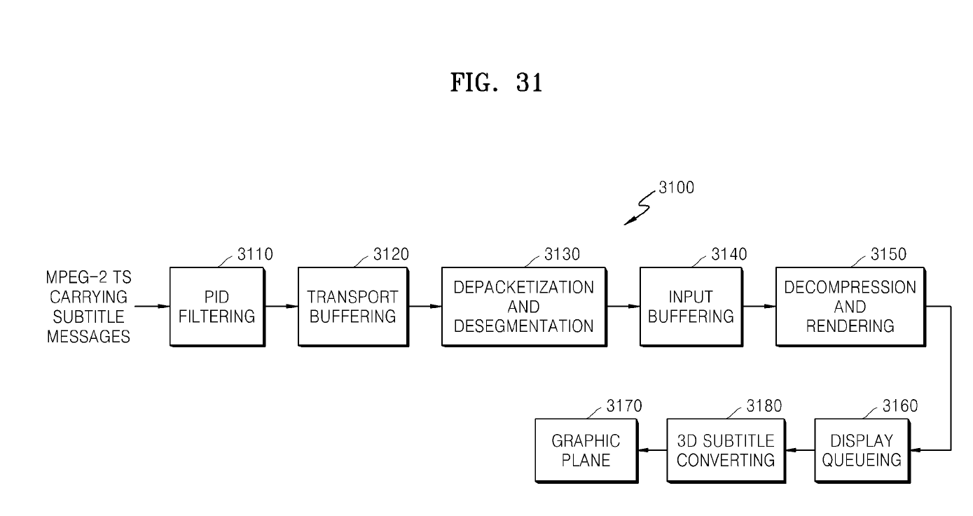

Operations of the multimedia stream generating apparatus 100 according to the third exemplary embodiment and the multimedia stream receiving apparatus 200 according to the third exemplary embodiment for subtitle 3D reproduction will now be described with reference to Tables 41 through 48 and FIGS. 31 through 34, based on a subtitle complying with the cable broadcasting method described with reference to Tables 35 through 40 and FIGS. 28 through 30.

The multimedia stream generating apparatus 100 according to the third exemplary embodiment may insert information for reproducing a cable subtitle in 3D into a subtitle PES packet. Here, the information according to the third exemplary embodiment may include information about a depth value, disparity, or offset of a subtitle.

Also, the multimedia stream receiving apparatus 200 according to the third exemplary embodiment may gather subtitle PES packets having the same PID information from the TS received according to the cable broadcasting method, extract information for 3D reproduction of a cable subtitle from a result of the gathering, and change a 2D subtitle into a 3D subtitle by using the information for 3D reproduction of a cable subtitle, thereby reproducing the 3D subtitle.

FIG. 31 is a flowchart of a subtitle processing model 3100 for 3D reproduction of a subtitle complying with a cable broadcasting method, according to the third exemplary embodiment.

Processes of restoring subtitle data and subtitle-reproduction related information complying with the cable broadcasting method through a PID filtering operation 3110, a transport buffering operation 3120, a depacketization and desegmentation operation 3130, an input buffering operation 3140, a decompression and rendering operation 3150, and a display queuing 3160 of the subtitle processing model 3100 according to the third exemplary embodiment are similar to operations 2910 through 2960 of the subtitle processing model 2900 of FIG. 29, except that subtitle 3D reproduction information may be additionally stored in a display queue in the display queuing 3160.

In a 3D subtitle converting operation 3180 according to the third exemplary embodiment, a 3D subtitle that can be reproduced in 3D may be formed based on the subtitle data and the subtitle-reproduction related information including subtitle 3D reproduction information stored in the display queuing operation 3160. The 3D subtitle may be output to a graphic plane 3170 of a display device.

The subtitle processing model 3100 according to the third exemplary embodiment may be applied to realize a subtitle processing operation of the multimedia stream receiving apparatus 200 according to the third exemplary embodiment. In particular, the 3D subtitle converting operation 3180 may correspond to a 3D subtitle processing operation of the reproducer 240 according to the third exemplary embodiment.

Exemplary embodiments in which the multimedia stream generating apparatus 100 according to the third exemplary embodiment transmits 3D subtitle reproduction information and exemplary embodiments in which the multimedia stream receiving apparatus 200 according to the third exemplary embodiment reproduces a subtitle in 3D by using the subtitle 3D reproduction information will now be described in detail.

The program encoder 110 of the multimedia stream generating apparatus 100 according to the third exemplary embodiment may insert the subtitle 3D reproduction information into a ‘subtitle_message( )’ field in a subtitle PES packet. Also, the program encoder 110 according to the third exemplary embodiment may newly define a descriptor or a subtitle type for defining the depth of a subtitle, and insert the descriptor or subtitle type into the subtitle PES packet.

Tables 41 and 42 respectively show syntaxes of a ‘simple_bitmap( )’ field and a ‘subtitle_message( )’ field, which are modified by the program encoder 110 according to the third exemplary embodiment to include depth information of a cable subtitle.

TABLE 41
Syntax

```
simple_bitmap( ){
    3d_subtitle_offset
    background_style
    outline_style
    character_color( )
    bitmap_top_H_coordinate
    bitmap_top_V_Coordinate
    bitmap_bottom_H_coordinate
    bitmap_bottom_V_coordinate
    if (background_style ==framed ){
        frame_top_H_coordinate
    frame_top_V_coordinate
    frame_bottom_H_coordinate
    frame_bottom_V_coordinate
    frame_color( )
    }
    if (outline_style==outlined){
        reserved
        outline_thickness
        outline_color( )
    } else if (outline_style==drop_shadow){
        shadow_right
        shadow_bottom
        shadow_color( )
    } else if (outline_style==reserved){
        reserved
    }
    bitmap_length
    compressed_bitmap( )
}
```

As shown in Table 41, the program encoder 110 according to the third exemplary embodiment may insert a ‘3d_subtitle_offset’ field into a ‘reserved( )’ field in the ‘simple_bitmap( )’ field of Table 39. In order to generate a bitmap for a left-view image and a bitmap for a right-view image for subtitle 3D reproduction, the ‘3d_subtitle_offset’ field may include offset information indicating a displacement amount for moving the bitmaps based on a horizontal coordinate axis. An offset value of the ‘3d_subtitle_offset’ field may be applied equally to a subtitle character and a background frame.

TABLE 42
Syntax

```
subtitle_message( ){
    table_ID
    zero
    ISO reserved
    section_length
    zero
    segmentation_overlay_included
    protocol_version
    if (segmentation_overlay_included) {
        table_extension
        last_segment_number
        segment_number
    }
    ISO_639_Ianguage_code
    pre_clear_display
    immediate
    reserved
    display_standard
    display_in_PTS
    subtitle_type
    3d_subtitle_direction
    display_duration
    block_length
    if (subtitle_type==simple_bitmap) {
        simple_bitmap( )
    } else {
        reserved( )
    }
    for (i=0; i<N; i++) {
        descriptor( )
    }
    CRC_32
}
```

The program encoder 110 according to the third exemplary embodiment may insert a ‘3d_subtitle_direction’ field into the ‘reserved( )’ field in the ‘subtitle_message( )’ field of Table 35. The ‘3d_subtitle_direction’ field may include offset direction information used to generate the bitmaps for a left-view image and a right-view image for subtitle 3D reproduction. When a negative offset is applied to a subtitle, the subtitle appears to be protruding outward from a TV screen. On the other hand, when a positive offset is applied to the subtitle, the subtitle appears to be protruding inward to the TV screen.

The reproducer 240 according to the third exemplary embodiment may generate a right-view subtitle by applying the offset to a left-view subtitle by using the direction of the offset. When a value of the ‘3d_subtitle_direction’ field is negative, the reproducer 240 according to the third exemplary embodiment may determine an x-coordinate value of the right-view subtitle by subtracting an offset value from an x-coordinate value of the left-view subtitle. Similarly, when the value of the ‘3d_subtitle_direction’ field is positive, the reproducer 240 according to the third exemplary embodiment may determine the x-coordinate value of the right-view subtitle by adding the offset value to the x-coordinate value of the left-view subtitle.

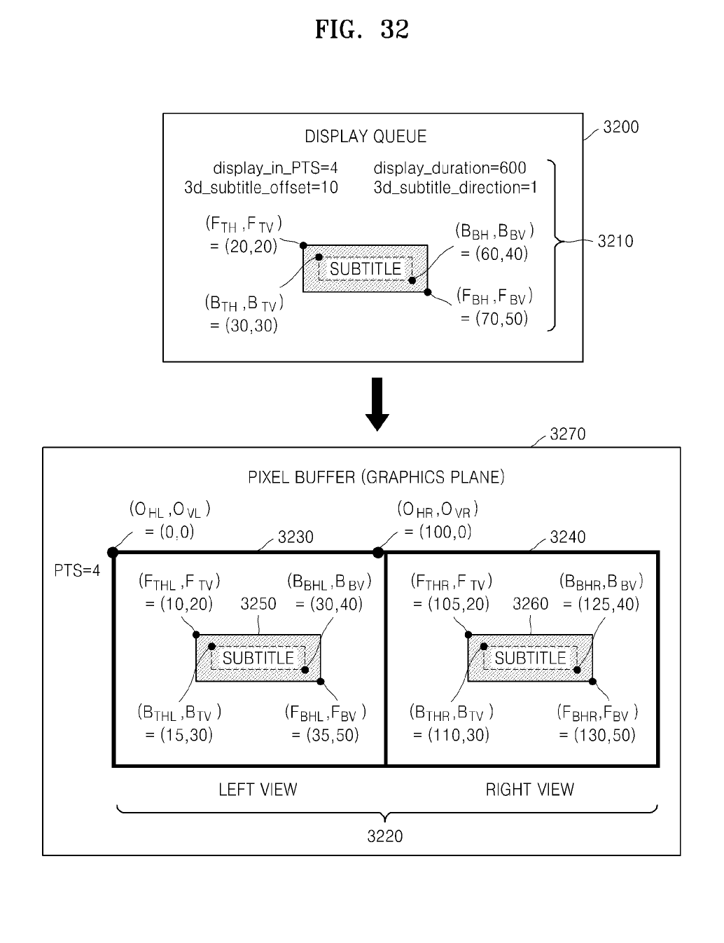

FIG. 32 is a diagram for describing adjustment of the depth of a subtitle complying with a cable broadcasting method according to the third exemplary embodiment.

The multimedia stream receiving apparatus 200 according to the third exemplary embodiment receives a TS including a subtitle message according to the third exemplary embodiment, and extracts subtitle data and subtitle-reproduction related information from a subtitle PES packet by demultiplexing the TS.

The multimedia stream receiving apparatus 200 according to the third exemplary embodiment may extract information about bitmap coordinates of the subtitle, information about frame coordinates, and bitmap data from the bitmap field of Table 41. Also, the multimedia stream receiving apparatus 200 according to the third exemplary embodiment may extract 3D subtitle offset information from the ‘3d_subtitle_offset’ field, which is a lower field of the bitmap field of Table 41.

The multimedia stream receiving apparatus 200 according to the third exemplary embodiment may extract information related to reproduction time of the subtitle from the subtitle message table of Table 42, and may also extract 3D subtitle offset direction information from the ‘3d_subtitle_offset_direction’ field, which is a lower field of the subtitle message table of Table 42.

Accordingly, a display queue 3200 may store a subtitle information set 3210, which includes the information related to reproduction time of the subtitle (display_in_PTS and display_duration), the 3D subtitle offset information (3d_subtitle_offset), the offset direction information (3d_subtitle_direction), the subtitle-reproduction related information including bitmap coordinates information (B_{TH}, B_{TV}, B_{BH}, and B_{BV}) of the subtitle and background frame coordinates information (F_{TH}, F_{TV}, F_{BH}, and F_{BV}) of the subtitle, and the subtitle data.

Through the 3D subtitle converting operation 3180 of FIG. 28, the reproducer 240 according to the third exemplary embodiment forms a subtitle composition screen on which the subtitle is disposed, based on the subtitle-reproduction related information stored in the display queue 3200, and stores the subtitle composition screen in a pixel buffer (graphics plane) 3270.

A 3D subtitle plane 3220 of a side by side format, i.e. a 3D composition format, may be stored in the pixel buffer 3270. Since resolution of the side by side format is reduced by half along an x-axis, the x-axis coordinate value for a base-view subtitle and the offset value of the subtitle, from among the subtitle-reproduction related information stored in the display queue 3200, may be halved so as to generate the 3D subtitle plane 3220. Y-coordinate values of a left-view subtitle 3250 and a right-view subtitle 3260 are identical to y-coordinate values of the subtitle from among the subtitle-reproduction related information stored in the display queue 3200.

For example, the display queue 3200 stores ‘display_in_PTS=4’ and ‘display_duration=600’ as the information related to a reproduction time of the subtitle, ‘3d_subtitle_offset=10’ as the 3D subtitle offset information, ‘3d_subtitle_direction=1’ as the 3D subtitle offset direction information, ‘(B_{TH}, B_{TV})=(30, 30)’ and ‘(B_{BH}, B_{BV})=(60, 40)’ as the bitmap coordinates information of the subtitle, and ‘(F_{TH}, F_{TV})=(14, 20)’ and ‘(F_{BH}, F_{BV})=(70, 50)’ as the background frame coordinates information of the subtitle.

The 3D subtitle plane 3220 having the side by side format and stored in the pixel buffer 3270 is formed of a left-view subtitle plane 3230 and a right-view subtitle plane 3240. Horizontal resolutions of the left-view subtitle plane 3230 and the right-view subtitle plane 3240 are reduced by half compared to original resolutions, and if an original coordinate of the left-view subtitle plane 3230 is ‘(O_{HL}, O_{VL})=(0, 0)’, an original coordinate of the right-view subtitle plane 3240 is ‘(O_{HR}, O_{VR})=(100, 0)’.

Here, x-coordinate values of the bitmap and background frame of the left-view subtitle 3250 are also each reduced by half. In other words, an x-coordinate value B_{THL} at an upper left point of the bitmap and an x-coordinate value B_{BHL} at a lower right point of the bitmap of the left-view subtitle 3250, and an x-coordinate value F_{THL} at an upper left point of the frame and an x-coordinate value F_{BHL} at a lower right point of the frame of the left-view subtitle 3250 are determined according to Relational Expressions (1) through (4) below.

B_{THL}=B_{TH}/2; (1)

B_{BHL}=B_{BH}/2; (2)

F_{THL}=F_{TH}/2; (3)

F_{BHL}=F_{BH}/2. (4)

Accordingly, the x-coordinate values B_{THL}, B_{BHL}, F_{BHL}, F_{THL}, and F_{BHL} of the left-view subtitle 3250 may be respectively determined to be (1) B_{THL}=B_{TH}/2=30/2=15; (2) B_{BHL}=B_{BH}/2=60/2=30; (3) F_{THL}=F_{TH}/2=20/2=10; and (4) F_{BHL}=F_{BH}/2=70/2=35.

Also, horizontal axis resolutions of the bitmap and the background frame of the right-view subtitle 3260 may each be reduced by half. X-coordinate values of the bitmap and the background frame of the right-view subtitle 3260 may be determined based on the original point (O_{HR}, O_{VR}) of the right-view subtitle plane 3240. Accordingly, an x-coordinate value B_{THR} at an upper left point of the bitmap and an x-coordinate value B_{BHR} at a lower right point of the bitmap of the right-view subtitle 3260, and an x-coordinate value F_{THR} at an upper left point of the frame and an x-coordinate value F_{BHR} at a lower right point of the frame of the right-view subtitle 3260 are determined according to Relational Expressions (5) through (8) below.

B_{THR}=O_{HR}+B_{THL}±(3d_subtitle_offset/2); (5)

B_{BHR}=O_{HR}+B_{BHL}±(3d_subtitle_offset/2); (6)

F_{THR}=O_{HR}+F_{THL}±(3d_subtitle_offset/2); (7)

F_{BHR}=O_{HR}+F_{BHL}±(3d_subtitle_offset/2). (8)

In other words, the x-coordinate values of the bitmap and background frames of the right-view subtitle 3260 may be set by displacing the x-coordinates in a negative or positive direction by the offset value of the 3D subtitle from a location apart from the original point (O_{HR}, O_{VR}) of the right-view subtitle plane 3240 in a positive direction by the x-coordinates of the left-view subtitle 3250. Here, since the offset direction of the 3D subtitle is 1, i.e., ‘3d_subtitle_direction=1’, the offset direction of the 3D subtitle is negative.

Accordingly, the x-coordinate values B_{THL}, B_{BHL}, F_{THL}, and F_{BHL} of the bitmap and the background frame of the right-view subtitle 3260 may be respectively determined to be (5) B_{THR}=O_{HR}+B_{THL}−(3d_subtitle_offset/2)=100+15−5=110; (6) B_{BHR}=O_{HR}+B_{BHL}−(3d_subtitle_offset/2)=100+30−5=125; (7) F_{THR}=O_{HR}+F_{THL}−(3d_subtitle_offset/2)=100+10−5=105; (8) F_{BHR}=O_{HR}+F_{BHL}−(3d_subtitle_offset/2)=100+35−5=130.

Accordingly, a display device may reproduce 3D subtitles in 3D by using the 3D subtitle plane 3220 on which the left-view subtitle 3250 and the right-view subtitle 3260 are displayed at locations moved by the offset value in an x-axis direction on the left-view subtitle plane 3230 and the right-view subtitle plane 3240, respectively.

Also, the program encoder 110 according to the third exemplary embodiment may newly define a descriptor and a subtitle type for defining the depth of a subtitle, and insert the descriptor and the subtitle type into a PES packet.

Table 43 shows a syntax of a ‘subtitle_depth_descriptor( )’ field newly defined by the program encoder 110 according to the third exemplary embodiment.

TABLE 43
Syntax

```
Subtitling_depth_descriptor( ){
    descriptor_tag
    descriptor_length
    reserved (or offset_based)
    character_offset_direction
    character_offset
    reserved
    frame_offset_direction
    frame_offset
}
```

The ‘subtitle_depth_descriptor( )’ field may include information about an offset direction of a character (‘character_offset_direction’) of the subtitle, offset information of the character (‘character_offset’), information about an offset direction of a background frame (‘frame_offset_direction’) of the subtitle, and offset information of the background frame (‘frame_offset’).

The ‘subtitle_depth_descriptor( )’ field may selectively include information (‘offset_based’) indicating whether an offset value of the character or the background frame of the subtitle is set based on a zero plane or based on disparity of a video object.

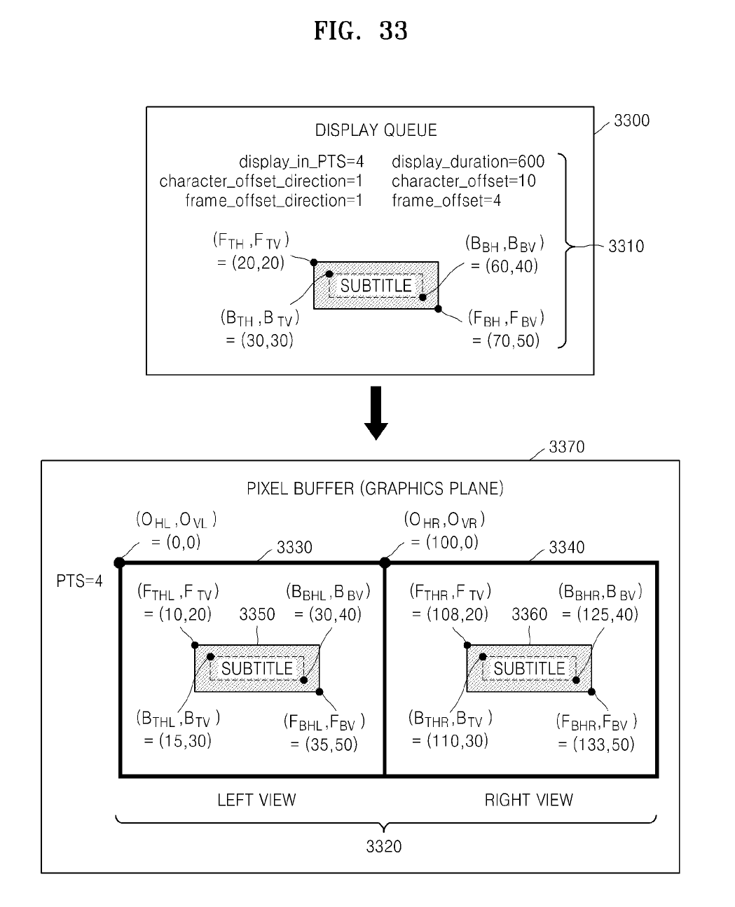

FIG. 33 is a diagram for describing adjustment of the depth of a subtitle complying with a cable broadcasting method according to the third exemplary embodiment.

The multimedia stream receiving apparatus 200 according to the third exemplary embodiment may extract information related to bitmap coordinates of the subtitle, information related to frame coordinates of the subtitle, and bitmap data from the bitmap field of Table 41, and extract information related to reproduction time of the subtitle from the subtitle message table of Table 42. Also, the multimedia stream receiving apparatus 200 according to the third exemplary embodiment may extract information about offset information of a character (‘character_offset_direction’) of the subtitle, offset information of the character (‘character_offset’), information about an offset direction of a background (‘frame_offset_direction’) of the subtitle, and offset information of the background (‘frame_offset’) from the subtitle depth descriptor field of Table 43.

Accordingly, a subtitle information set 3310, which includes subtitle-reproduction related information and subtitle data, may be stored in a display queue 3300. The subtitle-reproduction related information includes the information related to reproduction time of the subtitle (display_in_PTS and display_duration), the offset direction of the character (character_offset_direction), the offset information of the character (character_offset), the offset direction of the background frame (frame_offset_direction), and the offset information of the background frame (frame_offset).

For example, the display queue 3300 stores ‘display_in_PTS=4’ and ‘display_duration=600’ as the information related to the reproduction time of the subtitle, ‘character_offset_direction=1’ as the offset direction of the character, ‘character_offset=10’ as the offset information of the character, ‘frame_offset_direction=1’ as the offset direction of the background frame, ‘frame_offset=4’ as the offset information of the background frame, ‘(B_{TH}, B_{TV})=(30, 30)’ and ‘(B_{BH}, B_{BV})=(60, 40)’ as bitmap coordinates of the subtitle, and ‘(F_{TH}, F_{TV})=(20, 20)’ and ‘(F_{BH}, F_{BV})=(70, 50)’ as background frame coordinates of the subtitle.

Through the 3D subtitle converting operation 3180 of FIG. 31, a pixel buffer (graphic plane) 3370 may store a 3D subtitle plane 3320 having a side by side format, which is a 3D composition format.

Similar to FIG. 32, an x-coordinate value B_{THL} at an upper left point of a bitmap, an x-coordinate value B_{BHL} at a lower right point of the bitmap, an x-coordinate value F_{THL} at an upper left point of a frame, and an x-coordinate value F_{BHL} of a lower right point of the frame of a left-view subtitle 3350 on a left-view subtitle plane 3330 from among the 3D subtitle plane 3320 stored in the pixel buffer 3370 may be determined to be (9) B_{THL}=B_{TH}/2=30/2=15; (10) B_{BHL}=B_{BH}/2=60/2=30; (11) F_{THL}=F_{TH}/2=20/2=10; and (12) F_{BHL}=F_{BH}/2=70/2=35.

Also, an x-coordinate value B_{THR} at an upper left point of a bitmap, an x-coordinate value B_{BHR} at a lower right point of the bitmap, an x-coordinate value F_{THR} at an upper left point of a frame, and an x-coordinate value F_{BHR} of a lower right point of the frame of a right-view subtitle 3360 on a right-view subtitle plane 3340 from among the 3D subtitle plane 3320 are respectively determined according to Relational Expressions (13) through (15) below:

B_{THR}=O_{HR}+B_{THL}±(character_offset/2); (13)

B_{BHR}=O_{HR}+B_{BHL}±(character_offset/2); (14)

F_{THR}=O_{HR}+F_{THL}±(frame_offset/2); and (15)

F_{BHR}=O_{HR}+F_{BHL}±(frame_offset/2). (16)

Here, since offset direction information of a 3D subtitle are ‘character_offset_direction=1’ and ‘frame_offset_direction=1’, the offset direction of the 3D subtitle is negative.

Accordingly, the x-coordinate values B_{THL}, B_{BHL}, F_{THL}, and F_{BHL} of the bitmap and the background frame of the right-view subtitle 3360 may be determined to be (13) B_{THR}=O_{HR}+B_{THL}−(character_offset/2)=100+15−5=110; (14) B_{BHR}=O_{HR}+B_{BHL}−(character_offset/2)=100+30−5=125; (15) F_{THR}=O_{HR}+F_{THL}−(frame_offset/2)=100+10−2=108; and (16) F_{BHR}=O_{HR}+F_{BHL}−(frame_offset/2)=100+35−2=133.

Accordingly, a 3D display device may reproduce subtitles in 3D, by using the 3D subtitle plane 3320 on which the left-view subtitle 3350 and the right-view subtitle 3360 are disposed respectively at locations moved by the offset value in an x-axis direction on the left-view subtitle plane 3330 and the right-view subtitle plane 3340, respectively.

The multimedia stream generating apparatus 100 according to the third exemplary embodiment may additionally set a subtitle type for an additional-view subtitle so as to reproduce subtitles in 3D. Table 44 shows a subtitle type modified by the multimedia stream generating apparatus 100 according to the third exemplary embodiment.

TABLE 44

| subtitle_type | Meaning |
|---|---|
| 0 | Reserved |
| 1 | simple_bitmap - Indicates that subtitle data block |
| | contains data formatted in the simple bitmap style |
| 2 | subtitle_another_view - Bitmap and background frame |
| | coordinates of another view for 3D |
| 3-15 | Reserved |

The modified subtitle type of Table 44 is obtained by the multimedia stream generating apparatus 100 according to the third exemplary embodiment adding an another-view subtitle type ‘subtitle_another_view’ allocated in a subtitle type field value ‘2’ to a reserved region corresponding to a subtitle type field value in the range from 2 to 15 in the basic subtitle type of Table 38.

The multimedia stream generating apparatus 100 according to the third exemplary embodiment may modify the basic subtitle message table of Table 35 based on the modified subtitle type of Table 44. Table 45 shows a syntax of a modified subtitle message table ‘subtitle_message( )’.

TABLE 45
Syntax

```
subtitle_message( ){
    table_ID
    zero
    ISO reserved
    section_length
    zero
    segmentation_overlay_included
    protocol_version
    if (segmentation_overlay_included) {
        table_extension
        last_segment_number
        segment_number
    }
    ISO_639_Ianguage_code
    pre_clear_display
    immediate
    reserved
    display_standard
    display_in_PTS
    subtitle_type
    reserved
    display_duration
    block_length
    if (subtitle_type==simple_bitmap) {
        simple_bitmap( )
    } else if (subtitle_type==subtitle_another_view) {
        subtitle_another_view( )
    } else {
        reserved( )
    }
    for (i=0; i<N; i++) {
        descriptor( )
    }
    CRC_32
}
```

In other words, in the modified subtitle message table, when the subtitle type is ‘subtitle_another_view’, a ‘subtitle_another_view( )’ field may be additionally included to set another-view subtitle information. Table 46 shows a syntax of the ‘subtitle_another_view( )’ field.

TABLE 46
Syntax

```
subtitle_another_view ( ){
    reserved
    background_style
    outline_style
    character_color( )
    bitmap_top_H_coordinate
    bitmap_top_V_Coordinate
    bitmap_bottom_H_coordinate
    bitmap_bottom_V_coordinate
    if (background_style==framed){
        frame_top_H_coordinate
        frame_top_V_coordinate
        frame_bottom_H_coordinate
        frame_bottom_V_coordinate
        frame_color( )
    }
    if (outline_style==outlined){
        reserved
        outline_thickness
        outline_color( )
    } else if (outline_style==drop_shadow){
        shadow_right
        shadow_bottom
        shadow_color( )
    } else if (outline_style==reserved){
        reserved
    }
    bitmap_length
    compressed_bitmap( )
}
```

The ‘subtitle_another_view( )’ field may include information about coordinates of a bitmap of an another-view subtitle (bitmap_top_H_coordinate, bitmap_top_V_coordinate, bitmap_bottom_H_coordinate, bitmap_bottom_V_coordinate). Also, if a background frame of the another-view subtitle exists based on a ‘background_style’ field, the ‘subtitle_another_view( )’ field may include information about coordinates of the background frame of the another-view subtitle (frame_top_H_coordinate, frame_top_V_coordinate, frame bottom_H_coordinate, frame_bottom_V_coordinate).

The multimedia stream generating apparatus 100 according to the third exemplary embodiment not only includes the information about the coordinates of the bitmap and the background frame of the another-view subtitle, but may also include thickness information (outline_thickness) of an outline if the outline exists, and thickness information of right and left shadows (shadow_right and shadow_bottom) of a drop shadow if the drop shadow exists, in the ‘subtitle_another_view( )’ field.

The multimedia stream receiving apparatus 200 according to the third exemplary embodiment may extract and use only the information about the coordinates of the bitmap and the background frame of the subtitle from the ‘subtitle_another_view( )’ field so as to reduce data throughput.

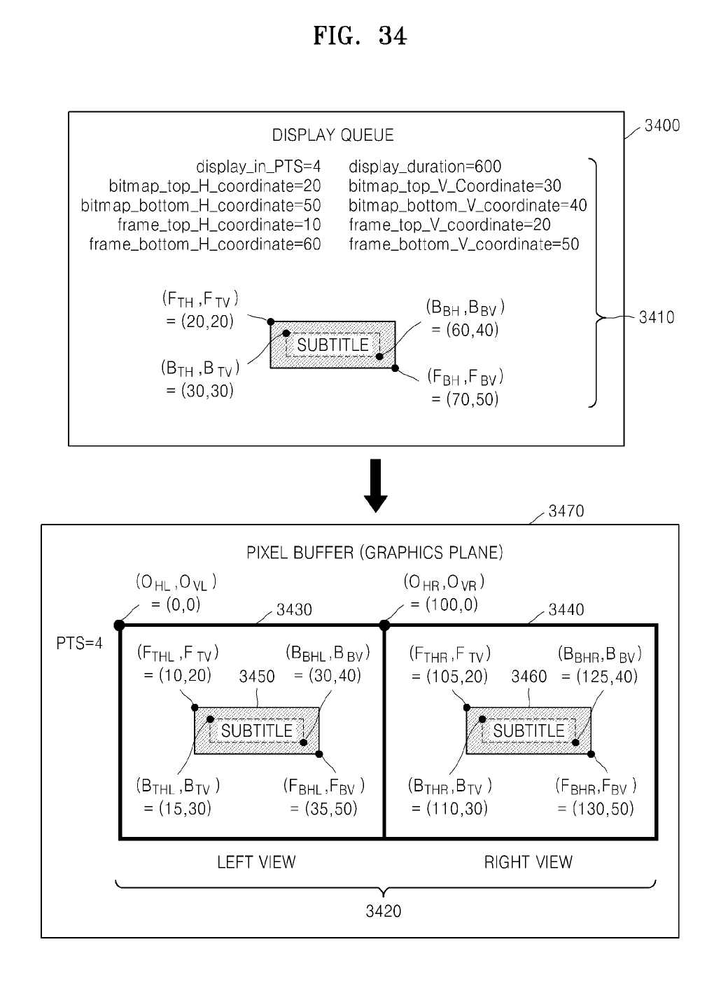

FIG. 34 is a diagram for describing adjustment of the depth of a subtitle complying with a cable broadcasting method according to the third exemplary embodiment.

The multimedia stream receiving apparatus 200 according to the third exemplary embodiment may extract information about the reproduction time of the subtitle from the subtitle message table of Table 45 that is modified to consider the ‘subtitle_another_view( )’ field, and extract the information about the coordinates of the bitmap and background frame of the another-view subtitle and the bitmap data from the ‘subtitle_another_view( )’ field of Table 46.

Accordingly, a display queue 3400 may store a subtitle information set 3410, which includes subtitle data and subtitle-reproduction related information, wherein the subtitle-reproduction related information includes information related to a reproduction time of a subtitle (display_in_PTS and display_duration), information about coordinates of a bitmap of the another-view subtitle (bitmap_top_H_coordinate, bitmap_top_V_coordinate, bitmap_bottom_H_coordinate, and bitmap_bottom_V_coordinate), and information about coordinates of a background frame of the another-view subtitle (frame_top_H_coordinate, frame_top_V_coordinate, frame_bottom_H_coordinate, and frame_bottom_V_coordinate.

For example, the display queue 3400 includes the subtitle-reproduction related information including ‘display_in_PTS=4’ and ‘display_duration=600’ as information related to reproduction time of the subtitle, ‘bitmap_top_H_coordinate=20’, ‘bitmap_top_V_coordinate=30’, ‘bitmap_bottom_H_coordinate=50’, and ‘bitmap_bottom_V_coordinate=40’ as the information about the coordinates of the bitmap of the another-view subtitle, and ‘frame_top_H_coordinate=10’, ‘frame_top_V_coordinate=20’, ‘frame_bottom_H_coordinate=60’, and ‘frame_bottom_V_coordinate=50’ as the information about the coordinates of the background frame of the another-view subtitle, ‘(B_{TH}, B_{TV})=(30, 30)’ and ‘(B_{BH}, B_{BV})=(60, 40)’ as information about coordinates of bitmap of a subtitle, and ‘(F_{TH}, F_{TV})=(20, 20)’ and ‘(F_{BH}, F_{BV})=(70, 50)’ as information about coordinates of a background frame of the subtitle.

Through the 3D subtitle converting operation 3180 of FIG. 31, a 3D subtitle plane 3420 having a side by side format, which is a 3D composition format, is stored in a pixel buffer (graphic plane) 3470. Similar to FIG. 32, an x-coordinate value B_{THL} at an upper left point of a bitmap, an x-coordinate value B_{BHL} at a lower right point of the bitmap, an x-coordinate value F_{THL} at an upper left point of a frame, and an x-coordinate value F_{BHL} of a lower right point of the frame of a left-view subtitle 3450 on a left-view subtitle plane 3430 from among the 3D subtitle plane 3420 stored in the pixel buffer 3470 may be determined to be (17) B_{THL}=B_{TH}/2=30/2=15; (18) B_{BHL}=B_{BH}/2=60/2=30; (19) F_{THL}=F_{TH}/2=20/2=10; and (20) F_{BHL}=F_{BH}/2=70/2=35.

Also, an x-coordinate value B_{THR} at an upper left point of a bitmap, an x-coordinate value B_{BHR} at a lower right point of the bitmap, an x-coordinate value F_{THR} at an upper left point of a frame, and an x-coordinate value F_{BHR} of a lower right point of the frame of a right-view subtitle 3460 on a right-view subtitle plane 3440 from among the 3D subtitle plane 3420 are determined according to Relational Expressions (21) through (24) below:

B_{THR}=O_{HR}+bitmap_top_{—}H_coordinate/2; (21)

B_{BHR}=O_{HR}+bitmap_bottom_{—}H_coordinate/2; (22)

F_{THR}=O_{HR}+frame_top_{—}H_coordinate/2; and (23)

F_{BHR}=O_{HR}+frame_bottom_{—}H_coordinate/2. (24)

Accordingly, the x-coordinate values B_{THL}, B_{BHL}, F_{THL}, and F_{BHL} of the right-view subtitle 3460 may be determined to be (21) B_{THR}=O_{HR}+bitmap_top_H_coordinate/2=100+10=110; (22) B_{BHR}=O_{HR}+bitmap_bottom_H_coordinate/2=100+25=125; (23) F_{THR}=O_{HR}+frame_top_H_coordinate/2=100+5=105; and (24) F_{BHR}=O_{HR}+frame_bottom_H_coordinate/2=100+30=130.

Accordingly, a 3D display device may reproduce subtitles in 3D by using on the 3D subtitle plane 3420 on which the left-view subtitle 3450 and the right-view subtitle 3460 are disposed respectively at locations moved by the offset value in an x-axis direction on the left-view subtitle plane 3430 and the right-view subtitle plane 3440, respectively.

The multimedia stream generating apparatus 100 according to the third exemplary embodiment may additionally set a subtitle disparity type as a cable subtitle type to give a 3D effect to a subtitle. Table 47 shows a subtitle type modified to add the subtitle disparity type by the multimedia stream generating apparatus 100 according to the third exemplary embodiment.

TABLE 47

| subtitle_type | Meaning |
|---|---|
| 0 | Reserved |
| 1 | simple_bitmap - Indicates that subtitle data block |
| | contains data formatted in the simple bitmap style |
| 2 | subtitle_disparity - Disparity information for 3D effect |
| 3-15 | Reserved |

The modified subtitle type of Table 47 is obtained by the multimedia stream generating apparatus 100 according to the third exemplary embodiment adding the subtitle disparity type (‘subtitle_disparity’) assigned to a subtitle type field value ‘2’ to a reserved region in the basic subtitle type table of Table 38.

The multimedia stream generating apparatus 100 according to the third exemplary embodiment may newly set a subtitle disparity field based on the modified subtitle type of Table 47. Table 48 shows a syntax of the ‘subtitle_disparity( )’ field, according to an exemplary embodiment.

TABLE 48
Syntax

subtitle_disparity( ){
disparity
}

According to Table 48, the subtitle disparity field includes a ‘disparity’ field including disparity information between a left-view subtitle and a right-view subtitle.

The multimedia stream receiving apparatus 200 according to the third exemplary embodiment may extract information related to a reproduction time of a subtitle from the subtitle message table modified to consider the newly set ‘subtitle_disparity’ field, and extract disparity information and bitmap data of a 3D subtitle from the ‘subtitle_disparity’ field of Table 48. Accordingly, the reproducer 240 according to the third exemplary embodiment may display the right-view subtitle 3460 at a location moved by a disparity from the left-view subtitle 3450, so that a 3D display device can reproduce a subtitle corresponding to a result of the display in 3D.

Generation and reception of a multimedia stream for 3D reproduction of EPG information according to the fourth exemplary embodiment will now be described in detail with reference to Tables 49 through 59 and FIGS. 35 through 40.

FIG. 35 is a block diagram of a digital communication system 3500 that transmits EPG information.

A video signal, an audio signal, and related ancillary data are input to the digital communication system 3500. The video signal is encoded as video data by a video encoder 3510, and the audio signal is encoded as audio data by an audio encoder 3520. The video data and the audio data are segmented into video PES packets and audio PES packets by packetizers 3530 and 3540, respectively.

A PSIP/SI generator 3550 generates a PAT and a PMT to generate various types of PSIP information or SI information. In this case, the digital communication system 3500 may insert various types of EPG information into a PSIP table or an SI table.

When the digital communication system 3500 complies with an ATSC communication method, the PSIP/SI generator 3550 generates the PSIP table. When the digital communication system 3500 complies with a DVB communication method, the PSIP/SI generator 3550 generates the SI table.

A MUX 3560 of the digital communication system 3500 receives the video PES packets and the audio PES packets from the packetizers 3530 and 3540, receives additional data, and receives Program Specific Information (PSI) tables and eight ATSC-PSIP tables or DVB-SI tables in section formats from the PSIP/SI generator 3550, and multiplexes them, thereby generating a TS for a single program.

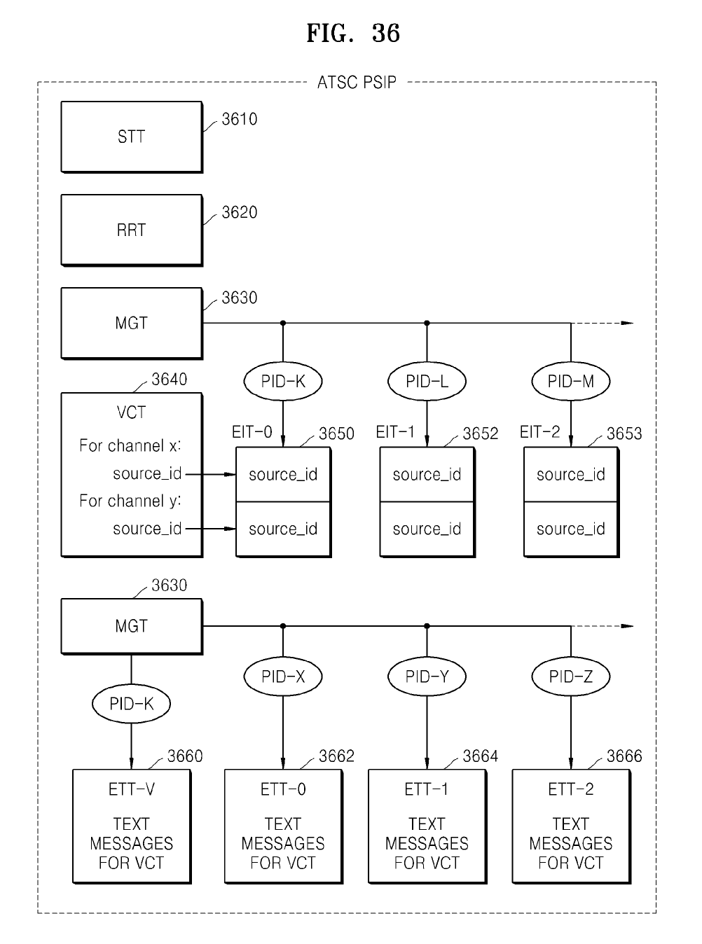

FIG. 36 illustrates PSIP tables including EPG information according to an ATSC communication method.

According to the ATSC communication method, the PSIP tables include EPG information. The PSIP tables are a System Time Table (STT) 3610 in which information about a current time and a current date is stored, a Rating Region Table (RRT) 3620 in which information about a broadcasting watch rating of a broadcasting program according to regions is stored, a Master Guide Table (MGT) 3630 in which PID information and version information of tables except for the STT 3610 are stored, a satellite Virtual Channel Table (VCT) 3640 in which channel information such as transmission channel information is stored, Event Information Tables (EITs) 3650, 3652, and 3653 in which event information such as the title, start time, etc., of an event such as a broadcasting program is stored, and Extended Text Tables (ETTs) 3660, 3662, 3664, and 3666 in which additional text information such as a detailed description such as a background, a synopsis, characters of the broadcasting program is stored. In other words, the PSIP tables store various types of information about an event such as a broadcasting program.

In particular, the satellite VCT 3640 includes a virtual channel identifier source id for each channel, so that event information for each channel may be searched for from the EITs 3650, 3652, and 3653 according to the virtual channel identifiers. The ETTs 3660, 3662, 3664, and 3666 may include text messages for the VCT 3640 or the EITs 3650, 3652, and 3653.

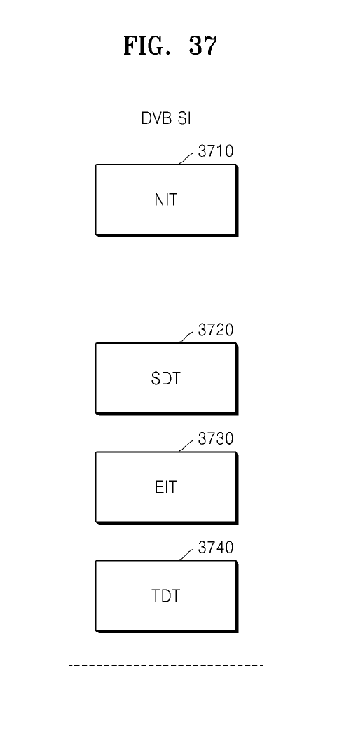

FIG. 37 illustrates SI tables including EPG information according to a DVB communication method.

The SI tables are a Network Information Table (NIT) 3710 in which network type information of a current broadcasting such as that of a terrestrial network, a cable network, or a satellite network is stored, a Service Description Table (SDT) 3720 in which service information such as a service name, a service provider, or the like is stored, an EIT 3730 in which event related information such as the title, the time, or the like of a broadcasting program is stored, and a Time and Data Table (TDT) 3740 in which information about current data and a current time is stored. Accordingly, the SI tables store various types of information about events such as a broadcasting program.

Hereinafter, a syntax of a VCT in an ATSC PSIP, a syntax of an RRT therein, a syntax of an STT therein, a syntax of an EIT therein, and a syntax of an ETT therein are shown in Tables 49, 50, 51, 52, and 53 below, respectively.

TABLE 49
Syntax

```
terrestrial_virtual_channel_table_section( ) {
    table_Id
    section_syntax_indicator
    private_indicator
    reserved
    section_length
    transport_stream_id
    reserved
    version_number
    current_next_indicator
    section_number
    last_section_number
    protocol_version
    num_channels_in_section
    for (i=0; i< num_channels_in_section; i++) {
        short_name
        reserved
        major_channel_number
        minor_channel_number
        modulation_mode
        carrier_frequency
        channel_TSID
        program_number
        ETM_locatlon
        access_controlled
        hidden
        reserved
        hide_guide
        reserved
        service_type
        source_id
        reserved
        descriptors_length
        for (i=0; i<N; i++) {
            descriptor( )
        }
    }
    reserved
    additional_descriptors_length
    for (j=0; j<N; j++)
        additional_descriptor( )
    }
    CRC_32
}
```

TABLE 50
Syntax

```
rating_regon_table_section( ) {
    table_id
    section_syntax_indicator
    private_indicator
    reserved
    section_length
    table_id_extension {
        reserved
        rating_region
    }
    reserved
    version_number
    current_next_indicator
    section_number
    last_section_number
    protocol_version
    rating_region_name_length
    rating_region_name_text( )
    dimensions_defined
    for (i=0; i< dimensions_defined; i++) {
        dimension_name_length
        dimension_name_text( )
        reserved
        graduated_scale
        values_defined
        for (j=0; j< values_defined; j ++) {
        abbrev_rating_value_length
        abbrev_rating_value_text( )
        rating_value_length
        rating_value_text( )
        }
    }
    reserved
    descriptors_length
    for (i=0; i<N; i++) {
        descriptor( )
    }
    CRC_32
}
```

TABLE 51
Syntax

```
system_time_table_section( ) {
    table_id
    section_syntax_indicator
    private_indicator
    reserved
    section_length
    table_id_extension
    reserved
    version_number
    current_next_indicator
    section_number
    last_section_number
    protocol_version
    system_time
    GPS_UTC_offset
    daylight_savings
    for (i=0; i<N; i++) {
        descriptor( )
    }
    CRC_32
}
```

TABLE 52
Syntax

```
event_information_table_section( ) {
    table_id
    section_syntax_indicator
    private_indicator
    reserved
    section_length
    source_id
    reserved
    version_number
    current_next_indicator
    section_number
    last_section_number
    protocol_version
    num_events_in_section
    for (j=o; j< num_events_in_section; j++) {
        reserved
        event_id
        start_time
        reserved
        ETM_location
        length_in_seconds
        title_length
        title_text( )
        reserved
        descriptors_length
        for (i=0; i<N; i++) {
            descriptor( )
        }
    }
    CRC_32
}
```

TABLE 53
Syntax

```
extended_text_table_section( ) {
    table_id
      section_syntax_Indicator
      private_Indicator
      reserved
      section_length
      ETT_table_id_extension
      Reserved
      version_number
      current_next_indicator
      section_number
      last_section_number
      protocol_version
      ETM_id
      extended_text_message( )
      CRC_32
}
```

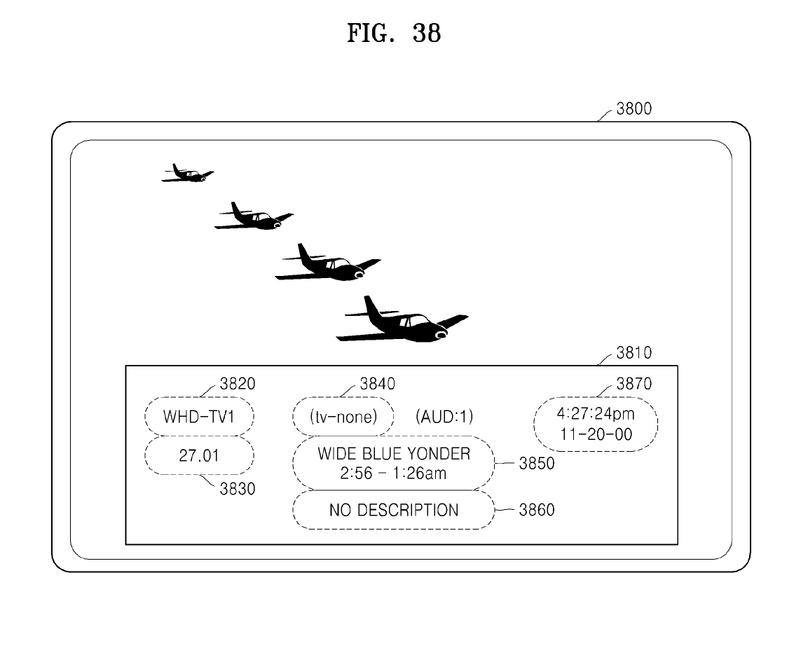

FIG. 38 illustrates a screen 3800 on which EPG information is displayed, and a source of each information.

An EPG screen 3810 formed using the PSIP tables complying with the ATSC communication method is displayed on the screen 3800. The EPG screen 3810 is formed by displaying text data included in the PSIP tables on a predetermined region set by a digital TV system on the screen 3800. In this case, the digital TV system may form the EPG screen 3810 by displaying the text data included in the PSIP tables by using an image and fonts included in the digital TV system.

In detail, a channel name 3820, a channel number 3830, a region rating 3840, a broadcasting program name and reproduction time 3850, a broadcasting program description text 3860 and a current time and date 3870 are displayed on the EPG screen 3810.

The channel name 3820 is determined based on shortened channel name information in a ‘short_name’ field of the VCT of Table 49. The channel number 3830 is determined based on channel information obtained by combining major channel number information in a ‘major_channel_number’ field of the VCT with minor channel information in a ‘minor_channel_number’ field of the VCT.

The region rating 3840 is determined based on region name information in a ‘rating_region_name_text( )’ field of the RRT of Table 50 and rating information in a ‘abbrev_rating_value_text( )’ or ‘rating_value_text( )’ field of the RRT.

The broadcasting program name and reproduction time 3850 is determined based on broadcasting program name information in a ‘title_text( )’ field of the EIT of Table 52.

The broadcasting program description text 3860 is determined based on event description text information in an ‘extended_text_message( )’ field of the ETT of Table 53.

The current time and date 3870 is determined based on system time information in a ‘system_time’ field of the STT of Table 51 and GPS-UTC time difference in a ‘GPS_UTC_offset’ field of the STT.

Table 54 shows a structure of a lower field ‘ETM_id’ of the ETT of Table 52.

TABLE 54
ETM_id

| | MSB | | LSB |
|---|---|---|---|
| Bit | 31 . . . 16 | 15 . . . 2 | ′10″ |
| Channel ETM_id | source_id | 0 . . . 0 | ′00″ |
| event ETM_id | source_id | event_id | ′10″ |

Based on the ‘ETM_id’ of the ETT table, in the case of ‘Channel ETM_id’, it is checked which VCT table a current ETT table corresponds to. In the case of ‘event ETM_id’, it is checked which EIT table the current ETT table corresponds to. As a description of a corresponding channel or event, a text message 3860 of an ‘extended_text_message( )’ field of the current ETT table is displayed on the EPG screen 3810.

Accordingly, the EPG screen 3810 is formed of EPG tables included in a plurality of PSIP tables.

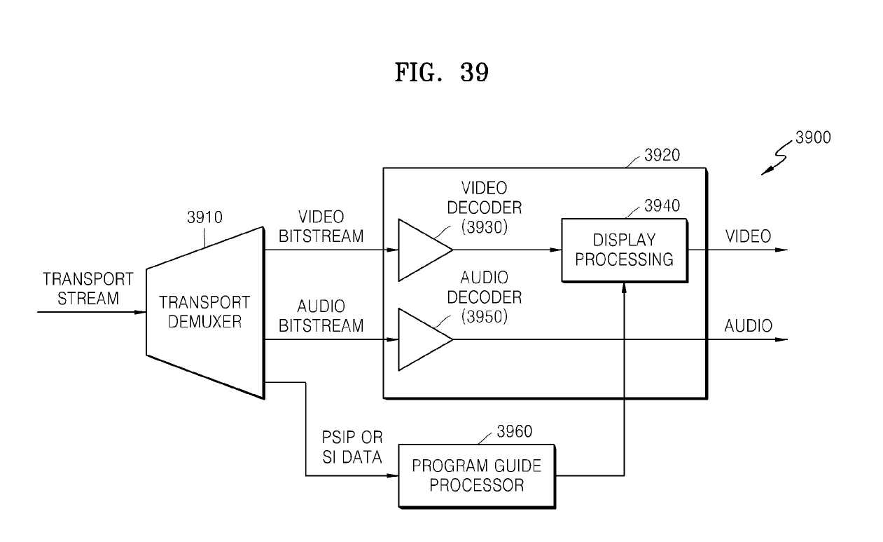

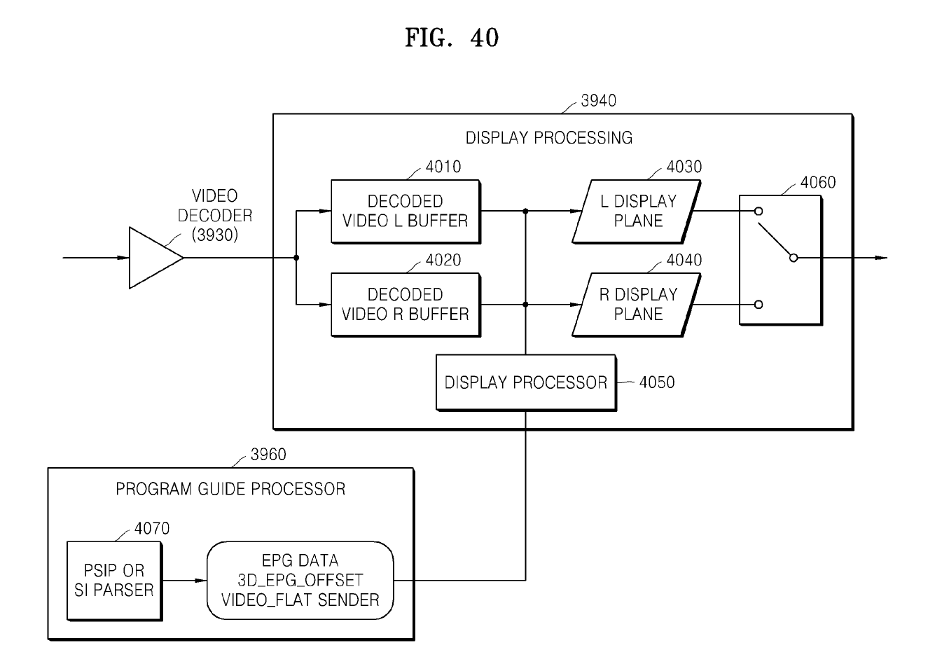

Operations of the multimedia stream generating apparatus 100 according to the fourth exemplary embodiment and the multimedia stream receiving apparatus 200 according to the fourth exemplary embodiment, for 3D reproduction of EPG information will now be described with reference to Tables 55 through 59 and FIGS. 39 and 40, based on the EPG information described above with reference to Tables 49 through 54 and FIGS. 35 through 38.

The multimedia stream generating apparatus 100 according to the fourth exemplary embodiment may insert EPG 3D reproduction information used to reproduce 3D EPG information in 3D, into a PSIP table or an SI table. The EPG 3D reproduction information according to the fourth exemplary embodiment may be used in various forms such as a depth difference, a disparity, a binocular parallax, an offset, etc., to serve as information about a depth of the 3D EPG information.

The multimedia stream receiving apparatus 200 according to the fourth exemplary embodiment may gather sections from a TS received according to the ATSC communication method, extract EPG information and EPG 3D reproduction information from the sections, and change 2D EPG information to 3D EPG information by using the EPG 3D reproduction information, thereby reproducing EPG information in 3D.

The multimedia stream generating apparatus 100 according to the fourth exemplary embodiment may modify or add the part in bold texts of a syntax of a VCT in an ATSC PSIP in Tables 49, a syntax of an RRT in Tables 50, a syntax of an STT in Tables 51, a syntax of an EIT in Tables 52, and a syntax of an ETT in Tables 53 above in order to include information related to three-dimensional reproduction of the EPG data.

The multimedia stream generating apparatus 100 according to the fourth exemplary embodiment may set the EPG 3D reproduction information to have a descriptor form. The VCT table of Table 49, the RRT table of Table 50, the STT table of Table 51, the EIT table of Table 52, except for the ETT table from among the PSIP tables, include descriptor fields ‘descriptor( )’. The multimedia stream generating apparatus 100 according to the fourth exemplary embodiment may insert a 3D EPG descriptor including the EPG 3D reproduction information according to the fourth exemplary embodiment into a descriptor field of each of the PSIP tables. Although the ETT table has no descriptor fields, the ETT table may be connected to the VCT table or the EIT table via the ‘ETM_id’ field, and may inherit the 3D EPG descriptor from the VCT table or the EIT table to which the ETT table is connected.

Table 55 shows a syntax of a 3D EPG descriptor according to the fourth exemplary embodiment.

TABLE 55
Syntax

```
3D_EPG_descriptor( ) {
    descriptor_tag
    descriptor_length
    3D_EPG_offset
    Video_Flat
    reserved
    additional_data( )
}
```

A ‘descriptor_tag’ field includes an ID of a ‘3D_EPG_descriptor’ field. A ‘descriptor_length’ field includes information about a total number of bytes of data that follows the ‘descriptor_length’ field.

A ‘3D_EPG_offset’ field includes offset information of EPG information which is to be displayed on an EPG screen by the PSIP tables including the ‘3D_EPG_descriptor’ fields.

A ‘Video_Flat’ field includes 2D video reproduction information representing whether a video image of a currently broadcasted program is reproduced in a switched 2D reproduction mode, when EPG information is reproduced in 3D. Table 56 shows an example of the ‘Video_Flat’ field including 2D video reproduction information.

TABLE 56

| Video_Flat bit | Meaning |
|---|---|
| 0 | Broadcasting image is maintained in 3D |
| 1 | Broadcasting image is changed to 2D |

A ‘reserved’ field and an ‘additional_data( )’ field are reserved regions.

A syntax of the NIT table from among the SI tables, a syntax of the SDS table from among the SI tables, and a syntax of the EIT table from among the SI tables are shown in Tables 57, 58, and 59, respectively.

TABLE 57
Syntax

```
Network_information_section( ) {
    table_id
    section_syntax_indicator
    reserve_future_use
    reserved
    section_length
    network_id
    reserved
    version_number
    current_next_indicator
    section_number
    last_section_number
    reserved_future_use
    network_descriptors_length
    for(i=0; i<N; i++) {
        descriptor( )
    }
    reserved_future_use
    transport_Stream_loop_length
    for(i=0; i<N; i++ {
        transport_stream_id
        original_network_id
        reserved_future_use
        transport_descriptors_length
        for(j=0; j<N; j++) {
            descriptors( )
        }
    }
    CRC_32
}
```

TABLE 58
Syntax

```
service_description_section( ) {
    table_id
    section_syntax_indicator
    reserved_future_use
    reserved
    section_length
    transport_stream_id
    reserved
    version_number
    current_next_indicator
    section_number
    last_section_number
    original_network_id
    reserved_future_use
    for (i=0; i<N; i++) {
        service_id
        reserved_future_use
        EIT_schedule_flag
        EIT_present_following_flag
        running_status
        free_CA_mode
        descriptors_loop_length
        for (j=0; j<N; j++) {
            descriptor( )
        }
    }
    CRC_32
}
```

TABLE 59
Syntax

```
event_information_section( ) {
    table_id
    section_syntax_indicator
    reserved_future_use
    reserved
    section_length
    service_id
    reserved
    version_number
    current_next_indicator
    section_number
    last_section_number
    transport_stream_id
    original_network_id
    segment_last_section_number
    last_table_id
    for (i=0; i<N; i++) {
        event_id
        start_time
        duration
        running_status
        free_CA_mode
        descriptors_loop_length
        for(j=0; j<N; j++){
            descriptor( )
        }
    }
    CRC_32
}
```

According to the DVB communication method, EPG text information is included in the descriptor fields ‘descriptor( )’ of the NIT table, the SDS table, and the EIT table from among the SI tables. Table 55 shows an example in which the multimedia stream generating apparatus 100 according to the fourth exemplary embodiment additionally inserts a 3D EPG descriptor including the EPG 3D reproduction information according to the fourth exemplary embodiment into a descriptor field of each of the SI tables. The multimedia stream generating apparatus 100 according to the fourth exemplary embodiment may modify or add the part in bold texts of a syntax of the NIT table in Table 57, a syntax of the SDS table in Table 58, and a syntax of the EIT table in Table 59 above in order to include information related to three-dimensional reproduction of the EPG data.

The multimedia stream receiving apparatus 200 according to the fourth exemplary embodiment may gather sections from a TS received according to a DVB communication method, and extract EPG information and EPG 3D reproduction information from the sections. When EPG information is to be reproduced in 3D, the multimedia stream receiving apparatus 200 according to the fourth exemplary embodiment may search for a 3D EPG descriptor. If the 3D EPG descriptor exists, the multimedia stream receiving apparatus 200 according to the fourth exemplary embodiment may convert 2D EPG information into 3D EPG information by using the EPG 3D reproduction information and reproduce the 3D EPG information.

FIG. 39 is a block diagram of a TS decoding system 3900 according to the fourth exemplary embodiment.

When the TS decoding system 3900 according to the fourth exemplary embodiment receives a TS, a transport DEMUX 3910 divides the TS into a video bitstream, an audio bitstream, and either a PSIP table or a SI table. The video bitstream and the audio bitstream are output to a program decoder 3920, and the PSIP table or the SI table is output to a program guide processor 3960.

The video bitstream may be input to a video decoder 3930, and a video restored by the video decoder 3930 may be output to a display processing unit 3940. The audio bitstream may be decoded by an audio decoder 3950.

The PSIP table or the SI table according to the fourth exemplary embodiment includes EPG 3D reproduction information. For example, the PSIP table or the SI table according to the fourth exemplary embodiment may include the ‘3D_EPG_descriptor’ field. Operations of the program guide processor 3960 and the display processing unit 3940 for reproducing 3D EPG information by using the PSIP table or the SI table will now be described in detail with reference to FIG. 40.

FIG. 40 is a block diagram of the display processing unit 3940 of the TS decoding system 3900 according to the fourth exemplary embodiment.

The PSIP table or the SI table input to the program guide processor 3960 is parsed by a PSIP or SI parser 4070 so that EPG information, EPG 3D reproduction information, and 2D video reproduction information are extracted from the PSIP table or the SI table. The EPG information, the EPG 3D reproduction information, and the 2D video reproduction information may be output to a display processor 4050 of the display processing unit 3940.

The restored video may be divided into a left-view image and a right-view image, which may be stored in a left-view video buffer 4010 and a right-view video buffer 4020, respectively.

The display processor 4050 generates left-view EPG information and right-view EPG information of the 3D EPG information based on the EPG 3D reproduction information. The left-view EPG information and the right-view EPG information are displayed on a left-view display plane 4030 and a right-view display plane 4040, respectively. The left-view display plane 4030 on which the left-view EPG information has been displayed is blended with the left-view image, and the right-view display plane 4040 on which the right-view EPG information has been displayed is blended with the right-view image, and results of the two blending operations are alternately reproduced by using a switch 4060. In this way, a 3D video image blended with 3D EPG information may be reproduced.

If 2D video reproduction information is set so that a video image is reproduced in a switched 2D reproduction mode, the video image should be reproduced in 2D. For example, if the same-view video image is blended with both the left-view display plane 4030 on which the left-view EPG information has been displayed and the right-view display plane 4040 on which the right-view EPG information has been displayed, EPG information may be reproduced in 3D, and a video image may be reproduced in 2D.

In order to generate the left-view EPG information and the right-view EPG information of the 3D EPG information based on the EPG 3D reproduction information, the display processor 4050 may apply different 3D EPG offsets to 2D EPG information according to different views. For example, if a 3D EPG offset is a horizontal displacement distance of a pixel, the display processor 4050 may generate the left-view EPG information by moving the 2D EPG information by the 3D EPG offset in a negative direction along the x axis, and the right-view EPG information by moving the 2D EPG information by the 3D EPG offset in a positive direction along the x axis. On the other hand, if the 3D EPG offset is a disparity between left and right views, the display processor 4050 may fix the 2D EPG information to the left-view EPG information, and may generate the right-view EPG information by moving the 2D EPG information by the 3D EPG offset in a negative or positive direction along the x axis. A method of the display processor 4050 generating the 3D EPG information may vary according to the type of 3D EPG offset.

In order to transmit a 3D EPG data structure including EPG data and EPG 3D reproduction information required to reproduce an EPG in 3D, the multimedia stream generating apparatus 100 according to the fourth exemplary embodiment may insert the 3D EPG data structure according to the fourth exemplary embodiment into an ATSC-PSIP table or a DVB-SI table and transmit the 3D EPG data structure together with a video stream and an audio stream.

The multimedia stream receiving apparatus 200 according to the fourth exemplary embodiment may receive and parse a multimedia stream according to the fourth exemplary embodiment and extract the 3D EPG data structure according to the fourth exemplary embodiment from an extracted ATSC-PSIP table or DVB-SI table. The multimedia stream receiving apparatus 200 according to the fourth exemplary embodiment may configure 3D EPG information based on EPG 3D reproduction information and transmit the 3D EPG information in 3D. The multimedia stream receiving apparatus 200 according to the fourth exemplary embodiment may prevent inconveniences such as visual discomfort and the like that the viewer can feel, by accurately reproducing the 3D EPG information based on the EPG 3D reproduction information.

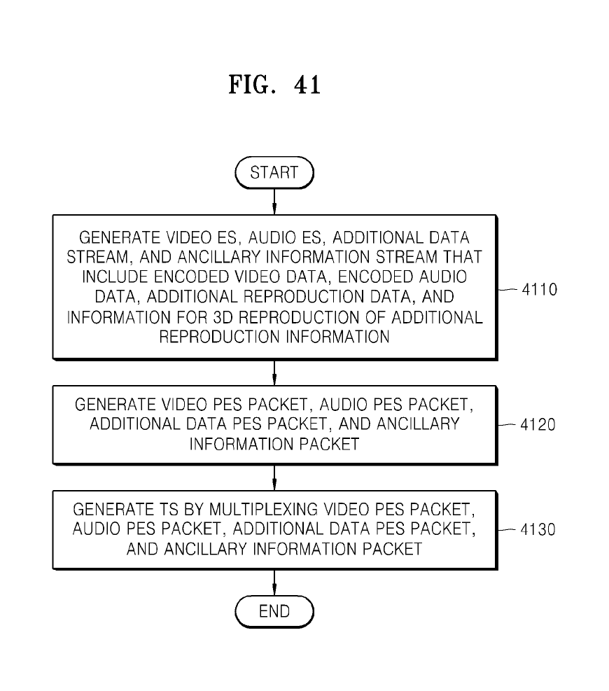

FIG. 41 is a flowchart of a multimedia stream generating method for 3D reproduction of additional reproduction information, according to an exemplary embodiment.

In operation 4110, a video ES, an audio ES, an additional data stream, and an ancillary information stream that include encoded video data, encoded audio data, additional reproduction data, and information for 3D reproduction of additional reproduction information are generated. The additional reproduction information may include closed caption data, subtitle data, and EPG data that are related to a program.

The information for 3D reproduction of additional reproduction information may include offset information used to adjust the depth of the additional reproduction information. The offset information represents at least one of parallax information such as a depth difference, a disparity, and the like between left-view additional reproduction information for left-view images and right-view additional reproduction information for right-view images, coordinate information, and depth information. The information for 3D reproduction of additional reproduction information may further include 2D video reproduction information, 3D reproduction emphasizing information, 3D reproduction safety information, and the like.

In operation 4120, a video PES packet, an audio PES packet, and an additional data PES packet are generated by packetizing the video ES, the audio ES, and the additional data stream, and an ancillary information packet is also generated. Information for 3D reproduction of additional reproduction information and addition reproduction data may be inserted at a PES packet level into a stream.

Closed caption data and closed caption 3D reproduction information according to the first exemplary embodiment may be inserted into the video ES, a header of the video ES, or a section. Subtitle data and subtitle 3D reproduction information according to the second and third exemplary embodiments may be inserted into at least one of a subtitle PES packet and a header of the subtitle PES packet. EPG data and EPG 3D reproduction information according to the fourth exemplary embodiment may be inserted into a descriptor field of an ATSC-PSIP table or a DVB_SI table.

In operation 4130, a TS is generated by multiplexing the video PES packet, the audio PES packet, the additional data PES packet, and the ancillary information packet. The TS may be transmitted via a predetermined channel.

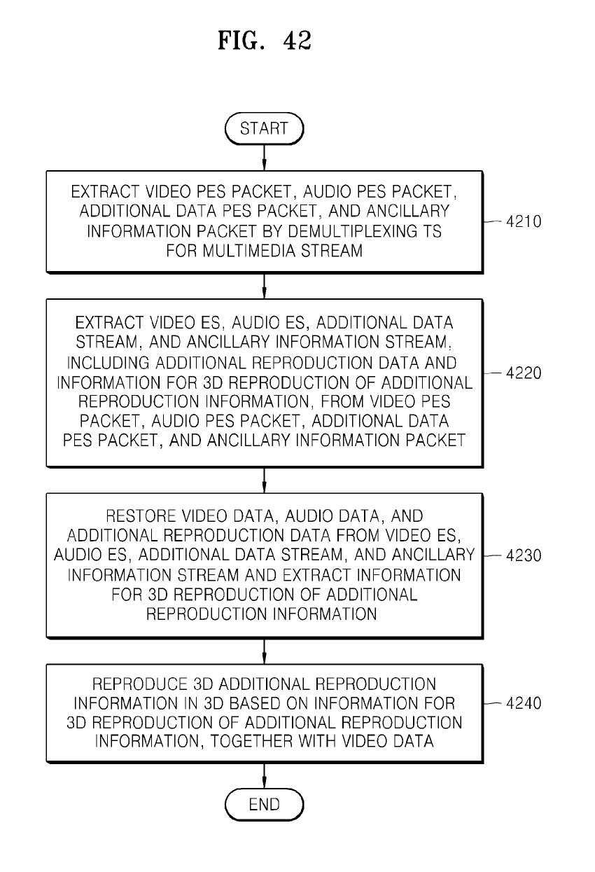

FIG. 42 is a flowchart of a multimedia stream receiving method for 3D reproduction of additional reproduction information, according to an exemplary embodiment.

In operation 4210, a TS for a multimedia stream including video data that includes at least one of a 2D video image and a 3D video image is received and multiplexed, and a video PES packet, an audio PES packet, an additional data PES packet, and an ancillary information packet are extracted from the demultiplexed TS.

In operation 4220, a video ES, an audio ES, an additional data stream, and an ancillary information stream are extracted from the video PES packet, the audio PES packet, the additional data PES packet, and the ancillary information packet. The ancillary information stream may include program related information such as PSI, ATSC-PSIP information, DVB-SI, etc. The extracted video ES, the extracted audio ES, the extracted additional data stream, and the extracted ancillary information stream, may include additional reproduction data and information for 3D reproduction of additional reproduction information.

In operation 4230, video, audio, additional data, and additional reproduction information are restored respectively from the video ES, the audio ES, the additional data stream, and the program related information, and the information for 3D reproduction of the additional reproduction information is extracted.

Closed caption data and closed caption 3D reproduction information according to the first exemplary embodiment may be extracted from the video ES, a header of the video ES, or a section. Subtitle data and subtitle 3D reproduction information according to the second and third exemplary embodiments may be extracted from at least one of a subtitle PES packet and a header of the subtitle PES packet. EPG data and EPG 3D reproduction information according to the fourth exemplary embodiment may be extracted from a descriptor field of an ATSC-PSIP table or a DVB_SI table.

In operation 4240, the video, the audio, the additional data, and the additional reproduction information are reproduced. 3D additional reproduction information may be constructed based on the information for 3D reproduction of the additional reproduction information and may be reproduced in 3D together with video data.

Since 3D reproduction is performed after adjusting the depth of the additional reproduction information based on the information for 3D reproduction of the additional reproduction information, or after securing the safety of offset information of the additional reproduction information, viewers can be relieved from inconveniences caused due to an inadequate depth between a video and the additional reproduction information.

The exemplary embodiments can be written as computer programs and can be implemented in general-use digital computers that execute the programs using a computer readable recording medium. Examples of the computer readable recording medium include storage media such as magnetic storage media (e.g., ROM, floppy disks, hard disks, etc.) and optical recording media (e.g., CD-ROMs, or DVDs).

While the various aspects have been particularly shown and described with reference to exemplary embodiments thereof, it will be understood by those of ordinary skill in the art that various changes in form and details may be made therein without departing from the spirit and scope of the exemplary embodiments as defined by the appended claims. The exemplary embodiments should be considered in descriptive sense only and not for purposes of limitation. Therefore, the scope of the exemplary embodiments is defined not by the detailed description of the exemplary embodiments but by the appended claims, and all differences within the scope will be construed as being included in the exemplary embodiments.

What is claimed is:

1. A multimedia stream generating method for 3-dimensional (3D) reproduction of additional reproduction information, the method comprising:
generating a video elementary stream (ES), an audio ES, an additional data stream, and an ancillary information stream that respectively comprise video data, audio data related to the video data, data of additional reproduction information to be reproduced with the video data on a display screen, and information for 3D reproduction of the additional reproduction information;
generating a video packetized elementary stream (PES) packet, an audio PES packet, a data PES packet, and an ancillary information packet by respectively packetizing the video ES, the audio ES, the additional data stream and the ancillary information stream; and
generating a transport stream (TS) by multiplexing the video PES packet, the audio PES packet, the additional data PES packet, and the ancillary information packet.

2. The multimedia stream generating method of claim 1, wherein the video data comprises at least one of a 2-dimensional (2D) video image and a 3D video image.

3. The multimedia stream generating method of claim 1, wherein the information for 3D reproduction of the additional reproduction information comprises information about an offset amount of 3D additional reproduction information for adjusting a depth of the 3D additional reproduction information during 3D reproduction of the video data.

4. The multimedia stream generating method of claim 3, wherein the offset amount of the additional reproduction information represents at least one selected from the group of a parallax indicating a displacement amount of the 3D additional reproduction information, a coordinate of the 3D additional reproduction information, and a depth of the 3D additional reproduction information.

5. The multimedia stream generating method of claim 4, wherein the parallax is expressed in units of one selected from the group of a depth difference, a disparity, and a binocular parallax between first-view additional reproduction information and second-view additional reproduction information of the 3D additional reproduction information.

6. The multimedia stream generating method of claim 3, wherein the information for 3D reproduction of the additional reproduction information further comprises information about an offset direction of the 3D additional reproduction information during 3D reproduction of the video data.

7. The multimedia stream generating method of claim 3, wherein the information for 3D reproduction of the additional reproduction information further comprises offset type information indicating whether the offset of the 3D additional reproduction information is expressed as a first displacement amount with respect to a zero plane where a depth is at an origin, or whether the offset of the 3D additional reproduction information is expressed as a second displacement amount with respect to at least one selected from the group of a depth, a disparity, and a binocular parallax of a video image which is to be reproduced together with the 3D additional reproduction information.

8. The multimedia stream generating method of claim 3, wherein the information for 3D reproduction of the additional reproduction information further comprises at least one type of information selected from the group of 2D/3D distinguishing information of the 3D additional reproduction information, 2D video reproduction information representing whether a video image is to be reproduced in 2D during reproduction of the 3D additional reproduction information, information identifying a region where the 3D additional reproduction information is to be reproduced, information associated with when the 3D additional reproduction information should be displayed, and 3D reproduction safety information of the 3D additional reproduction information.

9. The multimedia stream generating method of claim 1, further comprising transmitting the TS via a channel.

10. The multimedia stream generating method of claim 1, wherein the generating of the video ES, the audio ES, the additional data stream, and the ancillary information stream comprises inserting closed caption data, which is to be displayed with the video data on the display screen, into the video ES.

11. The multimedia stream generating method of claim 10, wherein the generating of the video ES, the audio ES, the additional data stream, and the ancillary information stream comprises inserting information for 3D reproduction of the closed caption into at least one selected from the group of the video ES, a header of the video ES, and additional data of the additional data stream.

12. The multimedia stream generating method of claim 11, wherein the information for 3D reproduction of the closed caption comprises 3D caption emphasizing information representing whether the closed caption data is to be replaced by 3D closed caption emphasizing data.

13. The multimedia stream generating method of claim 11, wherein the generating of the video ES, the audio ES, the additional data stream, and the ancillary information stream comprises inserting the information for 3D reproduction of the closed caption into a reserved region of a closed caption data region of the video ES, when a multimedia stream is transmitted by an Advanced Television Systems Committee (ATSC) communication system or by a Digital Video Broadcasting (DVB) communication system.

14. The multimedia stream generating method of claim 1, wherein the generating of the video ES, the audio ES, the additional data stream, and the ancillary information stream comprises generating a data stream for subtitle data which is to be reproduced on the display screen together with the video data, to serve as the additional data stream.

15. The multimedia stream generating method of claim 14, wherein the generating of the video ES, the audio ES, the additional data stream, and the ancillary information stream further comprises inserting information for 3D reproduction of the subtitle data into at least one selected from the group of the additional data PES packet and a header of the additional data PES packet.

16. The multimedia stream generating method of claim 15, wherein, when the multimedia stream is generated by an American National Strandard Institute/Society of Cable Telecommunications Engineers (ANSI/SCTE) based cable communication system, the information for 3D reproduction of the subtitle data comprises parallax information representing a displacement amount of at least one of a bitmap and a frame of a 3D subtitle, and parallax information representing at least one selected from the group of depth information of the 3D subtitle and coordinate information of the 3D subtitle.

17. The multimedia stream generating method of claim 15, wherein the generating of the video ES, the audio ES, the additional data stream, and the ancillary information stream comprises inserting offset information for each region of a current page of the subtitle data into a reserved field included in a page composition segment of the data stream, when the multimedia stream is generated by a DVB communication system.

18. The multimedia stream generating method of claim 1, wherein the generating of the video ES, the audio ES, the additional data stream, and the ancillary information stream comprises inserting electronic program guide (EPG) information which is to be reproduced together with the video data on the display screen, and information for 3D reproduction of the EPG information, into the ancillary information stream.

19. The multimedia stream generating method of claim 18, wherein in the generating of the video ES, the audio ES, the additional data stream, and the ancillary information stream, when the multimedia stream is generated by an ATSC communication system, the information for 3D reproduction of the EPG information is inserted into a descriptor field of an ATSC-based Program Specific Information Protocol (PSIP) table.

20. The multimedia stream generating method of claim 19, wherein the generating of the video ES, the audio ES, the additional data stream, and the ancillary information stream comprises inserting the information for 3D reproduction of the EPG information into a descriptor field of at least one selected from the group of a Terrestrial Virtual Channel Table (TVCT) section, an Event Information Table (EIT) section, an Extended Text Table (ETT) section, an Rating Region Table (RRT) section, and a System Time Table (STT) section of the ATSC-based PSIP table.

21. The multimedia stream generating method of claim 18, wherein the generating of the video ES, the audio ES, the additional data stream, and the ancillary information stream further comprises, when the multimedia stream is generated by a Digital Video Broadcasting (DVB) communication system, inserting the information for 3D reproduction of the EPG information into a descriptor field of a DVB-based Specific Information (SI) table.

22. The multimedia stream generating method of claim 21, wherein the generating of the video ES, the audio ES, the additional data stream, and the ancillary information stream further comprises inserting the information for 3D reproduction of the EPG information into a descriptor field of at least one selected from the group of a Network Information Table (NIT) section, a Service Description Table (SDT) section, and an Event Information Table (EIT) section of the DVB-based SI table.

23. A multimedia stream receiving method for 3-dimensional (3D) reproduction of additional reproduction information, the method comprising:
extracting a video packetized elementary stream (PES) packet, an audio PES packet, an additional data PES packet, and an ancillary information packet by receiving and demultiplexing a transport stream (TS) for a multimedia stream;
extracting a video elementary stream (ES), an audio ES, an additional data stream, and an ancillary information stream from the video PES packet, the audio PES packet, the additional data PES packet, and the ancillary information packet, respectively, wherein the video ES, the audio ES, the additional data stream, and the ancillary information stream comprise additional reproduction information, which is to be reproduced together with video data comprising at least one of a 2-dimensional (2D) video image and a 3D video image, and information for 3D reproduction of the additional reproduction information;
restoring the video data, audio data, additional data, and the additional reproduction information and extracting the information for 3D reproduction of the additional reproduction information, from the video ES, the audio ES, the additional data stream, and the ancillary information stream; and
reproducing the additional reproduction information in 3D together with the video data, based on the information for 3D reproduction of the additional reproduction information.

24. The multimedia stream receiving method of claim 23, wherein the information for 3D reproduction of the additional reproduction information comprises information about an offset of 3D additional reproduction information for adjusting a depth of the 3D additional reproduction information during 3D reproduction of the video data.

25. The multimedia stream receiving method of claim 24, wherein the offset of the additional reproduction information represents at least one selected from the group a parallax indicating a displacement amount of the 3D additional reproduction information, a coordinate of the 3D additional reproduction information, and a depth of the 3D additional reproduction information.

26. The multimedia stream receiving method of claim 25, wherein the parallax is expressed in units of one selected from the group of a depth difference, a disparity, and a binocular parallax between first-view additional reproduction information and second-view additional reproduction information of the 3D additional reproduction information.

27. The multimedia stream receiving method of claim 24, wherein the information for 3D reproduction of the additional reproduction information further comprises information about an offset direction of the additional reproduction information during 3D reproduction of the video data.

28. The multimedia stream receiving method of claim 24, wherein the information for 3D reproduction of the additional reproduction information further comprises offset type information indicating whether the offset of the additional reproduction information is expressed as a first displacement amount with respect to a zero plane where a depth is at the origin or as a second displacement amount with respect to at least one selected from the group of a depth, a disparity, and a binocular parallax of a video image which is to be reproduced together with the additional reproduction information on the display screen.

29. The multimedia stream receiving method of claim 24, wherein the information for 3D reproduction of the additional reproduction information further comprises at least one selected from the group of 2D/3D distinguishing information of the 3D additional reproduction information, 2D video reproduction information representing whether the video data is to be reproduced in 2D during reproduction of the 3D additional reproduction information, information identifying a region where the 3D additional reproduction information is to be reproduced, information associated with when the 3D additional reproduction information is to be displayed, and 3D reproduction safety information of the 3D additional reproduction information.

30. The multimedia stream receiving method of claim 27, wherein:
the reproducing of the additional reproduction information in 3D comprises displacing the 3D additional reproduction information in a positive direction or in a negative direction by the offset of the additional reproduction information, based on the offset of the 3D additional reproduction information and an offset direction of the 3D additional reproduction information from among the information for 3D reproduction of the additional reproduction information; and
the offset of the 3D additional reproduction information represents a displacement amount of the 3D additional reproduction information expressed in the unit of a depth, a disparity, or a binocular parallax of the video data.

31. The multimedia stream receiving method of claim 29, wherein the reproducing of the additional reproduction information in 3D comprises reproducing a video corresponding to the 3D additional reproduction information in 2D when reproducing the additional reproduction information in 3D, based on the 2D video reproduction information.

32. The multimedia stream receiving method of claim 29, wherein the reproducing of the additional reproduction information in 3D comprises synchronizing the 3D additional reproduction information with a corresponding video, based on information associated with when the 3D additional reproduction information is to be displayed.

33. The multimedia stream receiving method of claim 29, wherein the reproducing of the additional reproduction information in 3D comprises determining whether the 3D reproduction of the 3D additional reproduction information is safe, based on the 3D reproduction safety information of the 3D additional reproduction information.

34. The multimedia stream receiving method of claim 33, wherein the reproducing of the additional reproduction information in 3D further comprises, when it is determined that the 3D reproduction of the 3D additional reproduction information is safe, reproducing the 3D additional reproduction information in 3D.

35. The multimedia stream receiving method of claim 33, wherein the reproducing of the additional reproduction information in 3D further comprises, if it is determined that the 3D reproduction of the 3D additional reproduction information is unsafe, comparing the offset of the 3D additional reproduction information with a disparity of a corresponding video image to be displayed with the 3D additional reproduction information.

36. The multimedia stream receiving method of claim 35, wherein the comparing of the offset of the additional reproduction information with the disparity of a corresponding video image further comprises, if there is no disparity information of the corresponding video, estimating the disparity of the corresponding video image.

37. The multimedia stream receiving method of claim 35, wherein the reproducing of the additional reproduction information in 3D further comprises, if the offset of the 3D additional reproduction information belongs to a safe section of the disparity of the corresponding video image according to a result of the comparing, reproducing the image additional reproduction information in 3D.

38. The multimedia stream receiving method of claim 35, wherein the reproducing of the additional reproduction information in 3D further comprises, if the offset of the 3D additional reproduction information does not belong to a safe section of the disparity of the corresponding video image according to a result of the comparing, not reproducing the 3D additional reproduction information in 3D.

39. The multimedia stream receiving method of claim 35, wherein the reproducing of the additional reproduction information in 3D further comprises, if the offset of the 3D additional reproduction information does not belong to a safe section of the disparity of the corresponding video image according to a result of the comparing, reproducing the 3D additional reproduction information on a predetermined region of the corresponding video image in 2D.

40. The multimedia stream receiving method of claim 35, wherein the reproducing of the additional reproduction information in 3D further comprises, if the offset of the 3D additional reproduction information does not belong to a safe section of the disparity of the corresponding video image according to a result of the comparing, reproducing the 3D additional reproduction information in 3D by displacing the 3D additional reproduction information so that the 3D additional reproduction information protrudes toward a viewer relative to an object of the corresponding video image.

41. The multimedia stream receiving method of claim 35, wherein the reproducing of the additional reproduction information in 3D further comprises, if the offset of the additional reproduction information does not belong to a safe section of the disparity of the corresponding video according to a result of the comparing, reproducing the corresponding video in 2D and reproducing the additional reproduction information in 3D.

42. The multimedia stream receiving method of claim 35, wherein the reproducing of the additional reproduction information in 3D further comprises, when the multimedia stream is encoded by an Moving Picture Expert Group-2 (MPEG-2) data communication system, extracting at least one selected from the group of binocular parallax information, disparity information, and depth information of the 3D video image, from at least one selected from the group of a parallax information extension field, a depth map, and a reserved field of a closed caption data field of the video ES, and comparing the extracted information with the offset of the 3D additional reproduction information.

43. The multimedia stream receiving method of claim 35, wherein the reproducing of the additional reproduction information in 3D further comprises, when the multimedia stream has an International Organization for Standardization (ISO)-based media file format, extracting at least one selected from the group of binocular parallax information, disparity information, and depth information of the 3D video image, from an Stereoscopic Camera and Display Information (SCDI) region of the ISO-based media file format, the SCDI region comprising a stereoscopic camera and display-related information, and comparing the extracted information with the offset of the 3D additional reproduction information.

44. The multimedia stream receiving method of claim 23, wherein the extracting of the video ES, the audio ES, the additional data stream, and the ancillary information stream comprises extracting closed caption data which is to be displayed with the video data on the display screen, from the video ES.

45. The multimedia stream receiving method of claim 42, wherein the extracting of the video ES, the audio ES, the additional data stream, and the ancillary information stream comprises extracting information for 3D reproduction of the closed caption data from at least one selected from the group of the video ES, a header of the video ES, and the ancillary information stream.

46. The multimedia stream receiving method of claim 43, wherein the information for 3D reproduction of closed caption data comprises 3D caption emphasizing information representing whether the closed caption data is to be replaced by 3D closed caption emphasizing data.

47. The multimedia stream receiving method of claim 43, wherein the extracting of the video ES, the audio ES, the additional data stream, and the ancillary information stream comprises extracting the information for 3D reproduction of closed caption data from a reserved region of a closed caption data region of the video ES, when the multimedia stream is received by an Advanced Television Systems Committee (ATSC) or a Digital Video Broadcasting (DVB) communication system.

48. The multimedia stream receiving method of claim 43, wherein the reproducing of the additional reproduction information in 3D comprises reproducing the closed caption data in 3D, based on the information for 3D reproduction of closed caption data.

49. The multimedia stream receiving method of claim 46, wherein the reproducing of the additional reproduction information in 3D comprises reproducing the closed caption data in 3D by using the 3D closed caption emphasizing data, based on the 3D closed caption emphasizing information.

50. The multimedia stream receiving method of claim 23, wherein the extracting of the video ES, the audio ES, the additional data stream, and the ancillary information stream comprises extracting a subtitle data stream for subtitle data which is to be reproduced on the display screen together with the video data, to serve as the additional data stream.

51. The multimedia stream receiving method of claim 50, wherein the extracting of the video ES, the audio ES, the additional data stream, and the ancillary information stream further comprises extracting information for 3D reproduction of the subtitle data from at least one selected from the group of the additional data PES packet and a header of the additional data PES packet.

52. The multimedia stream receiving method of claim 51, wherein, when the multimedia stream is received by an American National Strandard Institute/Society of Cable Telecommunications Engineers (ANSI/SCTE) based cable communication system, the information for 3D reproduction of the subtitle data comprises parallax information representing a displacement amount of at least one of a bitmap and a frame of a 3D subtitle, and offset information representing at least one selected from the group of depth information of the 3D subtitle and coordinate information of the 3D subtitle.

53. The multimedia stream receiving method of claim 51, wherein the extracting of the video ES, the audio ES, the additional data stream, and the ancillary information stream further comprises extracting offset information for each region of a current page of the subtitle data from a reserved field included in a page composition segment of the data stream, when the multimedia stream is generated by a Digital Video Broadcasting (DVB) communication system.

54. The multimedia stream receiving method of claim 51, wherein the reproducing of the additional reproduction information in 3D comprises reproducing the subtitle data in 3D, based on the information for 3D reproduction of the subtitle.

55. The multimedia stream receiving method of claim 23, wherein the extracting of the video ES, the audio ES, the additional data stream, and the ancillary information stream comprises extracting electronic program guide (EPG) information which is to be reproduced together with the video data, and information for 3D reproduction of the EPG information, from the ancillary information stream.

56. The multimedia stream receiving method of claim 55, wherein in the extracting of the video ES, the audio ES, the additional data stream, and the ancillary information stream, when the multimedia stream is received by an Advanced Television Systems Committee (ATSC) communication system, the information for 3D reproduction of the electronic program guide (EPG) information is extracted from a descriptor field of an ATSC-based Program Specific Information Protocol (PSIP) table.

57. The multimedia stream receiving method of claim 56, wherein the extracting of the video ES, the audio ES, the additional data stream, and the ancillary information stream comprises extracting the information for 3D reproduction of the EPG information from a descriptor field of at least one selected from the group of a Terrestrial Virtual Channel Table (TVCT) section, an Event Information Table (EIT) section, an Extended Text Table (ETT) section, an Rating Region Table (RRT) section, and a System Time Table (STT) section of the ATSC-based PSIP table.

58. The multimedia stream receiving method of claim 56, wherein the extracting of the video ES, the audio ES, the additional data stream, and the ancillary information stream comprises, when the multimedia stream is generated by a DVB communication system, extracting the information for 3D reproduction of the EPG information from a descriptor field of a DVB-based Specific Information (SI) table.

59. The multimedia stream receiving method of claim 58, wherein the extracting of the video ES, the audio ES, the additional data stream, and the ancillary information stream comprises extracting the information for 3D reproduction of the EPG information from a descriptor field of at least one selected from the group of a Network Information Table (NIT) section, a Service Description Table (SDT) section, and an EIT section of the DVB-based SI table.

60. The multimedia stream receiving method of claim 55, wherein the reproducing of the additional reproduction information in 3D comprises reproducing the EPG information in 3D, based on the information for 3D reproduction of the EPG information.

61. A multimedia stream generating apparatus for 3-dimensional (3D) reproduction of additional reproduction information, the multimedia stream generating apparatus comprising:
a program encoder which generates a video elementary stream (ES), an audio ES, an additional data stream, and an ancillary information stream that respectively comprise video data, audio data related to the video data, data of additional reproduction information which is to be reproduced together with the video data on a display screen, and information for 3D reproduction of the additional reproduction information, and which generates a video PES packet, an audio packetized elementary stream (PES) packet, a data PES packet, and an ancillary information packet by respectively packetizing the video ES, the audio ES, the additional data stream and the ancillary information stream; and
a transport stream (TS) generator which generates a TS by multiplexing the video PES packet, the audio PES packet, the additional data PES packet, and the ancillary information packet.

62. The multimedia stream receiving apparatus of claim 61, wherein the video data comprises at least one of a 2-dimensional (2D) video image and a 3D video image.

63. A multimedia stream receiving apparatus for 3-dimensional (3D) reproduction of additional reproduction information, the multimedia stream receiving apparatus comprising:
a receiver which receives a transport stream (TS) for a multimedia stream that comprises video data comprising at least one of a 2-dimensional (2D) video image and a 3D video image;
a demultiplexer which demultiplexes the received TS to extract a video packetized elementary stream (PES) packet, an audio PES packet, an additional data PES packet, and an ancillary information packet and extracts a video ES, an audio ES, an additional data stream, and an ancillary information stream from the video PES packet, the audio PES packet, the additional data PES packet, and the ancillary information packet, wherein the video ES, the audio ES, the additional data stream, and the ancillary information stream comprise additional reproduction information, which is to be reproduced together with the video data on a display screen, and information for 3D reproduction of the additional reproduction information;
a decoder which extracts and restores the video data, audio data, additional data, and the additional reproduction information and extracts the information for 3D reproduction of the additional reproduction information, from the video ES, the audio ES, the additional data stream, and the ancillary information stream; and
a reproducer which reproduces the additional reproduction information in 3D together with the video data, based on the information for 3D reproduction of the additional reproduction information.

64. A non transitory computer readable recording medium having embodied thereon instructions, that when executed by a computer, causes the computer to perform a multimedia stream generating method for 3-dimensional (3D) reproduction of additional reproduction information, the method comprising:
generating a video elementary stream (ES), an audio ES, an additional data stream, and an ancillary information stream that respectively comprise video data, audio data related to the video data, data of additional reproduction information to be reproduced with the video data on a display screen, and information for 3D reproduction of the additional reproduction information;
generating a video packetized elementary stream (PES) packet, an audio PES packet, a data PES packet, and an ancillary information packet by respectively packetizing the video ES, the audio ES, the additional data stream and the ancillary information stream; and
generating a transport stream (TS) by multiplexing the video PES packet, the audio PES packet, the additional data PES packet, and the ancillary information packet.

65. A computer readable recording medium having recorded thereon instructions that, when executed by a computer, causes the computer to perform a multimedia stream receiving method for 3-dimensional (3D) reproduction of additional reproduction information, the method comprising:
extracting a video packetized elementary stream (PES) packet, an audio PES packet, an additional data PES packet, and an ancillary information packet by receiving and demultiplexing a transport stream (TS) for a multimedia stream;
extracting a video elementary stream (ES), an audio ES, an additional data stream, and an ancillary information stream from the video PES packet, the audio PES packet, the additional data PES packet, and the ancillary information packet, respectively, wherein the video ES, the audio ES, the additional data stream, and the ancillary information stream comprise additional reproduction information, which is to be reproduced together with video data comprising at least one of a 2-dimensional (2D) video image and a 3D video image, and information for 3D reproduction of the additional reproduction information;
restoring the video data, audio data, additional data, and the additional reproduction information and extracting the information for 3D reproduction of the additional reproduction information, from the video ES, the audio ES, the additional data stream, and the ancillary information stream; and
reproducing the additional reproduction information in 3D together with the video data, based on the information for 3D reproduction of the additional reproduction information.
